(19) United States
(12) Patent Application Publication
(10) Pub. No.: US 2025/0342347 A1
(43) Pub. Date: Nov. 6, 2025

(54) COMPUTING DEVICE, METHOD FOR IMPLEMENTING CONVOLUTION OPERATION BY USING COMPUTING DEVICE, AND RELATED PRODUCT

(71) Applicant: Cambricon (Xi'an) Semiconductor Co., Ltd., Xi'an (CN)

(72) Inventors: Wankai ZHENG, Xi'an (CN); Haoyuan HE, Xi'an (CN); Weilun CHEN, Xi'an (CN); Jinhua TAO, Xi'an (CN)

(21) Appl. No.: 18/694,967

(22) PCT Filed: Aug. 18, 2022
(86) PCT No.: PCT/CN2022/113302

§ 371 Date: Nov. 4, 2024

(30) Foreign Application Priority Data
Sep. 26, 2021 (CN) 202111131388.5

(51) Int. Cl. G06N 3/0464

(52) U.S. Cl. CPC G06N 3/0464

(57) ABSTRACT

The present disclosure provides a computing device, a method for implementing a convolution operation by using a computing device, and related products. The computing device is included in a combined processing device. The combined processing device further includes an interface device and other processing devices. The computing device interacts with other processing devices to jointly complete a computing operation specified by a user. The combined processing device further includes a storage device, which is connected to the computing device and other processing devices respectively and configured to store data of the computing device and other processing devices. A scheme of the present disclosure optimizes the convolution operation and improves operation processing efficiency.

### CROSS REFERENCE OF RELATED APPLICATION

This disclosure claims priority to the Chinese patent application filed on Sep. 26, 2021, with the application No. 202111131388.5 and the invention title “COMPUTING DEVICE, METHOD FOR IMPLEMENTING CONVOLUTION OPERATION BY USING COMPUTING DEVICE, AND RELATED PRODUCT”.

### TECHNICAL FIELD

This disclosure relates generally to the field of data processing. More specifically, the present disclosure relates to a computing device configured to perform a convolution operation, a method for performing a convolution operation using a computing device, a chip, and a board card.

### BACKGROUND

At present, deep learning has become an important branch of machine learning and has also vigorously promoted the development of artificial intelligence (AI). Deep neural network (DNN), as the core technology of deep learning, has been widely used in many industries.

Neural network is one of the most critical technologies in AI and deep learning, among which a convolution neural network (CNN) is the most important network type. The most critical computation in the convolution neural network is a convolution operation on a convolution layer (Conv layer). A function of the Conv layer is to extract features from input data. Through multi-layer convolution, complex features may be extracted to ensure that the network has sufficient expression and generalization capabilities. The neural network model contains a large number of various types of convolution operations, and the computing performance of the convolution operation greatly affects the computing performance of the entire neural network model. When neural network models are used in different fields, such as speech recognition, machine translation, image processing, etc., sizes of dimensions of their corresponding input feature maps and weights may be different. In order to take full advantage of hardware advantages of deep learning processors, it is necessary to optimize convolution operations of different sizes and types to improve the computing performance of executing neural network models.

### SUMMARY

In order to solve one or more of the technical problems mentioned above, the present disclosure proposes a computing device in many aspects. By performing blocking processing on an input feature map and a weight, the computing device may make data of various dimensions fit hardware of a convolution operation, thus improving the computing efficiency of the convolution operation. The convolution operation in the embodiment of the present disclosure may be an operation in various neural network models. These neural network models may be applied in various fields, such as image processing, speech processing, text processing, etc. These processes may include, but are not limited to, for example, identification and classification.

In a first aspect, an embodiment of the present disclosure provides a computing device configured to perform a convolution operation. The computing device includes a master processing circuit and a plurality of slave processing circuits. The master processing circuit is configured to obtain an input feature map and/or a convolution kernel, where the input feature map and the convolution kernel have been split into a plurality of splitting units according to a convolution splitting scheme and dimension storage orders of the input feature map and the convolution kernel have been converted. The convolution splitting scheme is determined based on a size of a lowest storage dimension of the input feature map before splitting. The convolution splitting scheme indicates a shape of a splitting unit, where the amount of data contained in one splitting unit is less than or equal to a maximum computation amount of hardware at a time, and data in one splitting unit is continuously stored in one data line. The plurality of slave processing circuits are configured to perform convolution operations on corresponding splitting units of the input feature map and the convolution kernel.

In a second aspect, an embodiment of the present disclosure provides a chip, which includes the computing device of any embodiment of the first aspect.

In a third aspect, an embodiment of the present disclosure provides a board card, which includes the chip of any embodiment of the second aspect.

In a second aspect, an embodiment of the present disclosure provides a method for implementing a convolution operation using the computing device according to any embodiment of the first aspect.

Through the computing device, the chip, the board card, and the method for implementing the convolution operation using the computing device as provided above, the scheme of the embodiment of the present disclosure applies different convolution splitting schemes to input feature maps of different dimensions to adapt to the processing capability of the hardware operation device, so as to fully utilize the parallel processing capability of the plurality of slave processing circuits, which may effectively improve the computing efficiency of the convolution operation. In addition, in some embodiments, the input feature map and weight may be transmitted through different data paths, thereby supporting a plurality of reuse methods of the input feature map and weight, and further optimizing the convolution operation and reducing the amount of data access.

### BRIEF DESCRIPTION OF THE DRAWINGS

By reading the following detailed description with reference to the accompanying drawings, the above-mentioned and other objects, features and technical effects of the exemplary embodiments of the present disclosure will become easier to understand. In the accompanying drawings, several embodiments of the present disclosure are shown in an exemplary but not restrictive manner, and the same or corresponding reference numerals indicate the same or corresponding parts of the embodiments.

FIG. 1 shows a structural block diagram of a board card according to an embodiment of the present disclosure;

FIG. 2 shows a structural block diagram of a combined processing device according to an embodiment of the present disclosure;

FIG. 3 shows a schematic diagram of an internal structure of a processor core of a single-core or multi-core computing device according to an embodiment of the present disclosure;

FIGS. 4a-4c illustrate several exemplary convolution operation principle examples that may be applied to embodiments of the present disclosure;

FIG. 5 shows a schematic structural block diagram of a computing device according to an embodiment of the present disclosure;

FIG. 6 shows an exemplary data storage order according to an embodiment of the present disclosure;

FIGS. 7a-7d illustrate several exemplary grouping modes according to embodiments of the present disclosure;

FIG. 8 shows an exemplary splitting diagram of an input feature map according to an embodiment of the present disclosure;

FIGS. 9a-9d show schematic diagrams of data storage in a second storage circuit according to embodiments of the present disclosure;

FIGS. 10a-10b show schematic diagrams of output point splitting of a computing circuit according to embodiments of the present disclosure;

FIG. 11 shows a schematic diagram of splitting and storage in a Forward16 scheme according to an embodiment of the present disclosure.

FIG. 12 shows a schematic diagram of a single computation in the Forward16 scheme according to an embodiment of the present disclosure;

FIG. 13 shows a schematic diagram of sliding convolution in the Forward16 scheme according to an embodiment of the present disclosure;

FIG. 14 shows a schematic accumulation diagram of sliding convolution results in the Forward16 scheme according to an embodiment of the present disclosure;

FIG. 15 shows a schematic output data format diagram in the Forward16 splitting scheme according to an embodiment of the present disclosure;

FIG. 16 shows a schematic diagram of splitting and storage in a Forward4 scheme according to an embodiment of the present disclosure.

FIG. 17 shows a schematic diagram of a single computation in the Forward4 scheme according to an embodiment of the present disclosure;

FIG. 18 shows a schematic diagram of sliding convolution in the Forward4 scheme according to an embodiment of the present disclosure;

FIG. 19 shows a schematic output data format diagram in the Forward4 scheme according to an embodiment of the present disclosure;

FIG. 20 shows a schematic diagram of output point splitting of a computing circuit in a Forward1 scheme according to an embodiment of the present disclosure;

FIG. 21 shows a schematic diagram of a single computation in the Forward1 scheme according to an embodiment of the present disclosure;

FIG. 22 shows a schematic diagram of sliding convolution in the Forward1 scheme according to an embodiment of the present disclosure;

FIG. 23 shows a schematic output data format diagram in the Forward1 scheme according to an embodiment of the present disclosure;

FIG. 24 shows a schematic diagram of data storage in a second storage circuit in an Update1 scheme according to embodiments of the present disclosure;

FIG. 25 shows a schematic diagram of sliding convolution in the Update1 scheme according to an embodiment of the present disclosure;

FIG. 26 shows a schematic output data format diagram in the Update1 scheme according to an embodiment of the present disclosure;

FIGS. 27a-27b show exemplary storage contents in a second storage circuit in different grouping modes in an Update4 scheme according to an embodiment of the present disclosure;

FIG. 28 shows a schematic diagram of a single computation process in the Update4 scheme according to an embodiment of the present disclosure;

FIG. 29 shows a schematic diagram of a sliding convolution process in the Update4 scheme according to an embodiment of the present disclosure; and

FIG. 30 shows a schematic output data format diagram in the Update4 scheme according to an embodiment of the present disclosure.

### DETAILED DESCRIPTION

Technical schemes in embodiments of the present disclosure will be described clearly and completely hereinafter with reference to the drawings in the embodiments of the present disclosure. Obviously, the embodiments to be described are merely some rather than all examples of the present disclosure. All other embodiments obtained by those of ordinary skill in the art based on the embodiments of the present disclosure without creative efforts shall fall within the protection scope of the present disclosure.

It should be understood that terms such as “first”, “second”, “third”, and “fourth” that may appear in the claims, the specification, and drawings are used for distinguishing different objects rather than describing a specific order. It should be understood that the terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that the terms used in the specification of the present disclosure are merely intended to describe specific embodiments rather than to limit the present disclosure. As being used in the specification and the claims of the disclosure, unless the context clearly indicates otherwise, the singular forms “a”, “an”, and “the” are intended to include the plural forms. It should also be understood that the term “and/or” used in the specification and the claims refers to any and all possible combinations of one or more of relevant listed items and includes these combinations.

As being used in this specification and the claims, the term “if” may be interpreted as “when”, or “once” or “in response to a determination” or “in response to a case where something is detected” depending on the context.

### Exemplary Hardware Environment

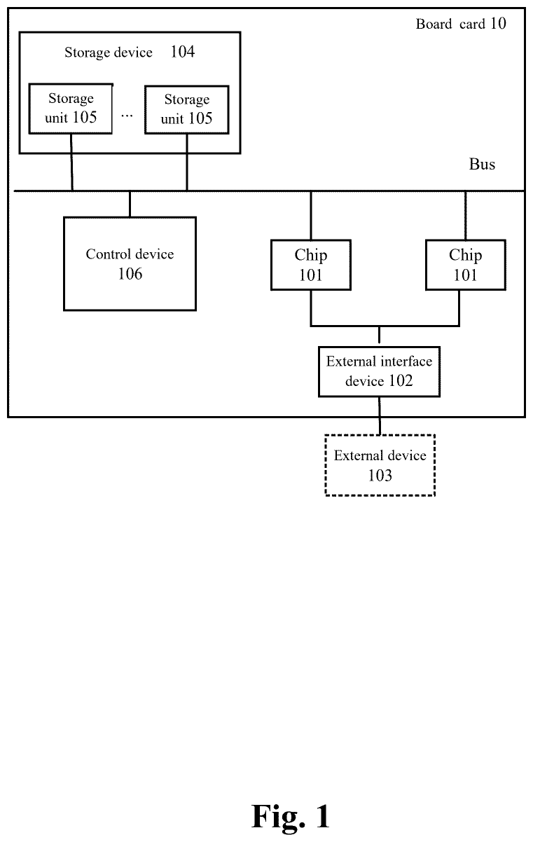

FIG. 1 shows a structural block diagram of a board card 10 according to an embodiment of the present disclosure. As shown in FIG. 1, the board card 10 includes a chip 101, which is a system on chip (SoC), integrated with one or more combined processing devices. The combined processing device is an artificial intelligent computing unit, which is used to support various deep learning and machine learning algorithms to meet the intelligent processing needs in complex scenarios in computer vision, speech, natural language processing, data mining and other fields. In particular, deep learning technology is widely used in the field of cloud intelligence. A significant feature of cloud intelligence applications is the large amount of input data, which has high requirements on the storage and computing capabilities of the platform. The board card 10 of this embodiment is suitable for use in cloud intelligence applications, with huge off-chip storage, on-chip storage and powerful computing capabilities.

The chip 101 is connected to an external device 103 through an external interface device 102. The external device 103 may be, for example, a server, a computer, a camera, a monitor, a mouse, a keyboard, a network card or a WIFI interface. The data to be processed may be transferred to the chip 101 from the external device 103 through the external interface device 102. Computation results of the chip 101 may be transferred back to the external device 103 via the external interface device 102. According to different application scenarios, the external interface device 102 may have different interface forms, such as a peripheral component interface express (PCIe) interface.

The board card 10 also includes a storage device 104 for storing data, which includes one or more storage units 105. The storage device 104 is connected to and transfers data with a control device 106 and the chip 101 through a bus. The control device 106 in the board card 10 is configured to control the status of the chip 101. To this end, in one application scenario, the control device 106 may include a micro controller unit (MCU).

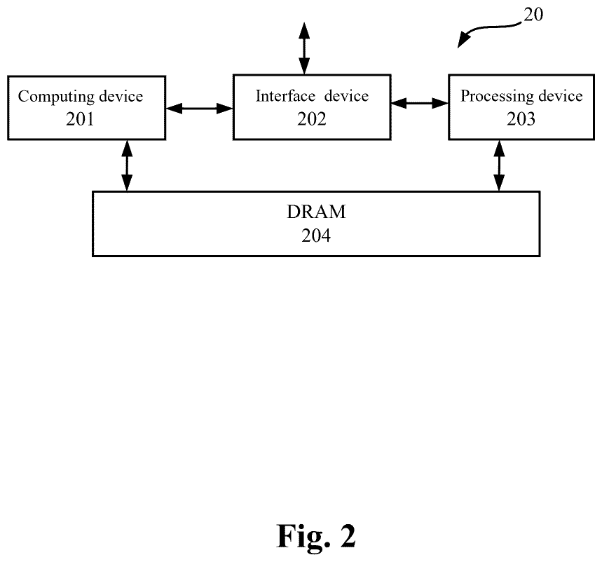

FIG. 2 shows a structural block diagram of a combined processing device in the chip 101 according to an embodiment of the present disclosure. As shown in FIG. 2, the combined processing device 20 includes a computing device 201, an interface device 202, a processing device 203 and a storage device 204.

The computing device 201 is configured to perform user-specified operations, and is mainly implemented as a single-core intelligent processor or a multi-core intelligent processor to perform computation of deep learning or machine learning. The computing device 201 may interact with the processing device 203 through the interface device 202 to jointly complete the user-specified operations.

The interface device 202 is used to transfer data and control instructions between the computing device 201 and the processing device 203. For example, the computing device 201 may obtain input data from the processing device 203 via the interface device 202 and write it into an on-chip storage device of the computing device 201. Further, the computing device 201 may obtain the control instructions from the processing device 203 via the interface device 202 and write them into an on-chip control cache of the computing device 201. Alternatively or optionally, the interface device 202 may also read data in the storage device of the computing device 201 and transfer it to the processing device 203.

As a general processing device, the processing device 203 performs basic control including, but not limited to, data transfer, starting and/or stopping the computing device 201, and the like. Depending on implementations, the processing device 203 may be one or more types of a central processing unit (CPU), a graphics processing unit (GPU), or other general-purpose and/or special-purpose processors. These processors, include, but are not limited to, a digital signal processors (DSP), an application specific integrated circuits (ASIC), a field-programmable gate arrays (FPGA) or others programmable logic devices, discrete gate or transistor logic devices, discrete hardware components, etc., and their number may be determined according to actual needs. As mentioned above, only as far as the computing device 201 of the present disclosure is concerned, it may be regarded as having a single-core structure or a homogeneous multi-core structure. However, when the computing device 201 and the processing device 203 are considered together, they are regarded as forming a heterogeneous multi-core structure.

The storage device 204 is used to store data to be processed, which may be a dynamic random access memory (DRAM), which is a double data rate (DDR) memory. The storage device 204 usually has a size of 16 G or larger and is used to save data of the computing device 201 and/or the processing device 203.

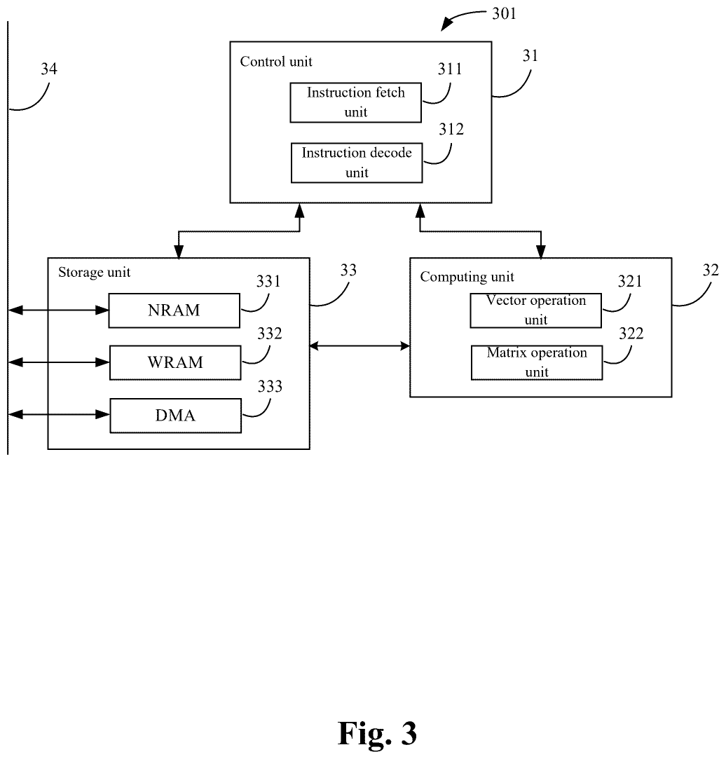

FIG. 3 shows a schematic diagram of an internal structure of a processing core when the computing device 201 is a single-core or multi-core device. The computing device 301 is used to process input data such as computer vision, speech, natural language, and data mining. The computing device 301 includes a control unit 31, a computing unit 32, and a storage unit 33.

The control unit 31 is used to coordinate and control the work of the computing unit 32 and the storage unit 33 to complete the task of deep learning, and includes an instruction fetch unit (IFU) 311 and an instruction decode unit (IDU) 312. The instruction fetch unit 311 is used to obtain instructions from the processing device 203, and the instruction decode unit 312 decodes the obtained instructions and sends decoding results to the computing unit 32 and the storage unit 33 as control information.

The computing unit 32 includes a vector operation unit 321 and a matrix operation unit 322. The vector operation unit 321 is used to perform vector operations and may support complex operations such as vector multiplication, addition, and nonlinear transformation. The matrix operation unit 322 is responsible for core computations of the deep learning algorithm, namely matrix multiplication and convolution.

The storage unit 33 is used to store or transfer relevant data, including a neuron storage unit (neuron RAM, NRAM) 331, a weight storage unit (weight RAM, WRAM) 332, and a direct memory access unit (DMA) 333. NRAM 331 is used to store input neurons, output neurons and intermediate results after computation; WRAM 332 is used to store a convolution kernel of the deep learning network, which is a weight; DMA 333 is connected to a DRAM 204 through a bus 34 and is responsible for data transfer between the computing device 301 and the DRAM 204.

### Exemplary Convolution Operation Types

Based on the foregoing hardware environment, in one aspect, an embodiment of the present disclosure provides a computing device configured to perform a convolution operation, so that the convolution operation in, for example, a neural network model may be optimized. A Conv layer in a neural network model may perform a convolution operation by applying convolution kernels (also called filters, weights, etc.) to input feature maps (also called input data, neurons, or input neurons) to perform convolution processing so as to perform feature extraction. The Conv layer may contain a plurality of convolution kernels, and each element that makes up a convolution kernel corresponds to a weight coefficient and a bias.

The neural network model may contain various convolution operation layers, such as Conv layers that perform forward and conventional 3D convolution operations, and deConv layers that perform depthwise convolution operations. In reverse training, it may be necessary to perform a reverse depthwise convolution operation or a cross product convolution operation. These different types of convolution operations may be performed in the embodiments of the present disclosure.

In conventional 3D convolution operations, it is assumed that the tensor shape of the input feature map in the Conv layer is expressed as X [N Hi Wi Ci], the tensor shape of the convolution kernel is expressed as K [Co Kh Kw Ci], and the output result is Y [N Ho Wo Co], then the simplified mathematical computation formula of the convolution operation may be expressed as follows:

$${Y}_{i n , j c , j h , j w} = {\sum }_{0 \leq i c \leq ci , 0 \leq i h \leq k h , 0 \leq i w \leq kw} {X}_{i n , i c , j h \times s h + i h , j w \times s w + i w} \times {K}_{j c , i c , i h , i w} \qquad ( 1 )$$

In the above formula, X is input data, Y is output data, K is a convolution kernel, Kh is the height of K, Kw is the width of K, and sh is a stride in the height direction, and sw is a stride in the width direction. The bias, padding and dilation are ignored in the formula, and it is assumed that the input data X has been padded and the convolution kernel has been dilated. The N dimension and the C dimension are ignored in the formula. The forward computation of the neural network model is independent in the N dimension and fully connected in the C dimension. When the convolution kernel is working, it will smay the input features according to a certain stride, perform matrix element multiplication and summation on the input features in the convolution window, and superimpose the bias. In conventional 3D convolution operations, element-wise product results in the H, W, and Ci directions are accumulated, and this is called 3D convolution. However, this kind of 3D convolution has constraints: a Ci dimension size of the convolution kernel is equal to a Ci dimension size of the input feature map, so the convolution kernel does not slide in the Ci direction, and it is a pseudo 3D convolution. In order to distinguish it from other convolution operations in this disclosure, the above convolution operation is called a 3D convolution operation.

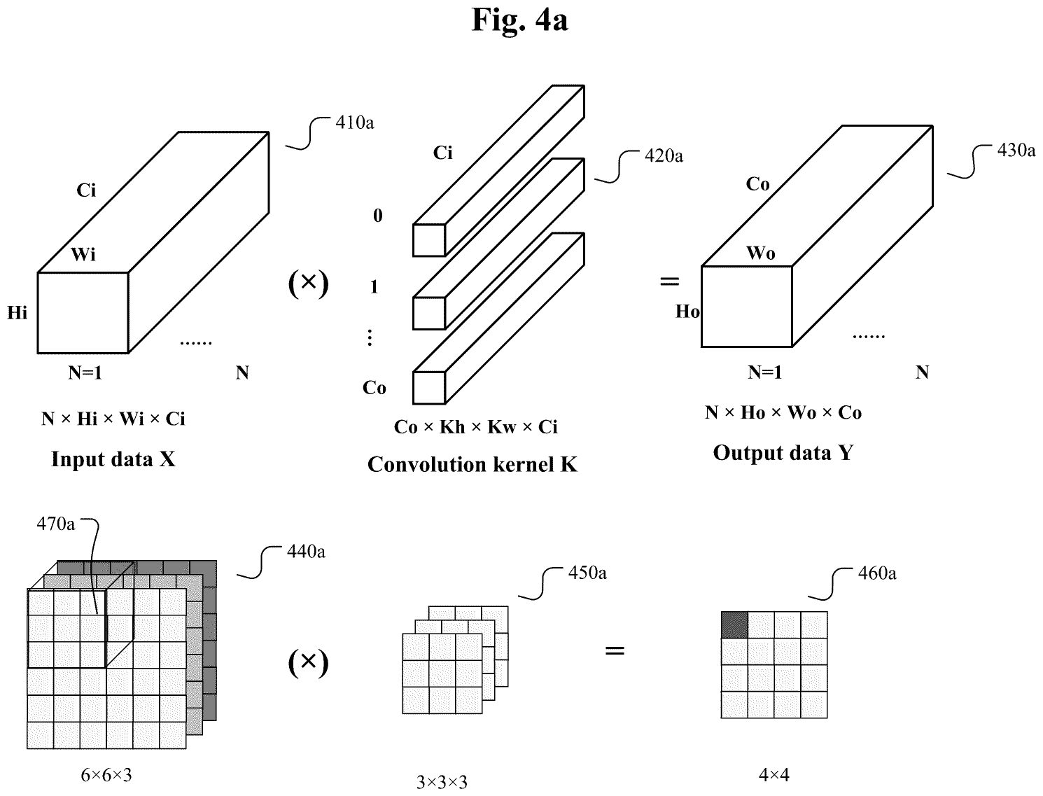

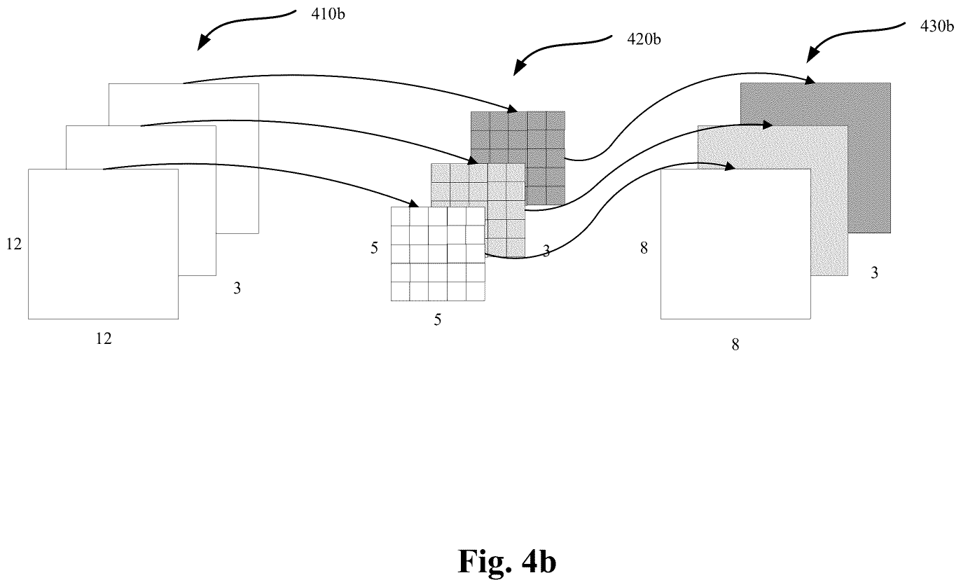

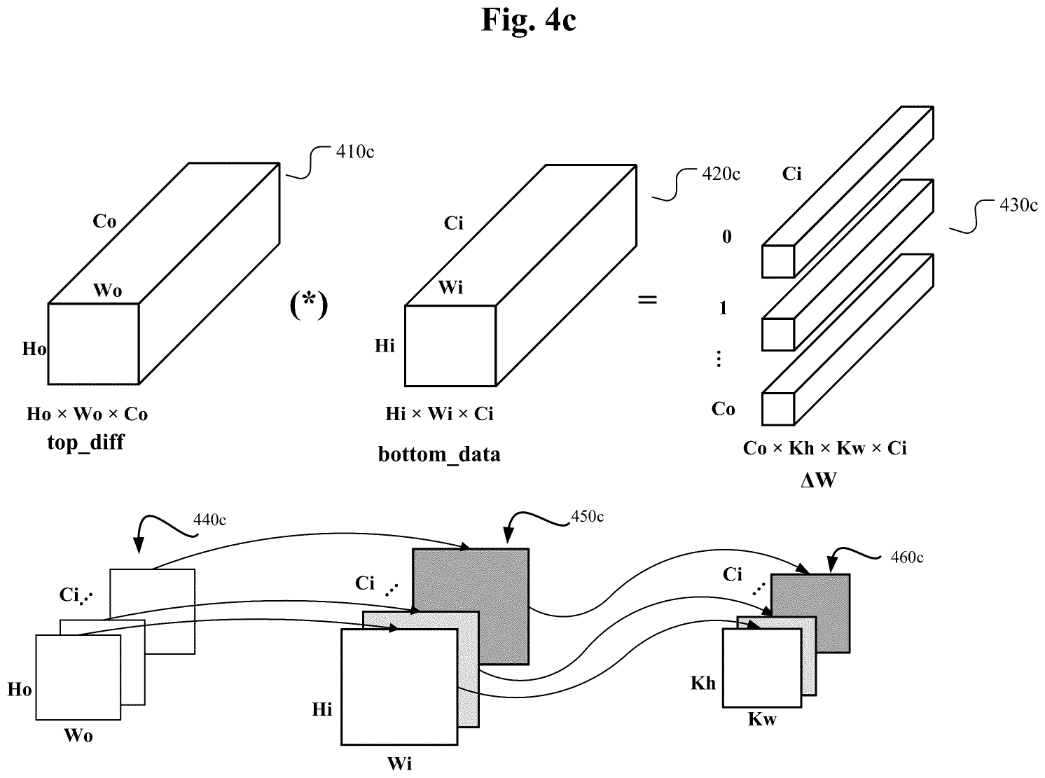

FIG. 4a illustrates an exemplary conventional 3D convolution operation principle example to which an embodiment of the present disclosure may be applied.

The figure exemplarily shows four-dimensional input data X with a size of [N Hi Wi Ci], which may be expressed as N three-dimensional rectangles 410a with a size of Hi×Wi×Ci. The figure also exemplarily shows a four-dimensional convolution kernel K with a size of [Co Kh Kw Ci], which may be expressed as Co three-dimensional convolution kernels 420a with a size of Kh×Kw×Ci. A convolution result of the input data X and the convolution kernel K obtains output data Y, which is four-dimensional data with a size of [N Ho Wo Co] and may be represented as N three-dimensional rectangles 430a with a size of Ho×Wo×Co.

The figure also specifically shows an example of a convolution operation, in which the input data is an input feature map 440a with a size of 6×6×3, omitting the N dimension; the convolution kernel is a three-dimensional convolution kernel 450a with a size of 3×3×3, which is for a single convolution kernel Co; the output data is an output feature map 460a with a size of 4×4. The computation process is as follows:

The convolution kernel 450a slides the input feature map 440a according to a certain stride, performs matrix element multiplication and summation on the input features in the convolution window 470a, and superimposes the bias. That means that a value at each position in the output feature map 460a is obtained by performing a two-dimensional convolution operation on a corresponding block of each input feature map and a corresponding convolution kernel and then adding results of the operation. For example, the figure shows that the value at the (0, 0) position on the output feature map 460a (i.e., the convolution output point) is obtained by performing a two-dimensional convolution operation on the convolution window 470a framed by the black cube in the input feature map and the three-dimensional convolution kernel 450a to obtain 3 values and then adding the 3 values to obtain a final value.

In order to obtain the output at other positions, the position of the convolution kernel 450a may be moved on the input feature map 440a, which means moving the convolution window of the convolution output point. In the example in the figure, a convolution stride (Sx, Sy) is (1, 1), and the value at (0, 1) or (1, 0) on the output feature map 460a may be obtained respectively by performing the convolution operation after the convolution kernel is moved one grid horizontally (in a width direction) to the right or vertically (in a height direction) downward.

It may be seen from the above description that in a Conv layer of the neural network, there are N groups of input feature maps, and each group contains Hi×Wi×Ci pieces of information, where Hi is the height of the input feature map, Wi is the width of the input feature map, and Ci is the number of input feature maps, also called the number of input channels. The Conv layer has Ci×Co convolution kernels with a size of Kh×Kw, where Ci is the number of input channels, Co is the number of output feature maps (or the number of output channels), Kh is the height of the convolution kernel, and Kw is the width of the convolution kernel. The output feature map contains Ho×Wo×Co pieces of information, where Ho is the height of the output feature map, Wo is the width of the output feature map, and Co is the number of output channels. In addition, in the convolution operation, the convolution stride (Sx, Sy) is also involved, and the size of the convolution stride will affect the size of the output feature map.

FIG. 4b illustrates an exemplary depthwise convolution operation principle example to which an embodiment of the present disclosure may be applied.

The difference between depthwise convolution and conventional 3D convolution is that computation results are not accumulated in the depth direction, and the depth direction here refers to the input channel Ci. In conventional 3D convolution, each convolution kernel needs to be computed with all layers (input channels) of the input feature map and corresponding results are accumulated, so the number of input channels of each convolution kernel is equal to the number of input channels of the input feature map. In depthwise convolution, each convolution kernel is a single-channel convolution kernel. One convolution kernel is responsible for one channel, and one channel is convolved by only one convolution kernel. Therefore, the depthwise convolution is sometimes called 2D convolution, which means that sliding accumulation is only performed in the H and W dimensions.

As shown in the figure, the input feature map 410b has a dimension size of 12×12×3, which means it includes three channels, and each channel includes a 12×12 image. Three convolution kernels 420b are respectively used in this depthwise convolution. Each convolution kernel is a single-channel convolution kernel, and has a size of, for example, 5×5×1. Each convolution kernel convolves only one channel of the input feature map 410b. Such convolution obtains an output with a size of 8×8×1 each time, and then these outputs are stacked together to create an 8×8×3 image, finally obtaining an output feature map 430b with a size of 8×8×3. As may be seen from the figure, the depth (number of channels) of the output feature map remains consistent with that of the input feature map.

Since the input channels are not accumulated in depthwise convolution, when depthwise convolution is involved, the dimensions of the input feature map, convolution kernel and output feature map may be simplified to C (channel), H (height), and W (width) dimensions.

In back propagation of neural network model training, the computation of neuron gradient and weight gradient are involved, as shown below:

$$top\_diff W = bottom\_diff \qquad ( 2 )$$

$$top\_diff bottom\_data = Δ W . \qquad ( 3 )$$

In the above formulas, top_diff and bottom_diff are neuron gradients respectively, W is the weight of this iteration, ΔW is the weight gradient computed in this iteration, [symbol] is the computation in back propagation, similar to the convolution operation. Relative to the backward propagation direction, bottom_diff in the previous layer is top_diff in the current layer, and bottom_diff in the current layer is top_diff in the next layer, so an error may be propagated layer by layer in a reverse direction.

In the computation of formula (2), the operation between top_diff is similar to the operation between the input neuron and the weight W, where top_diff is equivalent to the input feature map.

In the computation of formula (3), the operation between top_diff and bottom_data is similar to the depthwise convolution operation, where top_diff is equivalent to the convolution kernel, sliding and accumulating in the X and Y directions of bottom_data. The operation principle may be referred to FIG. 4b. In this computing scenario, the size of top_diff and the size of bottom_data are usually large. The embodiments of the present disclosure also provide an optimization scheme for the convolution operation (referred to as reverse depthwise convolution) in this scenario.

In back propagation, for a Conv layer that performs a conventional 3D convolution operation, the operation in the reverse process may be called a cross product convolution operation. The embodiments of the present disclosure may also provide an optimization scheme for this convolution operation.

FIG. 4c illustrates an exemplary cross product convolution operation principle example to which an embodiment of the present disclosure may be applied.

The figure exemplarily shows three-dimensional data top_diff with a size of [Ho Wo Co], which may be expressed as a three-dimensional rectangle 410c with a size of Ho×Wo×Co; the figure also shows three-dimensional data bottom_data with a size of [Hi Wi Ci], which may be expressed as a three-dimensional rectangle 420c with a size of Hi×Wi×Ci. A cross product convolution operation is performed on top_diff and bottom_data to obtain output data 430c, which is four-dimensional data with a size of [Co Kh Kw Ci] and may be expressed as Co three-dimensional rectangles 430c with a size of Kh×Kw×Ci. Comparing with FIG. 4a, it may be seen that the cross product convolution in FIG. 4c is equivalent to a reverse operation of the conventional 3D convolution, which means that the convolution kernel is computed through the output feature map (top_diff) and the input feature map (bottom_data). The N dimension is omitted in FIG. 4c.

Specifically, for data of each HoWo plane in top_diff, which means that, for the HoWo plane of each Co value, Ci copies are copied to obtain the data 440c of Ho×Wo×Ci. A depthwise convolution operation is performed on the data 440c and bottom_data (refer to the schematic diagram of FIG. 4b), which means that computation results are not accumulated in the Ci direction, thereby obtaining the output 460c, which is three-dimensional data with a size of Kh×Kw×Ci. The copy and depthwise convolution operation are repeated for each HoWo plane, thus obtaining Co pieces of three-dimensional data with the size of Kh×Kw×Ci, which means obtaining a four-dimensional convolution kernel 430c with a size of Co×Kh×Kw×Ci.

In this disclosure, input feature map (feature map), input data, neuron or input neuron may be used interchangeably; convolution kernel, filter or weight may be used interchangeably. Additionally, the H (height) and Y dimensions may be used interchangeably, and the W (width) and X dimensions may be used interchangeably. Correspondingly, the H dimension of the input feature map may be expressed as Hi or Yi, the H dimension of the output feature map may be expressed as Ho or Yo, and the W dimension may be expressed similarly. In the embodiment of the present disclosure, each convolution output point has a corresponding convolution window, and the shape of the convolution window is equal to the shape of the convolution kernel. The value of each convolution output point corresponds to a result of an element-wise multiply-accumulate operation of the input feature map and the weight in its convolution window. In addition, no matter which type of convolution operation is involved, the data involved may be split into input feature map, convolution kernel and output feature map. For example, in the reverse operation, top_diff corresponds to a convolution kernel, bottom_data corresponds to an input feature map, and ΔW corresponds to an output feature map.

### Exemplary Computing Device

In the embodiment of the present disclosure, a master-slave structured computing device may be used to implement the above convolution operation. Furthermore, different data paths may be configured for the input feature map and the convolution kernel, thereby improving memory access efficiency.

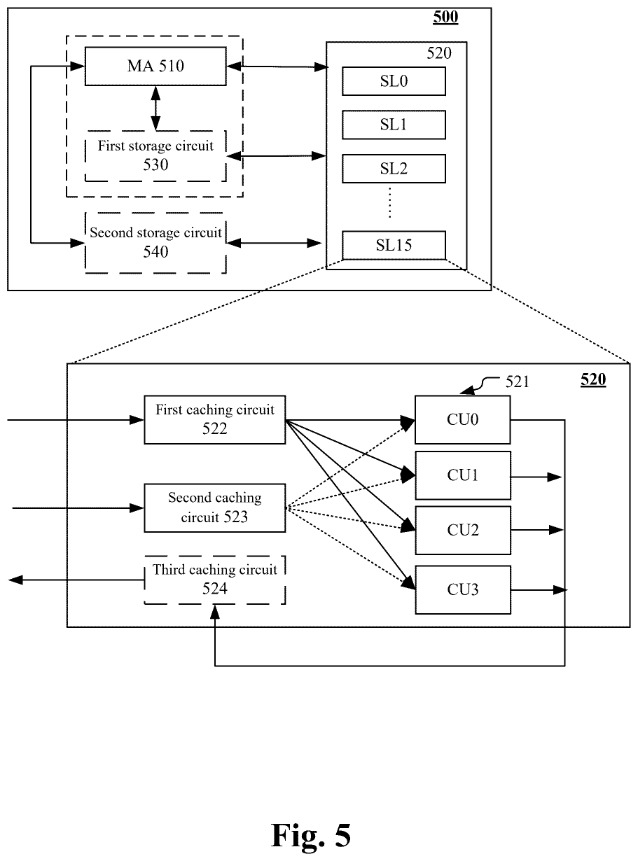

FIG. 5 shows a schematic structural block diagram of a computing device 500 according to an embodiment of the present disclosure. It may be understood that this structure may be viewed as a refinement of the internal structure of the computing unit of a single processing core in FIG. 3, or as a joint functional splitting block diagram based on computing units of a plurality of processing cores shown in FIG. 3. As shown in FIG. 5, the computing device 500 of the embodiment of the present disclosure may be configured to perform various types of convolution operations, and may include a master processing circuit (MA) 510 and a plurality of slave processing circuits (SLs) 520. In this figure, 16 slave processing circuits SL0˜SL15 are shown. Those skilled in the art may understand that the number of the slave processing circuits may be more or less, depending on the specific hardware configuration, and the embodiments of the present disclosure are not limited in this regard.

The master processing circuit and the slave processing circuit may communicate with each other through various connections, and the plurality of slave processing circuits may also communicate with each other through various connections. In different application scenarios, the connection among the plurality of slave processing circuits may be either a hard connection arranged through hard wires, or a logical connection method configured according to, for example, microinstructions to form a variety of topologies of slave processing circuit arrays. The disclosed embodiments are not limited in this regard. The master processing circuit and the slave processing circuit may cooperate with each other to achieve parallel computing processing.

In order to support computing functions, the master processing circuit and the slave processing circuit may include various computing circuits, such as a vector operation unit and a matrix operation unit. The vector operation unit is used to perform vector operations and may support complex operations such as vector multiplication, addition, and nonlinear transformation. The matrix operation unit is responsible for core computations of the deep learning algorithm, for example, matrix multiplication and convolution.

The slave processing circuit, for example, may be configured to perform intermediate operations on corresponding data in parallel to obtain a plurality of intermediate results according to the operation instructions, and transfer the plurality of intermediate results back to the master processing circuit.

By configuring the computing device 500 into a master-slave structure (such as a master multi-slave structure, or a multi-master multi-slave structure, which is not limited in the present disclosure), for the computation instructions of forward operations, the data may be split according to the computation instructions. Therefore, a plurality of slave processing circuits may be used to perform parallel operations on parts with a large amount of computation to increase the operation speed and save computation time, thereby reducing power consumption.

In some embodiments of the present disclosure, by using different data paths to transfer input feature maps and weights, a plurality of reuse methods of input feature maps and weights may be supported, thereby reducing the amount of data access during computation and improving processing efficiency.

Specifically, the computing device 500 may further include a first storage circuit 530 and a second storage circuit 540 for storing data transferred via different data channels respectively. Optionally, the first storage circuit 530 and the second storage circuit 540 may be two memory blocks formed by splitting the same memory, or they may be two independent memories, which are not specifically limited here.

The first storage circuit 530 may be used to store multicast data, which means that the data in the first storage circuit will be transferred to a plurality of slave processing circuits through a broadcast bus, and these slave processing circuits receive the same data. It may be understood that broadcast and multicast may be implemented through the broadcast bus. Multicast refers to a communication method that transfers a piece of data to a plurality of slave processing circuits; broadcast is a communication method that transfers a piece of data to all slave processing circuits, and is a special case of multicast. Since both multicast and broadcast correspond to one-to-many transmission, the two are not specifically distinguished in this disclosure. Broadcast and multicast may be collectively referred to as multicast, and those skilled in the art may clarify their meanings according to the context.

The second storage circuit 540 may be used to store distribution data, which means that the data in the second storage circuit will be transferred to different slave processing circuits respectively, and each slave processing circuit receives different data.

By separately providing the first storage circuit and the second storage circuit, it is possible to support transmission of data to be computed in different transmission methods, thereby reducing the amount of data memory access by reusing multicast data among a plurality of slave processing circuits.

In some embodiments, one of the input feature map and the convolution kernel may be determined as multicast data and stored in the first storage circuit, so that the data is transferred to a plurality of scheduled slave processing circuits by broadcasting during the computation. Correspondingly, the other one of the input feature map and the convolution kernel may be determined as distribution data and stored in the second storage circuit. These pieces of distribution data may be distributed to the corresponding slave processing circuits before computation.

FIG. 5 also shows a schematic diagram of the internal structure of the slave processing circuit SL according to an embodiment of the present disclosure. As shown in the figure, each slave processing circuit 520 may include a plurality of computing circuits CU 521, a first caching circuit 522 and a second caching circuit 523. The figure shows 4 computing circuits CU0˜CU3. Those skilled in the art may understand that the number of computing circuits may be more or less, depending on the specific hardware configuration, and the embodiments of the present disclosure are not limited in this regard.

In some embodiments, the first caching circuit 522 may be used to cache a weight or input feature map allocated to the slave processing circuit. Correspondingly, the second caching circuit 523 may be used to cache the input feature map or weight allocated to the slave processing circuit. Both caching circuits are used to select data to participate in computations. The data of the first caching circuit 522 may be a plurality of data lines from, for example, the first storage circuit 530 or the second storage circuit 540. Correspondingly, the data of the second caching circuit 523 may be a plurality of data lines from, for example, the second storage circuit 540 or the first storage circuit 530. Depending on the specific reuse method, these data lines may be distributed to the corresponding computing circuit CU 521 or broadcast to all CUs 521 within the slave processing circuit 520 during computation.

Each computing circuit CU 521 is configured to perform an element-wise multiply-accumulate operation on the data lines selected from the first caching circuit and the data lines selected from the second caching circuit in each cycle of computation.

By separately providing the first caching circuit and the second caching circuit, it is possible to support transmission of data to be computed in different transmission methods, thereby reducing the amount of data memory access by reusing data among a plurality of computing circuits within a single slave processing circuit as much as possible.

The slave processing circuit 520 may also include a third caching circuit 524 for caching the computation results of each computing circuit CU 521.

It may be understood that although each processing circuit and storage circuit are shown as separate units in FIG. 5, the storage circuit and the processing circuit may also be combined into one unit according to different configurations. For example, the first storage circuit 530 may be combined with the master processing circuit 510, and the second storage circuit 540 may be shared by the plurality of slave processing circuits 520, and may allocate an independent storage area for each slave processing circuit to speed up access. The disclosed embodiments are not limited in this regard. In addition, in the computing device, the master processing circuit and the slave processing circuits may belong to the same processor or different units of a chip, or may belong to different processors. The disclosure is not limited in this regard.

### Exemplary Data Splitting and Storage

In the embodiment of the present disclosure, the dimensions of the multidimensional data involved are represented as (N, H, W, C) or (Co, H, W, Ci), which represents the storage order of the data in the memory. It may be understood that although multidimensional data has a plurality of dimensions, the multidimensional data corresponds the storage order on the memory because the layout of the memory is always one-dimensional. Multidimensional data is usually allocated in continuous storage space, which means that multidimensional data may be expanded in one dimension and stored in the memory in sequence. For example, in the embodiment of the present disclosure, the initial input feature map may be stored sequentially in a low-dimensional (here C/Ci is the lowest dimension) priority manner. In order to optimize the convolution operation, during the computation or before the computation, the storage order of input feature maps may be adjusted, as will be described in detail later. Adjacent dimensions refer to dimensions that are close to each other in the dimensional information representation of multidimensional data. For example, W and Ci are adjacent, and adjacent dimensions may also be called continuous dimensions.

In intelligent processors, due to the need for computing power and the consideration of area and power consumption, the main computing unit of the hardware is a vector multiply-accumulate arithmetic unit. Implementing support for various convolution algorithms in hardware design is essentially to maximize the extraction of multiply-accumulate operation in the algorithms and efficiently exchange input and output data of the multiply-accumulate operation between an on-chip RAM (such as NRAM, WRAM, etc. in FIG. 3) and the arithmetic unit through a data path.

In the hardware, data is stored in lines (cache lines). Read, write, and computation operations are most efficient when the entire line is aligned. Therefore, in order to fully utilize the bandwidth and adapt to the requirements such as the amount of access to an arithmetic unit array, data typically needs to be aligned for vectorization. The design of an artificial intelligence chip usually takes the Ci dimension as the lowest dimension, which is in the arrangement order of NHWC mentioned above. The data in the Ci dimension are continuous. Therefore, the data alignment for vectorization t requires a size of the Ci dimension to be aligned to a specified value, such as an alignment value M, thereby accessing data in units of the alignment value M, where M may also be called a maximum computation amount of hardware at a time. Based on different hardware designs, M may have different values, such as 64 bit, 128 bit, 256 bit, 512 bit, etc. Usually, an input port size of the arithmetic unit array is also related to M. For example, when an input data bit width is symmetrical, the input port size of the arithmetic unit array is usually twice of M, which means that input feature map data and weight data of the alignment value M scale are processed at one time. When the Ci dimension of the input feature map is large, it is easy to meet the above alignment requirements.

When the Ci dimension of the input feature map is small, for example, smaller than the size of a cache line, the Ci dimension needs to be padded to one line of data (for example, 512 bits), that is, by filling with invalid data 0. This kind of padding will cause a lot of redundant computations, resulting in a waste of resources and reducing the efficiency of computations.

In the embodiment of the present disclosure, a convolution operation scheme is proposed, which may be executed by the computing device of FIG. 5, for example. The master processing circuit is configured to obtain the input feature map and/or the convolution kernel, and the input feature map and the convolution kernel have been split into a plurality of splitting units according to a convolution splitting scheme and their dimension storage orders have been converted, so that the data in a splitting unit are continuously stored in one data line. Depending on different hardware configurations and/or other considerations, the above splitting and dimension conversion of the input feature map and the convolution kernel may be performed at different locations and at different times. During the update of neuron gradients in the back propagation, top_diff may be regarded as the input feature maps

In some embodiments, the master processing circuit may include a blocking circuit, which means that the blocking circuit is integrated in the master processing circuit, and is used to split and dimensionally convert the input feature map and the convolution kernel respectively for storage. For example, the master processing circuit may read the input feature map and convolution kernel in an original storage format from an external storage circuit (such as a double data rate (DDR)), and then split and dimensionally convert the input feature map and the convolution kernel respectively using the blocking circuit, and then store one of the input feature map and the convolution kernel in a first storage circuit and the other in a second storage circuit. The above splitting process may be performed either during or before the operation to prepare data.

In other embodiments, the master processing circuit may include a partial blocking circuit for only splitting and dimensionally converting data determined as multicast data in the input feature map and the convolution kernel for storage, while data determined as distribution data may be split and dimensionally converted by an external blocking circuit. For example, in an implementation, a convolution kernel determined as the distribution data may be pre-stored in the second storage circuit after being split and dimensionally converted by the external blocking circuit. Specifically, the convolution kernel may be stored directly from an off-chip storage circuit to the second storage circuit, or may be stored to the second storage circuit through the first storage circuit.

In some embodiments, the master processing circuit may not include the blocking circuit at all or not perform the function of the blocking circuit. In these embodiments, the input feature map and convolution kernel are split and dimensionally converted by a blocking circuit independent of the master processing circuit. One of the input feature map and convolution kernel after splitting and dimensional conversion may be stored in the first storage circuit, and the other may be stored in the second storage circuit.

A corresponding convolution splitting scheme may be determined based on the size of the lowest storage dimension (such as Ci) of the input feature map, where the convolution splitting scheme at least indicates a shape of a splitting unit of to-be-computed data. The amount of data contained in a single splitting unit is less than or equal to the maximum computation amount of hardware at a time.

In some embodiments, the amount of data contained in a single splitting unit may be set to an one-time processing alignment value M of the hardware, so that operations may be processed in units of the splitting unit, which may give full play to the computing power of the hardware and avoid or reduce invalid computations.

In the illustrative description of the present disclosure, it is assumed that M=512 bit-64 Byte, the data type may be Int8, Int16, Float16, or Float32, and the data type of the input feature map is consistent with that of the convolution kernel. Since the data type requires a width of at least 1 byte, and the smallest unit of operation processing is a piece of data, various computations are performed in bytes in the following examples, such as M=64 B, Ci=28 B, and so on, where units are sometimes omitted for brevity.

When the amount of data in the splitting unit is equal to M, a data block shape of each splitting unit is blockC*blockY*blockX, which may exist in many cases, and Table 1 lists several of them.

TABLE 1
Data block shape

Data type

| Data block shape | Int8 | Int16/ Float16 | Float32 |
|---|---|---|---|
| 64B × 1 × 1 | 64 × 1 × 1 | 32 × 1 × 1 | 16 × 1 × 1 |
| 32B × 2 × 1 | 32 × 2 × 1 | 16B × 2 × 1 | 8 × 2 × 1 |
| 16B × 2 × 2 | 16 × 2 × 2 | 8 × 2 × 2 | 4 × 2 × 2 |
| 16B × 4 × 1 | 16 × 4 × 1 | 8 × 4 × 1 | 4 × 4 × 1 |
| 8B × 4 × 2 | 8 × 4 × 2 | 4 × 4 × 2 | 2 × 4 × 2 |
| 4B × 4 × 4 | 4 × 4 × 4 | 2 × 4 × 4 | 1 × 4 × 4 |
| 4B × 8 × 2 | 4 × 8 × 2 | 2 × 8 × 2 | 1 × 8 × 2 |

As may be seen from Table 1 that X and Y dimensions of some data block shapes are equal in size (as shown in the dark lines). Such shapes may simplify subsequent operations. Therefore, in the embodiment of the present disclosure, it is preferable to use this data block shape to split to-be-computed data.

For simplicity, a 64 B×1×1 shape splitting scheme is called Forward64, a 16 B×2×2 shape splitting scheme is called Forward16, and a 4 B×4×4 shape splitting scheme is called Forward4. A 4 B×4×4 shape splitting scheme applied to a depthwise convolution operation is called Forward1, a 4 B×4×4 shape splitting scheme applied to a reverse depthwise convolution operation is called Update1, and a 4 B×4×4 shape splitting scheme applied to a cross product convolution operation is called Update4. In addition to Forward64, these splitting schemes are suitable for scenarios where a channel C is relatively small in convolution operation, so they may also be collectively referred to as a lite convolution. In these lite convolution splitting schemes, a single splitting unit includes data in the lowest storage dimension and at least one other storage dimension, and the total data amount of a single splitting unit is less than or equal to the maximum computation amount of hardware at a time.

Different convolution splitting schemes may be applied to different operation scenarios, so as to obtain different degree of performance optimization. Specifically, in some embodiments, a corresponding convolution splitting scheme may be determined according to at least one of the following rules:
aligning the lowest storage dimension Ci of the input feature map before splitting to a multiple of the nearest M/4ⁿ, where M is the maximum computation amount of hardware at a time, n=0, 1, . . . ½ log₂ M−1, and a size Uci (blockC) of the splitting unit in the lowest storage dimension is determined as M/4ⁿ;
taking the maximum value of M/4ⁿ or the M/4ⁿ with the smallest alignment padding amount as the Uci if there are a plurality of multiples of the nearest M/4ⁿ; and
determining sizes Ux (blockX) and Uy (blockY) of the splitting unit in the X and Y storage dimensions, such that Uci×Uy×Ux=M, where Ux=Uy is preferred.

The application of the above rules is described in combination with several examples in the following. Assuming M=64 in all examples, M/4ⁿ may be 64, 16, and 4.

In an example, if Ci=28, the lowest storage dimension is aligned to 4*7, which is the multiple of the nearest M/4ⁿ, and at this time, the size Uc (blockC) of the splitting unit in the lowest storage dimension is determined as 4. When Ux=Uy is preferred, the shape of the splitting unit may be determined as 4 B×4×4, which is the Forward4 scheme.

In another example, assuming Ci=112, if the lowest storage dimension is aligned to 64*2=128, 16 zeros are required to be padded; if the lowest storage dimension is aligned to 16*7=112, no zero is required to be padded; if the lowest storage dimension is aligned to 4*28=112, no zero is required to be padded. At this time, the multiple of the nearest M/4ⁿ is 16*7=4*28=112, and according to the rule, the maximum value of M/4ⁿ, which is 16, may be taken as the Uc. When Ux=Uy is preferred, the shape of the splitting unit may be determined as 16 B×2×2, which is the Forward16 scheme.

After the splitting scheme is determined, the input feature map and the convolution kernel may then be split into a plurality of corresponding splitting units according to the determined convolution splitting scheme, and their dimension storage order may be converted, so that data in a splitting unit is continuously stored as a data line, so as to facilitate subsequent reading processing in units of splitting units (data lines).

In some embodiments, for three-dimensional or four-dimensional neuron or weight data, all of them are split into data blocks of size blockC*blockY*blockX (Uc×Uy×Ux), each of which is stored consecutively on a line of M=64 B, so that when a line of data is read, data of a data block is actually fetched.

Specifically, one or more splitting units may be read according to a first read order in units of splitting units from to-be-computed data stored in the first dimension storage order, and the read splitting units are stored on corresponding storage circuits, where data in each splitting unit is stored according to a second dimension storage order, and data between splitting units is stored according to a third dimension storage order.

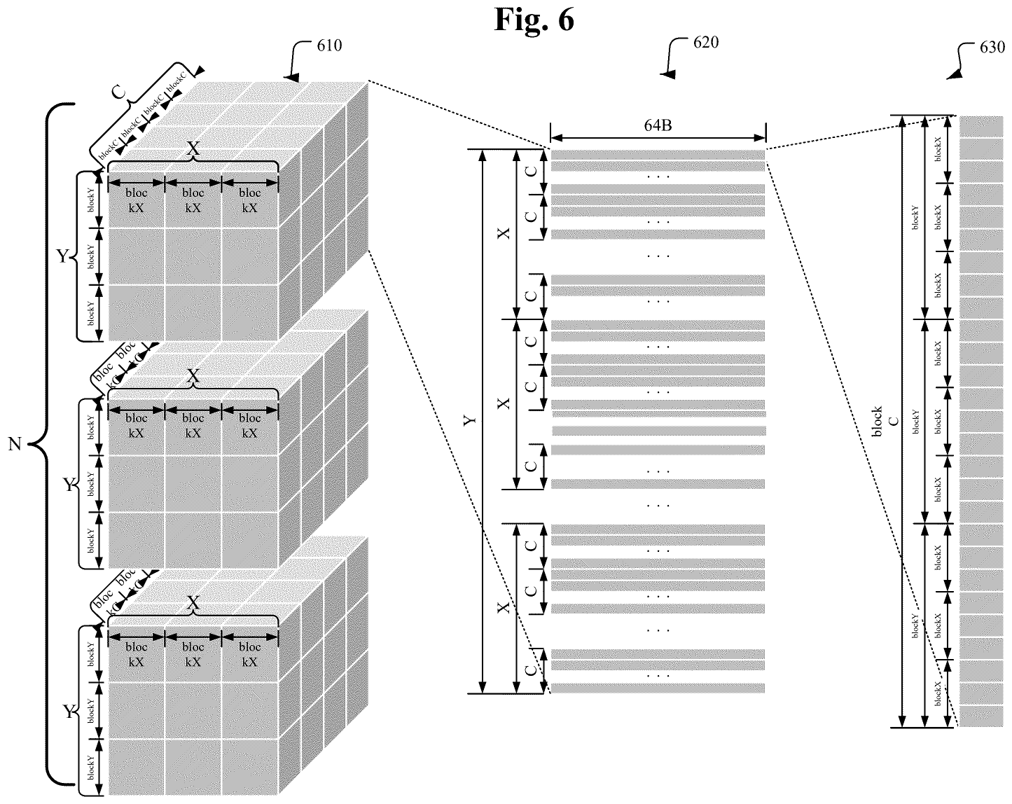

FIG. 6 shows an exemplary data storage order according to an embodiment of the present disclosure.

As shown in the figure, 610 represents a storage method of a to-be-computed four-dimensional tensor, including N three-dimensional sub-tensors, where N is in the highest dimension, which means that a first dimension storage order of the four-dimensional tensor is NHWC. It should be noted that both H and Y, and W and X may be used interchangeably in the present disclosure. Each sub-tensor is split into smaller data blocks or splitting units, with the number of data blocks in each dimension being C/Y/X respectively.

A middle diagram 620 shows how each sub-tensor is stored, with each data block being stored as a contiguous 64 Byte, or a line. When orders of reading the data blocks are different, orders between the lines will correspondingly change as well. In an example provided in the diagram, data blocks are read in an order of C first, then X, and finally Y; in other words, the first reading order is YXC. Consequently, the lines are stored in the order of Y*X*C; in other words, the third dimension storage order is YXC or HWC. In this example, the third dimension storage order is the same as the first dimension storage order. It is understood that other reading orders may be adopted, which may result in the third dimension storage order being different from the first dimension storage order, and this example will not list them all one by one.

A diagram 630 on the right illustrates an order within each line, i.e., a data order within each block, and a shape of the data block is blockC*blockY*blockX. At this time, the second dimension storage order is CYX or CHW. The specific splitting scheme will be described in detail later in combination with various exemplary convolution splitting schemes.

### Exemplary Grouping Operation and Data Reuse

The above has described a hardware structure of the computing apparatus and an exemplary splitting scheme and storage method of data of the present disclosure. The above hardware structure may provide different data paths for input feature maps and weights involved in the operation, so that different data transmission modes (such as broadcast, multicast, distribution, etc.) may be used to reduce data access quantity during the operation and improve operation efficiency. A computation of convolution involves each input feature map undergoing multiply-add operations with a convolution kernel of each Co to output Co output feature maps. However, it is not always possible to store all sizes of convolution kernels and input feature maps in on-chip space at the same time, so there are a series of repeated loading of input feature data or weight data on the hardware, and how to balance the repeated loading of input feature data or weight data may have a certain impact on the efficiency of the computation. In an actual operation, in order to reduce frequent off-chip memory access, different reuse methods may be adopted according to scale characteristics of data involved in the operation. In a convolution operation, there are two kinds of data reuse methods: convolution kernel reuse and input feature map reuse.

According to reuse scenario, the convolution kernel reuse may be split into intra-channel convolution kernel reuse and inter-batch convolution kernel reuse. The intra-channel convolution kernel reuse is for the case of a single output channel, i.e., a single output feature map, in which there is only one set of convolution kernel. For each input feature map, a plurality of convolution windows may reuse a same convolution kernel. Inter-batch convolution kernel reuse is for batch processing, i.e., a plurality of input images being processed simultaneously. The plurality of input images are processed using a same convolution kernel set, so the convolution kernel may be reused.

Similarly, according to reuse scenarios, the input feature map reuse may be split into intra-channel input feature map reuse and inter-channel input feature map reuse. The intra-channel input feature map reuse is for a single output channel, which means that for each input feature map, its adjacent convolution window may reuse a part of data of the input feature map. The inter-channel input feature map reuse is for the case of a plurality of output channels, i.e., a plurality of output feature maps (a plurality of sets of convolution kernel), in which input feature maps in a single convolution window may be convolved with a plurality of sets of convolution kernel.

According to the principle of the convolution operation described above, it may be seen that computation results in the Co dimension (the C dimension of the depthwise convolution operation) are not required to be accumulated, and thus operations in different Cos may be performed relatively independently on different computing circuits. In the case of a small number of input channels, the convolution kernel is generally small; for example, Kh and Kw are usually single digits, and Co is about the same size as Ci. In these embodiments, typically in a single round of computation, a size of an output channel Co dimension of a convolution kernel is less than or equal to the number of slave processing circuits that are scheduled, so that the computation of a single Co is completed by one or more slave processing circuits. More generally, even when the Co dimension is large, the convolution operation may be completed by splitting it into a plurality of rounds of computation, where the size of Co processed in each round is less than or equal to the number of slave processing circuits that are scheduled. Thus, in an example, the number of rounds of computations required to complete the convolution operation and the number of Cos processed in each round of computation or a corresponding grouping mode may be first determined based on the size of the output channel Co dimension of the convolution kernel and the number Ns of schedulable slave processing circuits.

When determining the number of rounds of computations required to complete the convolution operation, the number of Cos processed in each round may not be the same, so that there may be a plurality of allocation methods even for the same Co dimension size.

For example, taking a computing apparatus with 16 slave processing circuits SL as shown in FIG. 5 as an example, it is assumed that all slave processing circuits are schedulable, i.e. Ns=16. When Co=40, the convolution operation may be split into three rounds of computation, the first 16 Co values are processed in the first round, with each SL processing a different Co value; the next 16 Co values are processed in the second round, with each SL processing a different Co value; the remaining 8 Co values are processed in the final round, with each 2 SLs processing a different Co value. In the other allocation method, the convolution operation may also be split into two rounds of computation, the first 32 Co values are processed in the first round, with each SL processing 2 different Co values; the remaining 8 Co values are processed in the final round, with each 2 SLs processing a different Co value. For example, when Co=12, the convolution operation may be split into a single round of computation, with each SL processing a different Co value, where four SLs are idle or perform invalid operations. In the other allocation method, the convolution operation may also be split into three rounds of computation, processing four consecutive Co values at a time, with each 4 SLs processing a different Co value, thus utilizing all schedulable slave processing circuits in each round of computation. It is understandable that many other allocation methods may be envisaged by those skilled in the art.

It may be seen that regardless of allocation methods, there are two possible allocations of Co in a single round of computation: a plurality of slave processing circuits process a single Co value, or a single slave processing circuit processes one or more Co values. Specifically, in a single round of computation for processing Nco output channels, each Rs of SLs may constitute a slave processing circuit group SLB for processing a convolution kernel corresponding to a same output Co value, and Rs=[Ns/Nco]; in other words, the same convolution kernel is reused over Rs of SLs within the same SLB, where Rs indicates the number of times that the convolution kernel is reused among the slave processing circuits. Correspondingly, the input feature map may be reused among the slave processing circuit groups SLBs, where Rn=[Ns/Rs], which indicates the number of times that the input feature map is reused among the slave processing circuits.

Optionally or additionally, when each slave processing circuit processes convolution kernels corresponding to rn Co values, where rn=[Nco/Ns], at this point, the input feature map processed by each slave processing circuit may be reused for rn convolution kernels, where rn indicates the number of times that the input feature map is reused in a single slave processing circuit. Factors such as constraints on caching space of hardware (such as the size of the first caching circuit and the size of the second caching circuit in FIG. 5) may be considered to determine the maximum number of times rs that the convolution kernel is reused in a single slave processing circuit, and the maximum number of times rn that the input feature map is reused.

Taking into account the limitations of cache size in hardware circuits and the benefits of reuse, in some embodiments disclosed herein, a scenario where a slave processing circuit processes a plurality of Co values in a single round of computation is temporarily not considered, and only a scenario where one or more slave processing circuits process only one Co value in a single round of computation is considered.

Depending on the number of slave processing circuits SL that process a same Co value in a single round of computation, different grouping modes may be adopted. It may be understood that, preferably, the available slave processing circuits SL are allocated evenly to balance the computing power. For example, every 2 SLs may be grouped together, allowing 16 SLs to simultaneously process 8 Co values; or every 4 SLs may be grouped together, allowing 16 SLs to simultaneously process 4 Co values, and so on. In some embodiments, for the computing apparatus including Ns=16 Sls shown in FIG. 5, several grouping modes may be selected: Group1 mode, Group 4 mode, and Group 16 mode. Those skilled in the art may understand that, depending on the value of Ns, there may be different grouping modes, and each grouping mode may be processed correspondingly by referring to the three representative grouping modes provided in the present disclosure.

In some embodiments, the aforementioned grouping modes may be uniformly represented as GroupN, indicating that in the current round of computation, all scheduled slave processing circuits SL are split into N groups, with each slave processing circuit group SLB processing a same Co value, and different slave processing circuit groups SLB processing different Co values. In a scenario where there are a total of 16 SLs available for scheduling, N may be 1, 4, or 16, corresponding to the Group1, Group 4, and Group 16 modes described earlier respectively.

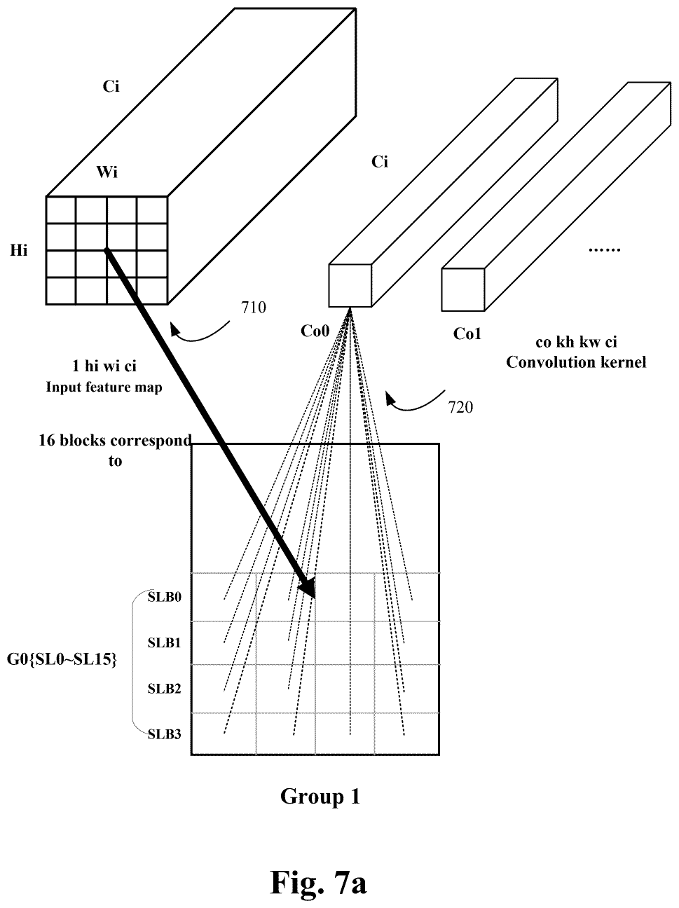

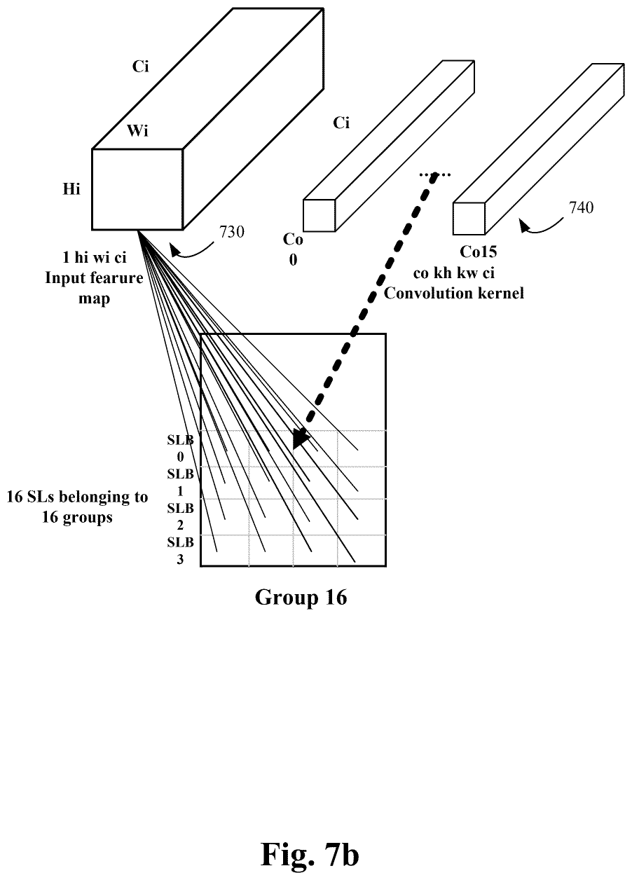

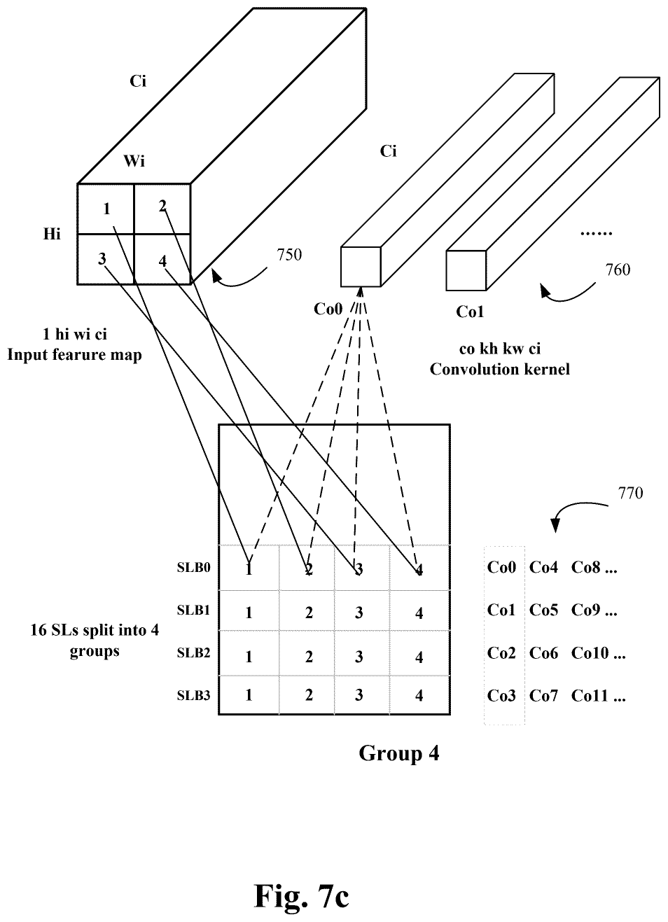

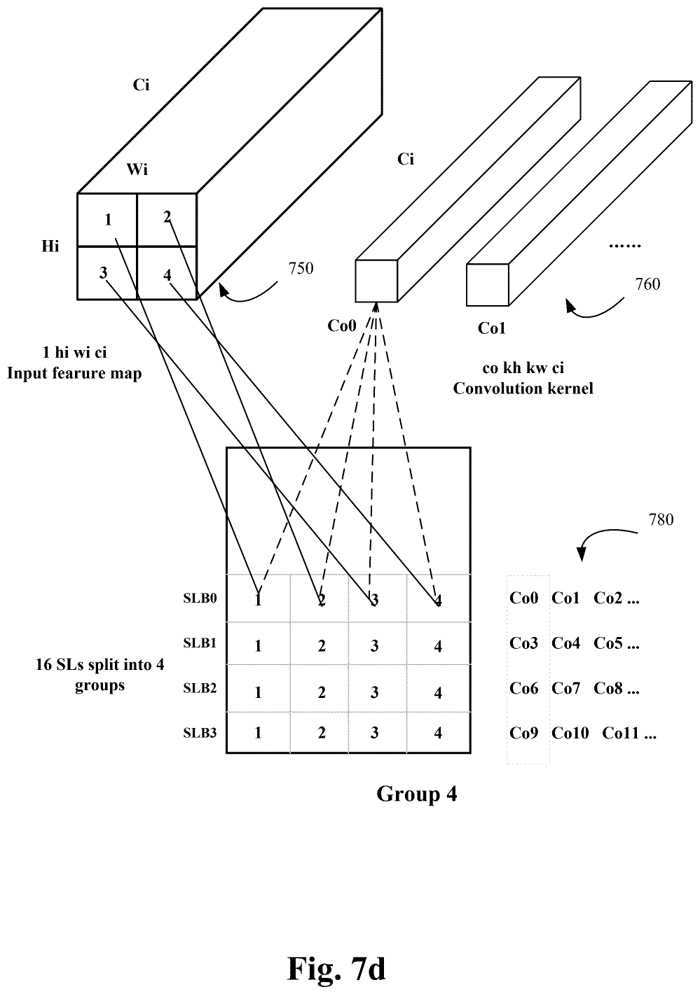

FIG. 7a-FIG. 7d illustrate several exemplary grouping modes according to embodiments of the present disclosure. FIG. 7a illustrates a Group1 mode, FIG. 7b illustrates a Group16 mode, FIG. 7c illustrates a Group4 mode, and FIG. 7d illustrates another Group4 mode.

As shown in FIG. 7a, the Group1 mode refers to all 16 schedulable SLs belonging to one group and collectively processing a single Co value. For example, SL0 to SL15 belong to a group G0. Thus, the computation for one output channel is distributed over 16 SLs. In this mode, it is preferable to consider broadcasting a convolution kernel 720 of the output channel to each SL and splitting and allocating an input feature map 710 to each SL, thereby improving memory access efficiency.

In an embodiment, the convolution kernels are stored in the first storage circuit 530 as shown in FIG. 5 to take advantage of the broadcast channel for transfer. The input feature map may be split along the X and Y directions of an output feature map and stored in the second storage circuit 540 to be allocated to different SLs. Therefore, all SLs work together to compute an output feature map of one Co. The splitting and storage of the input feature map will be described in detail later in conjunction with the drawings.

As shown in FIG. 7b, the Group16 mode refers to splitting all 16 schedulable SLs into 16 groups; in other words, one SL per group, with each SL processing a different Co value. For example, an SL0 belongs to a group G0, an SL1 belongs to a group G1, and so on, until an SL15 belongs to a group G15. In this mode, a same input feature map 730 may be reused among the 16 SLs, so it may be prioritized to transmit the input feature map 730 to each SL in a broadcast manner, while the convolution kernel 740 corresponding to different Co values is distributed to the respective SLs.

In an embodiment, the input feature map may be stored on the first storage circuit 530 in FIG. 5 for transmission using a broadcast channel. The convolutional kernel is split according to Co and stored on the second storage circuit 540 to be allocated to different SLs. Therefore, all Sls compute the output feature maps of different Co for the same input feature map.

The Group4 mode refers to splitting all 16 schedulable SLs into 4 groups, with one group processing a Co value. Each SL group (referred to as SLB) includes Rs SLs, where Rs=Ns/4=4. For example, SL0 to SL3 belong to a group G0, SL4 to SL7 belong to a group G1, SL8 to SL11 belong to a group G2, and SL12 to SL15 belong to a group G3. This mode lies between Group1 and Group16, hence either the convolution kernels or the input feature maps may be designated as multicast data, while the other may be determined as distribution data.

In an embodiment, the convolution kernels may be split into four groups according to Co, and the four groups of convolution kernels are stored in the first storage circuit 530 as shown in FIG. 5 to take advantage of a broadcast channel for transfer. The input feature map may be split into four parts along the X and Y directions of the output feature map and copied 4 times, stored in the second storage circuit 540, and distributed to four SLBs. Each SLB receives a same input feature map, and within the SLB, the input feature map is then split into four parts and distributed to the four SLs within the SLB. Therefore, all SLs within each SLB collectively compute an output feature map of one Co, and four SLBs process a different Co respectively.

In another embodiment, the convolution kernel may be stored on the second storage circuit 540 in FIG. 5, and the input feature map may be stored on the first storage circuit 530 in a manner similar to the previous embodiment.

In this mode, the convolution kernel may be split between SLBs in a variety of ways.

FIG. 7c illustrates an allocation method 770 of Co of a convolution kernel. In this method, convolution kernels are split into four groups, and specifically, the convolution kernels are split into the groups with each interval of 1 in the Co dimension. For example, when Co=12, the four split Co groups are {0,4,8}, {1,5,9}, {2,6,10}, and {3,7,11} respectively. Each time, one Co from each group is sent; for example, at the first time, Co=0˜3 is sent, with one Co corresponding to one SLB, and four SLs within one SLB share a same weight; at the second time, Co=4˜7 is sent, and so on. Therefore, after each round of computation is completed, a Co dimension of a computation result output by each SLB is continuous.

FIG. 7d illustrates another allocation method 780 of Co of a convolution kernel. In this method, convolution kernels are evenly split into four groups according to Co continuously. For example, when Co=12, the four split Co groups are {0, 1, 2}, {3,4,5}, {6,7,8}, and {9,10,11} respectively. Each time, one Co from each group is sent; for example, at the first time, Co=0, 3, 6, 9 is sent, with one Co corresponding to one SLB, and four SLs within one SLB share a same weight; at the second time, Co=1, 4, 7, 10 is sent, and so on. Therefore, the Co dimension of the computation result output by each SLB in the plurality of rounds of computation is continuous.

### Exemplary Splitting of Input Feature Maps

From the previous description, it may be seen that when a plurality of SLs process a single Co value, the input feature maps are required to be split among the plurality of SLs. For instance, in the Group1 mode, the input feature maps are required to be split into 16 parts, while in the Group4 mode, the input feature maps are required to be split into 4 parts.

To ensure that the split input feature maps may share convolution kernels, the splitting may be based on the Ho/Wo dimensions of the output feature map, which then maps back to the splitting of the input feature maps. In some embodiments, the input feature maps may be split among Rs slave processing circuits SL included in each slave processing circuit group as follows: based on a size of a corresponding output feature map, the output feature map is evenly split into Rs output feature blocks of the same shape along the X and Y dimensions (i.e., Ho/Wo dimension); and according to an input feature map area required to compute each output feature block, the input feature maps are split into Rs input feature blocks along the X and Y dimensions (i.e., Hi/Wi dimension) to be allocated to the Rs SLs. Understandably, depending on the size of the convolution kernel and the convolution stride, input feature maps corresponding to neighboring output points on the output feature map may overlap.

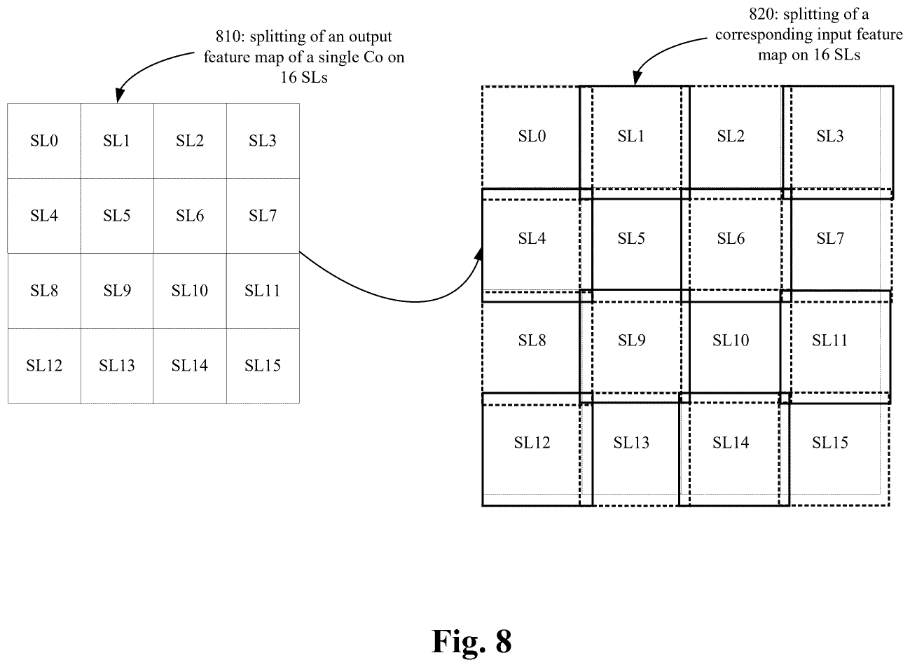

FIG. 8 illustrates an exemplary schematic diagram of splitting an input feature map according to an embodiment of the present disclosure. In this example, the input feature map is split into 16 parts and allocated on 16 SLs, corresponding to the Group1 mode.

In the figure, 810 represents an output feature map of a single Co, which is split into 16 output feature blocks of the same shape in the X and Y directions in a 4×4 manner, which are allocated to SL0S to L15 respectively. Subsequently, these 16 output feature blocks may be mapped onto an input feature map 820 to obtain 16 input feature map areas required to compute the 16 output feature blocks respectively, which also split the input feature map in the X and Y directions. These 16 input feature map areas may be correspondingly allocated to 16 SLs.

According to the description provided, based on a determined convolution splitting scheme, the input feature map is split in units of a splitting unit. Therefore, in the aforementioned embodiment, the splitting of the input feature map must ensure that the size of each split input feature map block is a multiple of the size of the splitting unit in the X and Y directions; in other words, the split input feature map blocks may be aligned according to the splitting unit in the X and Y directions. For example, when a 4×4×4 convolution splitting scheme is selected, each input feature map block is aligned as 4×4; and when a 16×2×2 convolution splitting scheme is selected, each input feature map bock is aligned as 2×2.

For a case where the output feature map is not aligned according to the splitting unit (such as 4×4 or 2×2), it is necessary to pad the input feature map accordingly (for example, 0 is used to pad the input feature map) to ensure that the size of an actual computed output in the X and Y dimensions is aligned according to the splitting unit (such as 4×4 or 2×2), and the size of an input in the X and Y dimensions is also aligned according to the splitting unit (such as 4×4 or 2×2).

It is understandable to those skilled in the art that the output feature map may also be split in the X and Y directions according to other rules; for example, the output feature map may be split into 16 output feature blocks of the same shape in a 1×16 manner, and the split output feature blocks are allocated to SL0˜SL15 respectively, which is not limited in the embodiment of the present disclosure. Additionally, it may also be understood that, although the previous description is combined with the splitting among slave processing circuits, this splitting method may also be applied to other scenarios, such as the splitting among computing circuits CUs within a single slave processing circuit SL, which is not limited in the embodiment of the present disclosure.

### Example of Data Storage on a Second Storage Circuit

As mentioned earlier, either the input feature map or the convolution kernel may be stored on the first storage circuit 530 in FIG. 5, and the other of the two may be stored on the second storage circuit 540. Data in the first storage circuit may be multicast via a broadcast path, while data in the second storage circuit is usually distributed. By allocating storage methods for individual data reasonably, the data access speed may be accelerated. In some embodiments, a second storage circuit may allocate a storage area for each slave processing circuit SL, so that data required by each slave processing circuit for operation only needs to be read from its corresponding storage area.

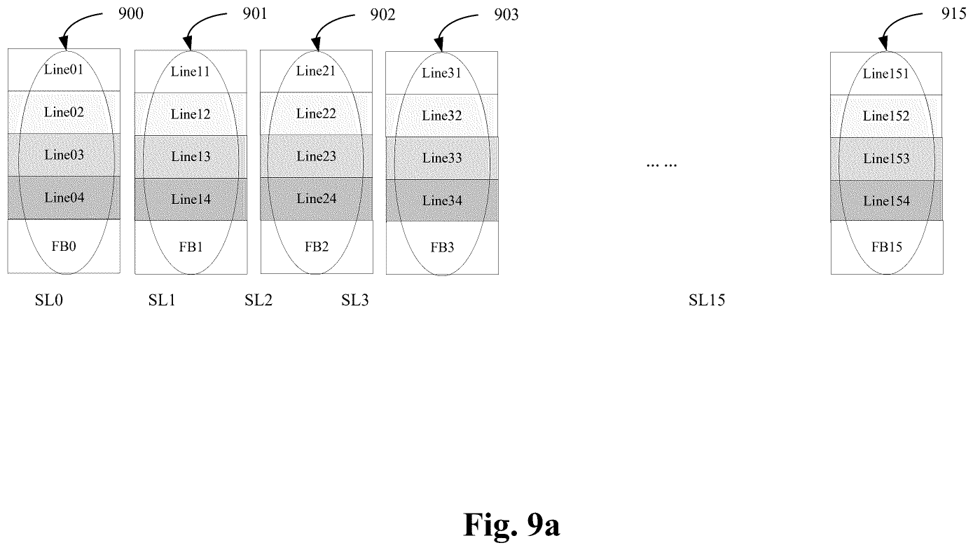

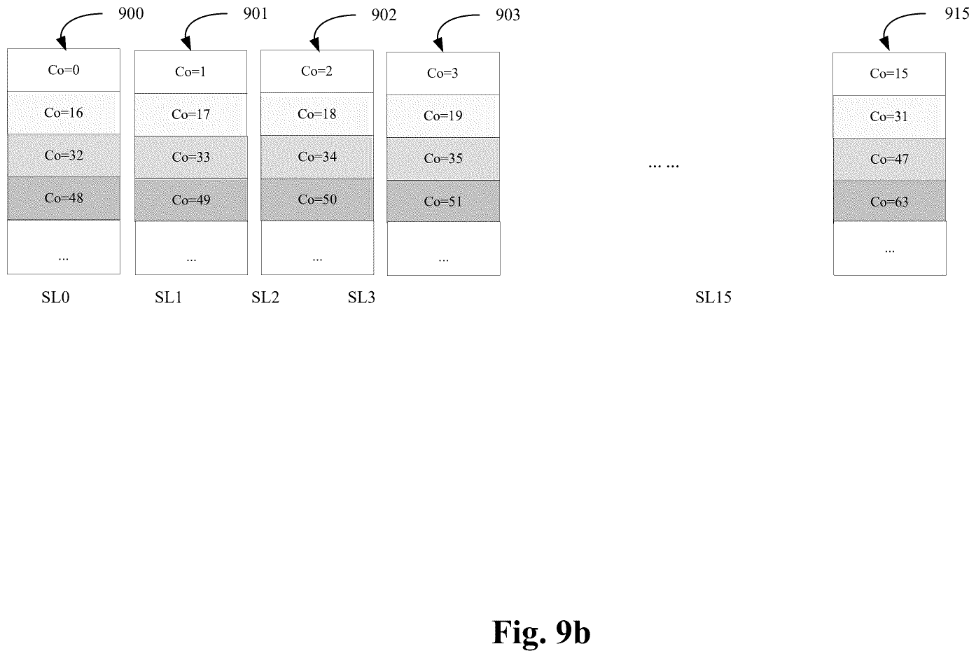

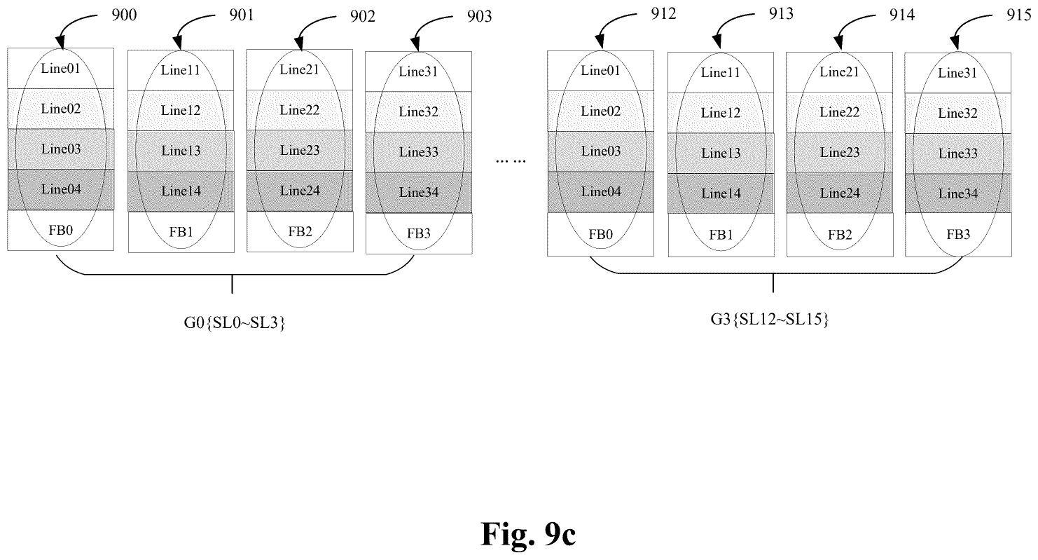

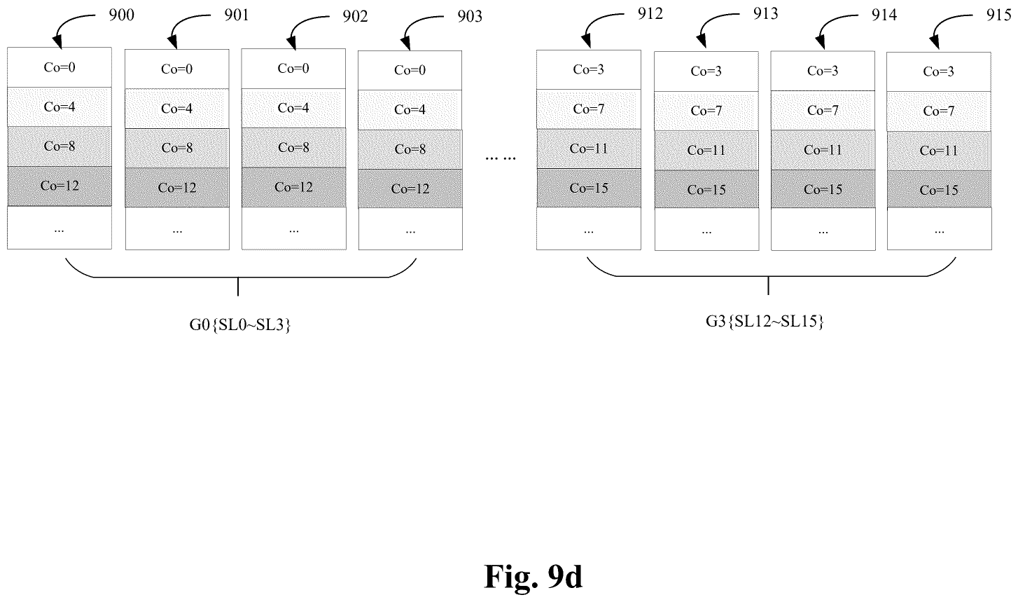

FIGS. 9a-9d show schematic diagrams of data storage in a second storage circuit according to embodiments of the present disclosure. The figure exemplifies 16 storage areas 900˜915 allocated for, for example, Ns=16 slave processing circuits SL0˜SL15. In each storage area, a convolution kernel or input feature map to be processed by the slave processing circuit is stored. It is understood that storage contents in each storage area will vary depending on different grouping modes.

FIG. 9a shows that in a Group1 mode, an input feature map is split into 16 FB0˜FB15 parts and stored in each storage area of a second storage circuit. The storage area corresponding to each SL stores a continuous two-dimensional area, and these two-dimensional areas are split as shown in FIG. 8. In each two-dimensional area, the splitting units described above are stored in lines; in other words, a line corresponds to a splitting unit of the input feature map. For example, assuming that each split input feature block contains four splitting units, which are four lines of data, in a storage area 1100 allocated to SL0, input feature maps in a first line (Line01), a second line (Line02), a third line (Line03), and a fourth line (Line04) are stored in sequence. Each line may also be called an input feature line.

FIG. 9b shows that in a Group16 mode, a convolution kernel is split according to Co and stored in each storage area of a second storage circuit to be allocated to a corresponding SL. The storage area corresponding to each SL stores convolution kernels allocated to its different Co values. For example, two allocation methods of Co are described in the above, and correspondingly, there are also two storage methods of Co. One of the storage methods is shown in FIG. 9b, where successive Co values are allocated sequentially to respective SLs in each round of computation. In this way, after each round of computation is completed, Co dimensions of computation results output by the SLs are continuous. For example, the figure shows that convolution kernels of Co=0˜15 in a first round of computation are stored on 16 storage areas 900˜915 in turn; convolution kernels of Co=16˜31 in a second round of computation are stored in the 16 storage areas 900˜915 successively, and so on. Understandably, in the Group16 mode, it is also possible to store the input feature map on the second storage circuit (not illustrated). At this time, the input feature map is copied 16 times without splitting and respectively stored in each storage area of the second storage circuit to be allocated to a corresponding SL, so that each SL may perform convolution operations for the same input feature map and convolution kernels with different Co values.

FIG. 9c shows one possible storage content in a Group4 mode. In this illustrative example, the input feature map is split into four parts and copied four times, and stored in each storage area of the second storage circuit. In particular, each slave processing circuit group SLB processes for the same input feature map and the convolution kernels with different Co values; and four SLs in each SLB process one split input feature block respectively. Therefore, the storage contents of the storage areas used for the four SLBs in the figure are the same; for example, the contents of 900˜903 are the same as those of 912˜915. Further, within each SLB, storage areas for different SLs store different split input feature blocks respectively; for example, an input feature block FB0 is stored in 900, an input feature block FB1 is stored in 901, and so on. The same storage allocation is also performed in the storage area of other SLBs, which will not be detailed more.

FIG. 9d shows another possible storage content in a Group4 mode. In this illustrative example, the convolution kernels are split into 4 groups according to Co and stored in each storage area of the second storage circuit. Specifically, the convolution kernels are split into the groups with each interval of 1 in the Co dimension. For example, when Co=16, the convolution kernels are allocated to four SLBs in a plurality of rounds in turn. Co=0 is allocated to G0{SL0˜SL3}, Co=1 is allocated to G1 {SL4˜SL7}, Co=2 is allocated to G2 {SL8˜SL11}, and Co=3 is allocated to G3 {SL12˜SL15}, and then starting from Co=4, the convolution kernels are allocated to four SLBs in sequence. The four SLs within each SLB share the same weight. For example, the same weight is stored in storage areas 900, 901, 902, and 903. Similarly, Co may also be continuous within a single SLB, and those skilled in the art may deduce its storage method by referring to the previous description, which is not detailed here.

### an Exemplary Convolution Operation Process in a Single Slave Processing Circuit

After to-be-computed data is split and stored accordingly, a plurality of schedulable slave processing circuits to perform convolution operations on corresponding data lines of an input feature map and a convolution kernel. Then, according to a convolution splitting scheme, computation results returned by the plurality of slave processing circuits may be spliced to obtain an output feature map of the convolution operation of the input feature map and the convolution kernel. Specifically, a specific convolution operation may be performed using a plurality of computing circuits CUs in the slave processing circuits, as well as individual caching circuits (referring to FIG. 5). Depending on the space size of the caching circuit inside the slave processing circuit and the computing power limit of the computing circuit, it is usually necessary to perform a plurality of computations in each round of computation to complete the required operation.

In some embodiments, a first caching circuit may be configured to cache an input feature map, which may come from a first storage circuit or a second storage circuit. Accordingly, a second caching circuit may be configured to cache a convolution kernel, which may come from a second storage circuit or a first storage circuit. As mentioned above, convolution operation processing in units of a splitting unit (a line of data) may give full play to the computing power of the hardware and avoid or reduce invalid computations. Thus, each computing circuit CU may perform an element-wise multiply-accumulate operation on a data line (such as an input feature line) selected from the first caching circuit and a data line (such as a weight line) selected from the second caching circuit respectively at each computation. For simplicity, the following description is for processing within a single slave processing circuit SL, and it is understood that similar processing is performed within other SLs.

From the previous description, it is known that in conventional three-dimensional convolution operation scenarios, all computing circuits within a single slave processing circuit compute one output feature map or some output feature maps corresponding to a same output channel Co. Depending on the space sizes of the first caching circuit and the second caching circuit inside the slave processing circuit SL, and the processing power (such as an internal register) of the computing circuit CU, the slave processing circuit may not be able to compute the output feature map allocated to it all at once. Therefore, the output feature map may be split into output feature blocks in terms of the single computing power of the computing circuit (such as computing Nop output points or partial sums at a time), where each output feature block corresponds to the single computing power (N_{CU}*Nop output points) of all schedulable N_{CU} computing circuits in a single SL. For example, taking an example in FIG. 5 where each SL includes 4 CUs, assuming that each CU may compute Nop=4 output points or partial sums of output points in a single computation, then a single SL may compute 4*4=16 output points (or partial sums) in a single computation. Therefore, the output feature map may be split into output feature blocks in alignment with 16 output points in XoYo dimensions, and each output feature block may be computed one by one. It is understandable that these 16 output points may be arranged in a 4×4 format or a 1×16 format, which is not limited in the embodiments of the present disclosure.

When each split output feature block is computed, output points of the output feature block may be further split among these N_{CU} computing units to determine processing targets for each computing unit. Then, based on the splitting of the output points, using the splitting unit as a sliding window, N_{CU} input feature data lines are selected from the first caching circuit and distributed to N_{CU} computing circuits, and corresponding weight data is selected from the second caching circuit and broadcast to N_{CU} computing circuits, so that a parallel computation of output points corresponding to a plurality of sliding windows may be realized by reuse the weight data. Nk times of selection by sliding window may be performed, where Nk is determined based on a smaller value of a size of the convolution kernel in the X and Y dimensions and a maximum size of the convolution kernel supported by the slave processing circuit in a single computation.

In some embodiments, when a three-dimensional convolution operation is performed, corresponding weight data may be selected as follows: 1/Nop weight lines are selected from the second caching circuit in a sliding manner corresponding to the first caching circuit; and the selected 1/Nop weight lines are copied Nop−1 times to be extended into an extended weight line and broadcast to the N_{CU} computing circuits in the slave processing circuit.

At this time, each computing circuit may, during each selection by sliding window process, perform the element-wise multiply-accumulate operation on one input feature line from the first caching circuit and one extended weight data line from the second caching circuit in units of 1/Nop data lines to obtain Nop partial sums. Additionally, Nk*Nop partial sums obtained by Nk times of sliding computation may be accumulated according to corresponding convolution output points to obtain and output Nop computation results.

The slave processing circuits, when outputting output points from its internal computing units, may output points computed by a plurality of computing units within it in a specific order according to the splitting method of the output points, which ensures that the consecutively outputted output points are continuous in the X and/or Y dimensions, facilitating subsequent processing. In some embodiments, the previously mentioned blocking circuit may further store computation results returned from individual slave processing circuits in a fourth dimension storage order. Depending on situations, the blocking circuit may also store the computation results in a desired dimension storage order.

The splitting of output points among computing circuits may be performed in various ways, and accordingly, the selection by sliding window and convolution process and the output order of the output points will also differ.

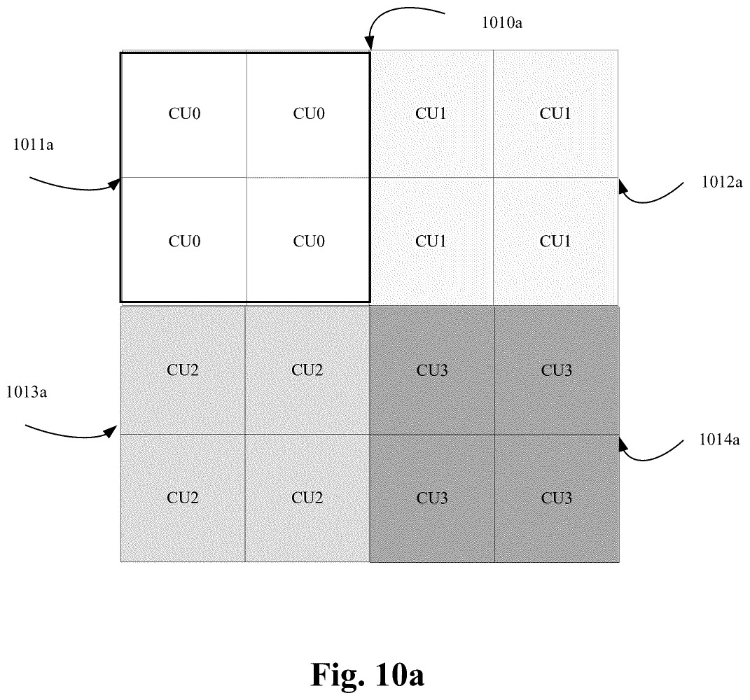

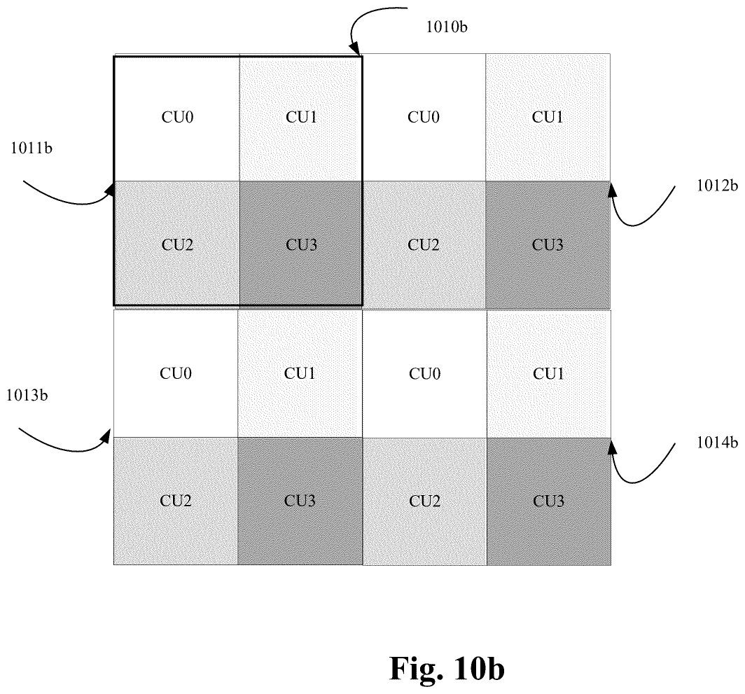

FIGS. 10a-10b show two kinds of different output point splitting between computing circuits.

FIG. 10a shows a schematic diagram of allocating continuous output points to each computing circuit. In these embodiments, an output feature block may be evenly split into N_{CU} output feature sub-blocks of the same shape among N_{CU} computing circuits, where each output feature sub-block includes Nop output points, so that each computing circuit is responsible for computing one of the output feature sub-blocks. For example, taking the above example as an example, the figure shows that an output feature block 1010a includes 4*4 output points, and each evenly split output feature sub-block 1011a˜1011d includes 2*2 output points, and each computing circuit computes 2*2 consecutive output points (partial sums) at a time. The output points allocated to four different computing circuits CU0˜CU3 are shown with different backgrounds in the figure.

Based on the above output point splitting, when the convolution operation is performed by the selection by sliding window, N_{CU} data lines are selected from the first caching circuit for computation, corresponding to positions of the N_{CU} output feature sub-blocks, according to data required for computing the output feature sub-blocks.

For example, when input feature data is selected for the first time, first input data lines are selected from corresponding input feature blocks respectively and distributed to four computing circuits according to four input feature blocks required for computing four output feature sub-blocks 1011a˜1014a.

When weight data is selected, corresponding weight data may be selected from the second caching circuit and broadcast to N_{CU} computing circuits, so that a parallel computation of output points corresponding to a plurality of computing circuits may be realized by reuse the weight data.

Further, in some embodiments, in order to take full advantage of the computing power (such as a multiply-accumulate arithmetic unit) within the computing circuit CU, such as computing Nop output points or partial sums at a single time, weight reuse may be performed within a single input data line to compute Nop output points or partial sums at the same time.

For example, in the selection of weight data, only 1/Nop weight lines are selected, and the selected 1/Nop weight lines are copied Nop−1 times to be extended into one weight line, where this extended weight line includes Nop same 1/Nop weight lines. The extended weight line may also be broadcast to N_{CU} computing circuits, thus reuse weights across a plurality of computing circuits while reuse weights at a smaller granularity (such as 1/Nop lines) between computations of Nop output points of a single computing circuit.

Therefore, N_{CU}*Nop output points or partial sums may be computed each time by selecting N_{CU} input feature data lines and selecting and copying 1/Nop weight lines to be extended into one weight line correspondingly every time. When the computation results is a partial sum, the partial sum may be computed several times by sliding several times, and the partial sum of each time may be accumulated according to the output point to which it belongs to obtain a final result.

According to the splitting method of the output points, the number of slides and sliding stride of the convolution operation may be determined. According to the splitting method in FIG. 10a, the number of slides Nk=Kx*Ky, where Kx is a smaller value of a size of the convolution kernel in the X dimension and a maximum convolution kernel size supported by the slave processing circuit in a single computation, Ky is a smaller value of a size of the convolution kernel in the Y dimension and the maximum convolution kernel size supported by the slave processing circuit in a single computation, and the sliding stride=1. The maximum convolution kernel size supported by the slave processing circuit in a single computation is determined, for example, by the space sizes of the first caching circuit and the second caching circuit. It is understood that when the size of the convolution kernel is greater than the maximum convolution kernel size, the convolution kernel is required to be split according to the maximum convolution kernel size in the Kx and Ky directions.

According to the splitting method in FIG. 10a, since the output points computed by each computing circuit are continuous in the X and/or Y dimensions, the computation result of each computing circuit may be output one by one. For example, according to the order of the computing circuit, the computation result of one computing circuit is output at a time, such as 2*2 output points, and 4*4 output feature blocks are returned for 4 consecutive times.

FIG. 10b shows a schematic diagram of allocating spaced output points to each computing circuit according to some embodiments of the present disclosure. In these embodiments, an output feature block may be evenly split into N_{CU} output feature sub-blocks of the same shape among N_{CU} computing circuits, where each output feature sub-block includes N_{CU} output points, respectively being allocated to N_{CU} computing circuits. For example, taking the above example as an example, the figure shows that an output feature block 1010b includes 4*4 output points, and each evenly split output feature sub-block 1011b˜1011b includes 2*2 output points. In each output feature sub-block, these 2*2 output points are allocated to four computing circuits. Thus, each computing circuit computes one output point in the Nop output feature sub-blocks. The output points allocated to four different computing circuits CU0˜CU3 are shown with different backgrounds in the figure.

Based on the above output point splitting, when the convolution operation is performed by the selection by sliding window, N_{CU} data lines are selected from the first caching circuit for computation, corresponding to positions of output points of each output feature sub-block, according to data required for computing the output feature sub-blocks.

For example, when input feature data is selected for the first time, four input data lines are selected from corresponding input feature blocks and distributed to four computing circuits according to four input feature blocks required for computing four output points in a first output feature sub-block 1011b. It is understood that since the four output points are continuous in the X and/or Y directions, the four input data lines selected at the same time have an interval or stride of 1 in the X and/or Y directions.

When weight data is selected, corresponding weight data may be selected from the second caching circuit and broadcast to N_{CU} computing circuits, so that a parallel computation of output points corresponding to a plurality of computing circuits may be realized by reuse the weight data.

Further, in some embodiments, in order to take full advantage of the computing power (such as a multiply-accumulate arithmetic unit) within the computing circuit CU, such as computing Nop output points or partial sums at a single time, weight reuse may be performed within a single input data line to compute Nop output points or partial sums at the same time.

For example, in the selection of weight data, only 1/Nop weight lines are selected, and the selected 1/Nop weight lines are copied Nop−1 times to be extended into one weight line, where this extended weight line includes Nop same 1/Nop weight lines. The extended weight line may also be broadcast to N_{CU} computing circuits, thus reuse weights across a plurality of computing circuits while reuse weights at a smaller granularity (such as 1/Nop lines) between computations of Nop output points of a single computing circuit.

Therefore, N_{CU}*Nop output points or partial sums may be computed each time by selecting N_{CU} input feature data lines and selecting and copying 1/Nop weight lines to be extended into one weight line correspondingly every time. When the computation results is a partial sum, the partial sum may be computed several times by sliding several times, and the partial sum of each time may be accumulated according to the output point to which it belongs to obtain a final result.

According to the splitting method of the output points, the number of slides and sliding stride of the convolution operation may be determined. According to the splitting method in FIG. 10b, the number of slides Nk=ceil(Kx/2)*ceil(Ky/2), where Kx is a smaller value of a size of the convolution kernel in the X dimension and a maximum convolution kernel size supported by the slave processing circuit in a single computation, Ky is a smaller value of a size of the convolution kernel in the Y dimension and the maximum convolution kernel size supported by the slave processing circuit in a single computation, and the sliding stride=2. Similarly, the maximum convolution kernel size supported by the slave processing circuit in a single computation is determined, for example, by the space sizes of the first caching circuit and the second caching circuit. It is understood that when the size of the convolution kernel is greater than the maximum convolution kernel size, the convolution kernel is required to be split according to the maximum convolution kernel size in the Kx and Ky directions.

According to the splitting method in FIG. 10b, since the output points computed by each computing circuit are spaced in the X and/or Y dimensions, which means that the output points computed by each computing circuit are not continuous in the X and/or Y dimensions, it is necessary to select partial computation results of part of the computing circuits for output each time, so that the output points are continuous in the X and/or Y dimensions. For example, a line of 1*4 computation results may be output each time, and 4*4 output feature blocks are returned for 4 consecutive times. In this example, a first line is required to output two results of CU0 and two results of CU1, a second line is required to output two results of CU2 and two results of CU3, and so on. In another example, 2*2 computation results may be still output each time, and 4*4 output feature blocks are returned for 4 consecutive times. In this example, a first computation result of each of CU0˜CU3 is output for the first time, a second computation result of each of CU0˜CU3 is output for the second time, and so on. In another example, computation results may be output by column, which will not be described here.

In addition, taking into account the use of registers inside the computing circuit CU, a slave processing circuit may compute a plurality of 4*4 areas in the Xo/Yo direction, for example, up to 16 4*4 areas. At this time, weights or neurons may be reused according to the storage content in the second storage circuit to reduce the reading frequency of the second storage circuit. If the computation result is a partial sum, the computation result is stored in a register in the computing circuit.

In these embodiments, each slave processing circuit may, depending on the method of weight reuse and/or input feature map reuse, control the method of reading weight data lines and input feature map data lines, so that weight data and input feature map data traverse through the entire convolution window of convolution output points simultaneously through a plurality of computations to perform an element-wise multiply-accumulate operation to obtain a plurality of partial sums and then obtain a convolution output corresponding to the convolution output points by accumulating the plurality of partial sums.

Detailed computation processes for different types of convolution operations and using different convolution splitting schemes are described below in combination with several specific embodiments.

### Embodiment 1: Forward16

In Forward16, a shape of a splitting unit is 16 B×2×2, and its computation may also be applied to similar convolution splitting schemes. The size of the splitting unit indicated by these convolution splitting schemes may be expressed as Uci×Uy×Ux=M, where Uci is a size of the splitting unit on an initial lowest storage dimension (such as Ci dimension) of an input feature map and a convolution kernel, Ux is a size of the splitting unit on an initial X storage dimension of the input feature map and the convolution kernel, Uy is a size of the splitting unit on an initial Y storage dimension of the input feature map and the convolution kernel, and M is a maximum computation amount of hardware at a time. In these convolution splitting scheme, Uci>Ux=Uy>1, Uci=M/4ⁿ, n=1, 2, . . . ½ log₂ M−1.

For example, if M=64, then M/4ⁿ may be 64, 16, 4, and 1, and the splitting unit may be in the shape of 16 B×2×2 according to the rule Uci>Ux=Uy>1. When the above convolution splitting scheme is used, the Ci dimension of the input feature map and the convolution kernel is required to be aligned to 16 B. For example, when Ci=40, the Ci dimension may be aligned to 3*16=48 by padding with zeros, thus being split according to 16 B×2×2. As such, there are three splitting units in the Ci dimension.

For example, if M=128, then M/4n may be 128, 32, 8, and 2, and the splitting unit may be in the shape of 32 B×2×2 or 8 B×4×4 according to the rule Uci>Ux=Uy>1. When the above convolution splitting scheme is used, the Ci dimension of the input feature map and the convolution kernel is required to be aligned to 32 B or 8 B. For example, when Ci=40, the Ci dimension may be aligned to 2*32=64 by padding with zeros or to 5*8=40 without zero padding, thus being preferentially split according to 8 B×4×4. As such, there are five splitting units in the Ci dimension.

Therefore, although the following convolution operations are described in conjunction with the concrete example of Forward16, these computation processes may also be applied to these convolution splitting schemes similar to Forward16.

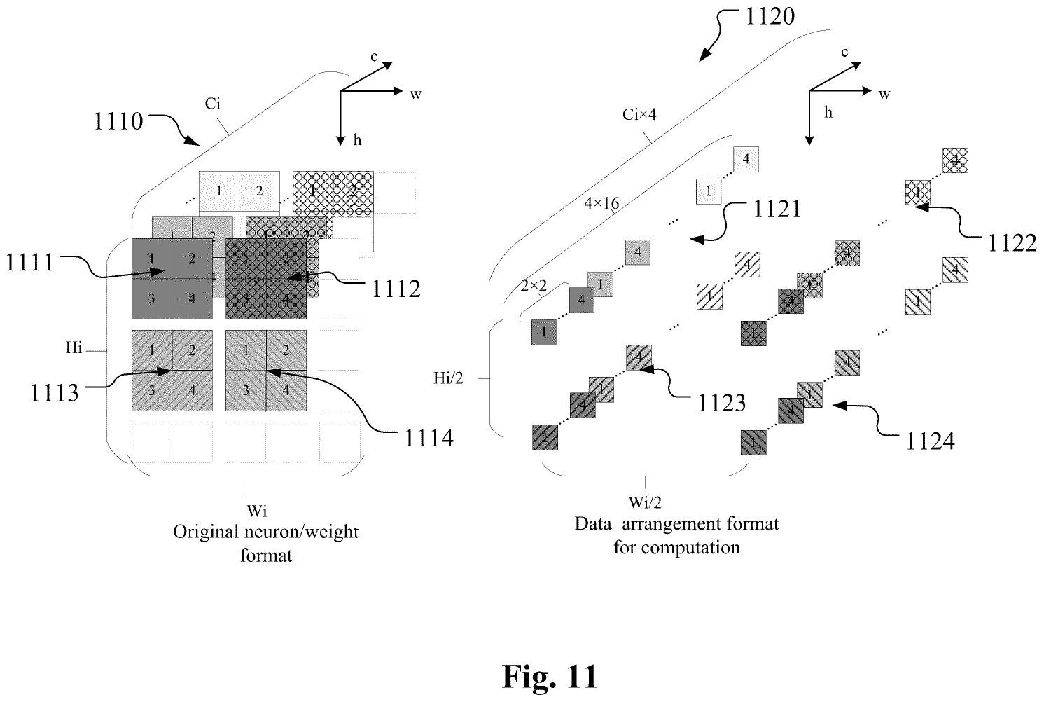

FIG. 11 shows a schematic diagram of splitting and storage in the Forward16 scheme in the embodiment 1 of the present disclosure. For simplicity, it is assumed that a data type is Int8 in the example in the figure.

In the figure, 1110 shows original to-be-computed data (which may be a neuron or a weight), which stored in the order of HWC. The figure also shows four data blocks 1111-1114 obtained by splitting the original to-be-computed data according to a splitting unit, each of which includes 16×2×2=64 pieces of data.

In the figure, 1120 shows a data arrangement format after splitting for easy reading. It may be seen that original data blocks (such as 1111-1114) are arranged as a line (such as 1121-1124) in the C dimension. In each line, data is stored in the order of CHW. For example, for a line 1121, four pieces of data of C=0 are stored first, then four pieces of data of C=1, then four pieces of data of C=2, and finally four pieces of data of C=15.

Specifically, when the data is a neuron, the data is required to be arranged from [1 Hi Wi Ci] as:
[1*Hi/2*Wi/2*Ci/16*(16×2×2)], which is a shape of a seven-dimensional tensor.

When the data is a weight, the data is required to be arranged from [Co Kh Kw Ci] as:
[Co*Kh/2*Kw/2*Ci/16*(16×2×2)], which is also a shape of a seven-dimensional tensor.

When the Forward16 convolution splitting scheme is performed using the computing apparatus shown in FIG. 5, according to the Forward16 convolution splitting scheme, the input feature map and the convolution kernel may be split into a plurality of corresponding splitting units by a blocking circuit integrated within the master processing circuit or a blocking circuit completely or partially independent of the master processing circuit. The blocking circuit may also convert the dimension storage orders of the input feature map and the convolution kernel, so that data in each splitting unit is continuously stored in one data line. The split and converted input feature map and/or convolution kernel may be supplied to the master processing circuit or the slave processing circuit. The master processing circuit may then distribute the obtained data to the plurality of slave processing circuits to perform convolution operations. According to the convolution splitting scheme, computation results returned from the plurality of slave processing circuits are spliced to obtain the output feature map of the convolution operation of the input feature map and the convolution kernel. The plurality of slave processing circuits may perform convolution operations based on the obtained data and return computation results to the master processing circuit.

In a scenario where the Forward16 scheme is performed, Co is usually aligned to 16. In these embodiments, the convolution splitting scheme may also indicate the number of rounds of computations L required to perform the convolution operation, where the number of output channels Co processed in each round of computation corresponds to the number Ns of schedulable slave processing circuits in that round of computation, thus a single slave processing circuit processing a single Co value.

Since each slave processing circuit processes a different Co value, the input feature map may be reused between these slave processing circuits. In view of this, in some embodiments, the input feature map may be determined as multicast data, and the multicast data after being split and converted in its dimension storage order may be stored in the first storage circuit for transmission to the plurality of scheduled slave processing circuits through the broadcast bus during the computation. Correspondingly, the convolution kernel may be determined as distribution data, and the distribution data after being split and converted in its dimension storage order may be stored in the second storage circuit for distribution to the corresponding slave processing circuits. These pieces of distribution data may be distributed to the corresponding slave processing circuits before the computation.

In this example, convolution kernels with different Co values allocated to respective slave processing circuits in each round of computation may be further stored in corresponding storage areas allocated to the slave processing circuits in the second storage circuit. The storage contents in the second storage circuit may refer to FIG. 9b.

Accordingly, the first caching circuit may cache a plurality of input feature data lines transmit from the first storage circuit by broadcast; the second caching circuit may cache a plurality of weight data lines from the second storage circuit that are distributed to the convolution kernel of the slave processing circuit. Depending on the splitting and/or reuse method, these data lines may be distributed to corresponding computing circuits CUs or broadcast to all computing circuits CUs within the slave processing circuit during the computation. Each computing circuit CU may then perform an element-wise multiply-accumulate operation on an input feature data line selected from the first caching circuit and a weight data line selected from the second caching circuit respectively in each computation.

When a plurality of computing circuits CUs in a single slave processing circuit SL process a single Co value together, it is necessary to split output points among these CUs. In the Forward16 scheme, the splitting method of the output points among four computing circuits CUs may refer to FIG. 10a. Specifically, each computing circuit computes a plurality of continuous output points of the output feature map in the X and/or Y dimensions during each computation.

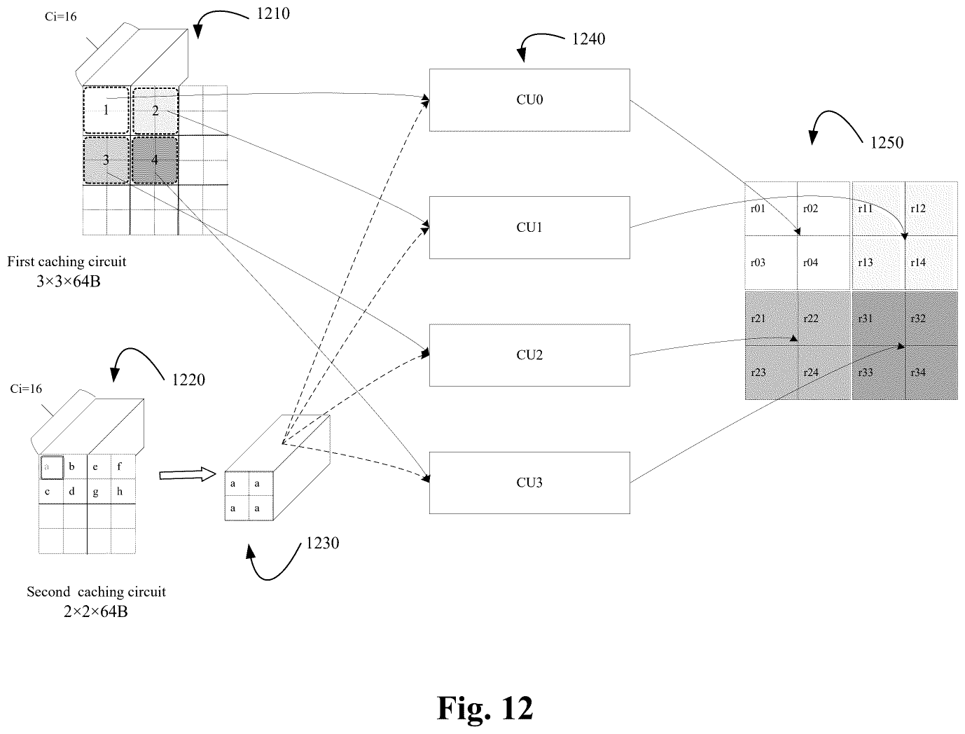

FIG. 12 shows a schematic diagram of a single computation in the Forward16 scheme according to an embodiment of the present disclosure. In this example, a first caching circuit 1210 has a size of 3×3×64 B, which means that the first caching circuit 1210 may cache up to 9 lines of data, and a second caching circuit 1220 has a size of 2×2×64 B, which means that the second caching circuit 1220 may cache up to 4 lines of data. To be consistent with the splitting units, the storage within the caching circuit in the figure is also shown in units of the splitting units.

A computation process of a first selection by sliding window is shown in the figure. According to a method corresponding to the splitting method of the output points, N_{CU} input feature lines are selected by sliding from the first caching circuit by taking a splitting unit as a sliding window, and then sent to N_{CU} computing circuits for computation. 1/Nop weight lines are selected from the second caching circuit in a sliding method corresponding to that in the first caching circuit, where Nop is the maximum number of computable convolution output points per computing circuit at a single time, the selected 1/Nop weight lines are copied Nop−1 times to be extended into an extended weight line and broadcast to N_{CU} computing circuits in the slave processing circuit. Specifically, in the computing apparatus shown in FIG. 5, N_{CU}=4, and Nop=4. The output points are split in a case where each computing circuit computes an output feature block consisting of 2×2 output points at each computation.

As shown in the figure, an input feature data line is selected from each of the four input feature blocks corresponding to the split output points from the first caching circuit 1210 at the starting position and sent to four computing circuits 1240 in the slave processing circuit SL correspondingly. ¼ weight data line is selected from the second caching circuit 1220 at the starting position, and the selected ¼ weight data line is copied three times to be extended into one extended weight data line 1230 and broadcast to four computing circuits 1240 in the SL.

In each computation, each computing circuit performs an element-wise multiply-accumulate operation on an input feature line from the first caching circuit and an extended weight line from the second caching circuit in units of 1/Nop data lines, thus obtaining Nop partial sums.

As shown in the figure, four computing circuits 1240 perform element-wise multiply-accumulate operations on the distributed input feature data lines and the broadcast extended weight data lines to obtain a computation result 1250. In 1250, results of different background colors are obtained by different computing circuits 1240. It may be seen that in each computation, a CU computes a partial sum of 2×2, and 4 CUs obtain a total of 4 partial sums of 2×2, i.e. 4×4.

Then, the selection by sliding window is synchronized in the first caching circuit and the second caching circuit to perform a next computation. Nk times of selection by sliding window may be performed, where Nk=Kx*Ky, where Kx is a smaller value of a size of the convolution kernel in the X dimension or a maximum convolution kernel size supported by the slave processing circuit in a single computation in the current convolution splitting mode (i.e., Forward16), and Ky is a smaller value of a size of the convolution kernel in the Y dimension or the maximum convolution kernel size supported by the slave processing circuit in a single computation in the current convolution splitting mode (i.e., Forward16). Accordingly, the computing circuit accumulates Nk*Nop partial sums obtained during Nk times of sliding computation according to corresponding convolution output points, thus obtaining and outputting Nop computation results.

In some embodiments, in the Forward16 mode, the maximum convolution kernel size supported by the slave processing circuit in a single computation is 3×3.

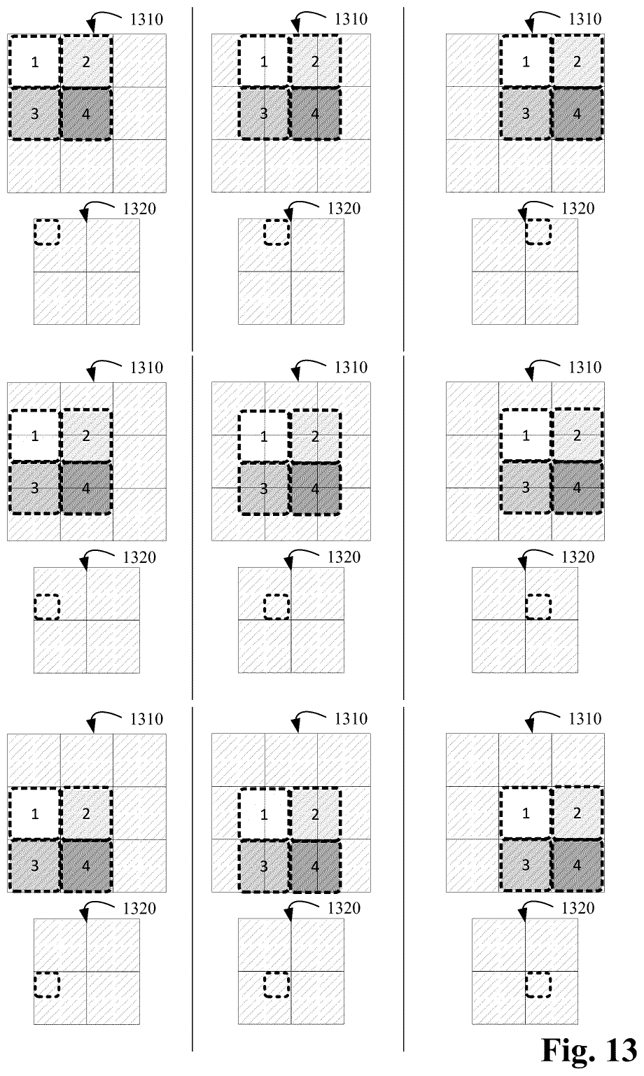

FIG. 13 shows a schematic diagram of a sliding convolution process in the Forward16 scheme according to an embodiment of the present disclosure. In this example, taking a 6×6 input feature map and a 3×3 convolution kernel as an example, if a convolution stride is 1, a size of an output feature map is 4×4. The input feature map has been aligned to 2×2 and is split into 9 blocks of 16×2×2 (C×H×W) size and stored in a first caching circuit, shown as 1310 in the figure, in which a C dimension is omitted. The 3×3 convolution kernel is required to be aligned to 4×4, the alignment part is padded with 0, and the convolution kernel is stored in a second caching circuit, shown as 1320 in the figure, in which a C dimension is also omitted. During each computation, a 1×1 block in the convolution kernel is selected and copied 3 times, which exactly corresponds to a 2×2 block in the input feature map. The copy operation may be realized by hardware.

The selection ranges of the input feature map and the convolution kernel in the first caching circuit and the second caching circuit during each sliding are shown in FIG. 13. There are 9 graphs in total, representing sliding 9 times in total. In the figure, a block 1310 represents an input feature map in a first caching circuit, and four dashed boxes represent areas selected to be sent to four CUs, a block 1320 represents a convolution kernel in a second caching circuit, and a dashed box represents a selected ¼ line, which is copied 3 copies and expanded into one line to be broadcast to four CUs. The number of slides is Nk=Kx*Ky=9.

In each computation, each CU performs an element-wise multiply-accumulate operation on a data line from the first caching circuit and an extended data line from the second caching circuit by taking a ¼ data line as a unit to obtain four partial sums; and in a current round of computation, Nk partial sums corresponding to a same convolution output point obtained during Nk times of computation are accumulated to obtain and output four computation results.

Specifically, for each graph in FIG. 13, the number of CUs is Ncu=4, and each CU computes a partial sum of four output points on the output feature map, which is an element-wise multiply-accumulate result of a ¼ data line; in other words, each output point is standard 16×1×1 (Ci×Y×X) convolution. After sliding Nk=Kx*Ky=9 times, the accumulation is completed in the Y×X direction, and finally a complete 4×4 (Y×X) output is obtained in one SL (as shown in FIG. 10a). For a larger convolution kernel, splitting is performed in the Kx and Ky directions according to the same principle as above.

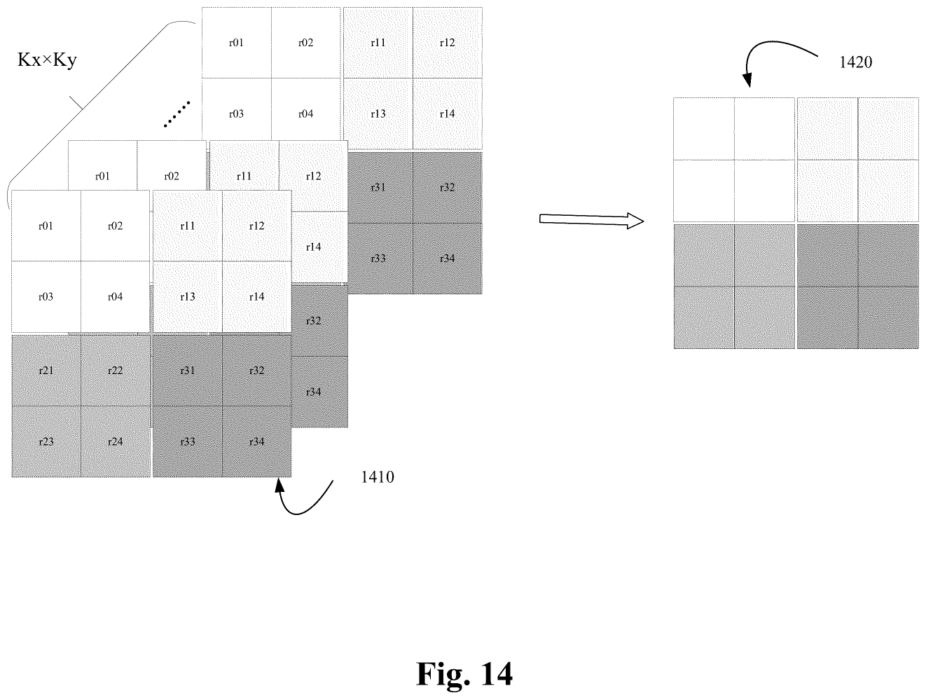

FIG. 14 shows a schematic accumulation diagram of sliding convolution results in the Forward16 scheme according to an embodiment of the present disclosure.

As shown by 1410 in the figure, in each computation, each computing circuit CU performs an element-wise multiply-accumulate operation on an input feature data line from the first caching circuit and an extended weight data line from the second caching circuit by taking a ¼ data line as a unit, thus obtaining four partial sums.

Each computing circuit CU accumulates Nk partial sums corresponding to a same convolution output point obtained by Nk=Kx*Ky times of computation in a current round of computation to obtain four computation results.

It is understandable that when Ci>16, it is necessary to traverse in the Ci direction, switching inputs and weights simultaneously until a complete output is computed. When Xo/Yo computed by each CU is greater than 4, it is necessary to slide along the Xo/Yo direction to read different input neurons and weights. Those skilled in the art may similarly derive the computation process according to the above description, which is not described here.

As may be seen from the previous sliding convolution process, an order of an output result in a sliding mode is not a normal arrangement order of output data of traditional convolution. Therefore, during the output process, each slave processing circuit SL may convert a computation result of its computing circuit CU into a specified format, such as Nco×Uy×Ux. In some embodiments, each slave processing circuit may output Nop computation results of one of its computing circuits at a time in an order in which output points are split continuously. The blocking circuit may further store a computation result returned from each slave processing circuit in a fourth dimension storage order. Depending on situations, the blocking circuit may also store the computation result in a desired dimension storage order.

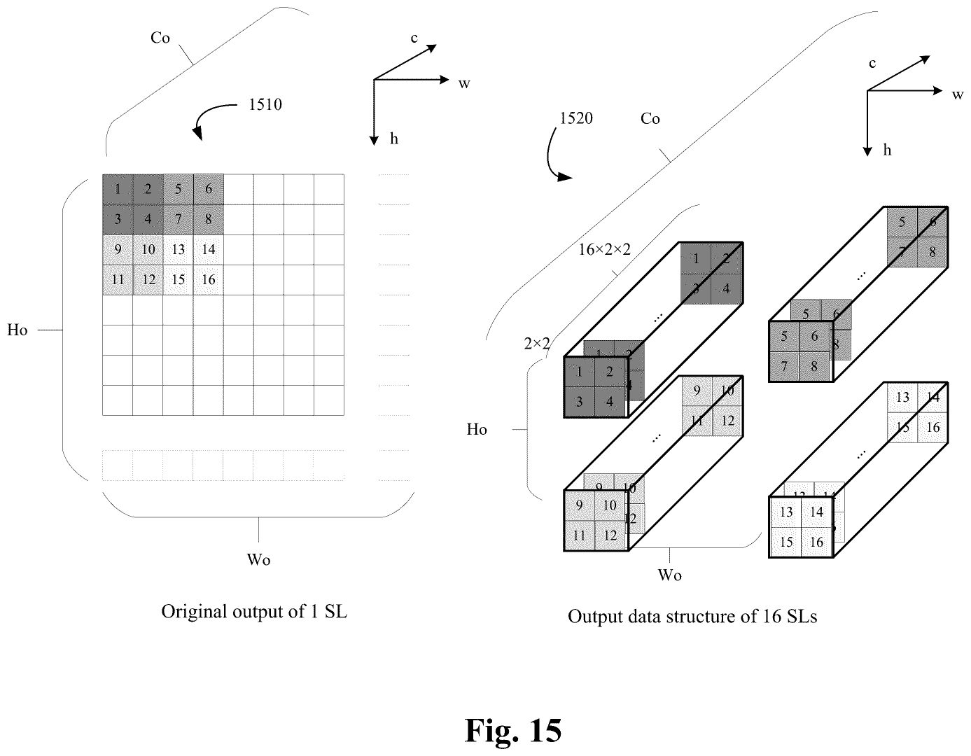

FIG. 15 shows a schematic output data format diagram in the Forward16 splitting scheme according to an embodiment of the present disclosure.

The 1510 in the figure shows an original output of 1 SL. As may be seen from the figure, each CU computes 2×2 output neurons. Since four output neurons computed by one CU are adjacent, each SL may output a computation result of one of the CUS (which is a 1×2×2 (Co×Y×X) area) at a time in an order in which output points are split continuously, and a 1×4×4 (Co×Y×X) area is returned for four consecutive times, which means that four computation results of each of the four CUs are returned. Different CUs within the same SL output different areas of the output feature map of the same Co. Different SLs output feature maps of different Cos.

The 1520 in the figure shows the output data structure of 16 SLs. As shown in the figure, an output caching circuit (such as the third caching circuit in FIG. 5) may convert an output result into a 16×2×2 format, where 16 corresponds to the number of SLs, and also corresponds to the number of output channels Cos.

In some embodiments, in view of the storage space of the registers inside the computing circuit, for example, a single slave processing circuit containing four computing circuits that can compute up to 16 4×4 output feature areas, the weights may be reused, thereby reducing the reading frequency of the second storage circuit. In other words, the reading frequencies of the first storage circuit and the second storage circuit may be different. If the result computed by the computing circuit is a partial sum, the result is stored in the internal register.

In these embodiments, the slave processing circuit may be further configured to: determine the number of times rs that the weight is reused in the slave processing circuit according to the storage space limitations in the computing circuit; and control the loading frequency of input feature data in the first caching circuit, so that weight data loaded each time in the second caching circuit is reused rs times, and performs a convolution operation with corresponding input feature data loaded rs times in the first caching circuit. In some examples, rs may take a value not greater than 16.

### Embodiment 2: Forward4

In Forward4, a shape of a splitting unit is 4 B×4×4, and its computation may also be applied to similar convolution splitting schemes. The size of the splitting unit indicated by these convolution splitting schemes may be expressed as Uci×Uy×Ux=M, where Uci is a size of the splitting unit on an initial lowest storage dimension (such as Ci dimension) of an input feature map and a convolution kernel, Ux is a size of the splitting unit on an initial X storage dimension of the input feature map and the convolution kernel, Uy is a size of the splitting unit on an initial Y storage dimension of the input feature map and the convolution kernel, and M is a maximum computation amount of hardware at a time. In these convolution splitting schemes, Ux=Uy≥Uci>1, Uci=M/4ⁿ, n=1, 2, . . . ½ log₂ M−1.

For example, if M=64, then M/4n may be 64, 16, 4, and 1, and the splitting unit may be in the shape of 4 B×4×4 according to Ux=Uy≥Uci>1. When the above convolution splitting scheme is used, the Ci dimension of the input feature map and the convolution kernel is required to be aligned to 4 B. For example, when Ci=10, the Ci dimension may be aligned to 3*4=12 by padding with zeros, thus being split according to 4 B×4×4. As such, there are three splitting units in the Ci dimension.

For example, if M=128, then M/4n may be 128, 32, 8, and 2, and the splitting unit may be in the shape of 2 B×8×8 according to Ux=Uy≥Uci>1. When the above convolution splitting scheme is used, the Ci dimension of the input feature map and the convolution kernel is required to be aligned to 2 B. For example, when Ci=3, the Ci dimension may be aligned to 2*2=4 by padding with zeros, thus being split according to 2 B×8×8. As such, there are two splitting units in the Ci dimension.

Therefore, although the following convolution operations are described in conjunction with the concrete example of Forward4, these computation processes may also be applied to these convolution splitting schemes similar to Forward4.

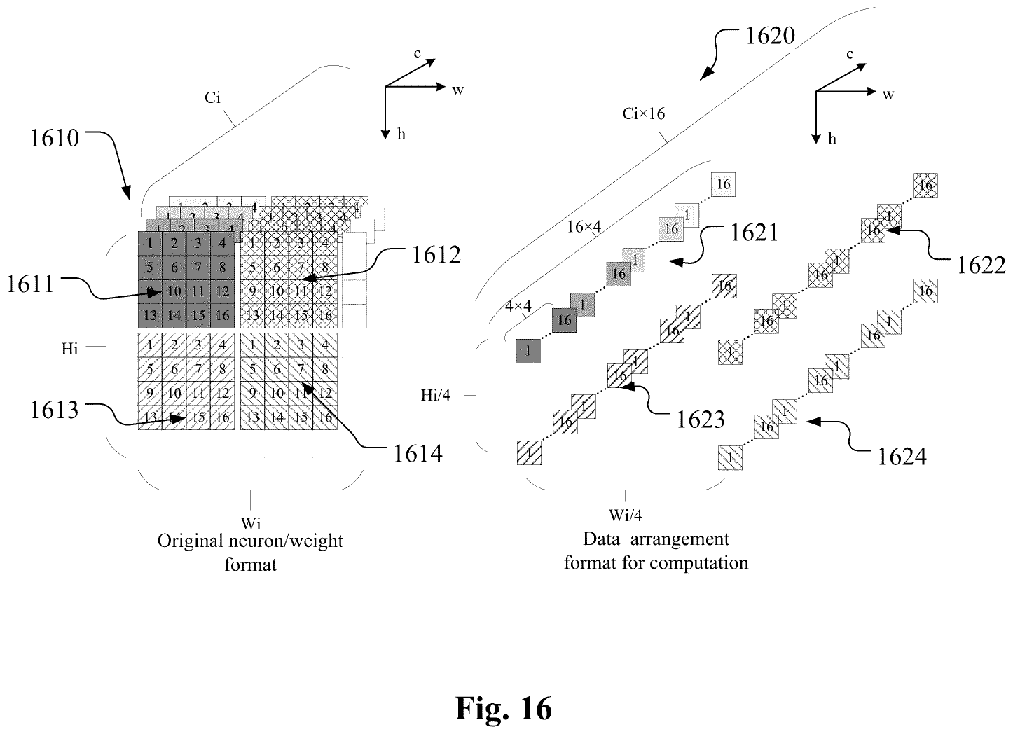

FIG. 16 shows a schematic diagram of splitting and storage in the Forward4 scheme according to an embodiment of the present disclosure. For simplicity, it is assumed that a data type is Int8 in the example in the figure.

In the figure, 1610 shows original to-be-computed data (which may be a neuron or a weight), which stored in the order of HWC. The figure also shows four data blocks 1611-1614 obtained by splitting the original to-be-computed data according to a splitting unit, each of the data blocks includes 4×4×4=64 pieces of data.

In the figure, 1620 shows a data arrangement format after splitting for easy reading. It may be seen that original data blocks (such as 1611-1614) are arranged as a line (such as 1621-1624) in the C dimension. In each line, data is stored in an order of CHW. For example, for a data line 1621, 16 pieces of data of C=0 are stored first, followed by 16 pieces of data of C=1, then 16 pieces of data of C=2, and finally 16 pieces of data of C=3.

Specifically, when the data is a neuron, the data is required to be arranged from [1 Hi Wi Ci] as:
[1*Hi/4*Wi/4*Ci/4*(4×4×4)], which is a shape of a seven-dimensional tensor.

When the data is a weight, the data is required to be arranged from [Co Kh Kw Ci] as:
[Co*Kh/4*Kw/4*Ci/4*(4×4×4)], which is also a shape of a seven-dimensional tensor.

When the Forward4 convolution splitting scheme is performed using the computing apparatus shown in FIG. 5, according to the Forward4 convolution splitting scheme, the input feature map and the convolution kernel may be split into a plurality of corresponding splitting units by a blocking circuit integrated within the master processing circuit or a blocking circuit completely or partially independent of the master processing circuit. The blocking circuit may also convert the dimension storage orders of the input feature map and the convolution kernel, so that data in each splitting unit is continuously stored in one data line. The split and converted input feature map and/or convolution kernel may be supplied to the master processing circuit or the slave processing circuit. The master processing circuit may then distribute the obtained data to a plurality of slave processing circuits to perform convolution operations; and according to the convolution splitting scheme, the master processing circuit may splice computation results returned from the plurality of slave processing circuits to obtain an output feature map of the convolution operation of the input feature map and the convolution kernel. The plurality of slave processing circuits may perform convolution operations based on the obtained data and return computation results to the master processing circuit.

In a scenario like Forward4, when the number of input channels is small, the convolution kernel is generally small, for example, Kh and Kw are usually single digits, and Co is about the same size as Ci. In these embodiments, typically in a single round of computation, a size of an output channel Co dimension of a convolution kernel is less than or equal to the number of slave processing circuits that are scheduled, so that the computation of a single Co is completed by one or more slave processing circuits. More generally, even when the Co dimension is large, the convolution operation may be completed by splitting it into a plurality of rounds of computation, where the size of Co processed in each round is less than or equal to the number of slave processing circuits that are scheduled. Thus, in an example, the number of rounds of computation required to complete the convolution operation and the number of Cos processed in each round or a corresponding grouping mode may be first determined based on the size of the output channel Co dimension of the convolution kernel and the number Ns of schedulable slave processing circuits.

The Forward4 convolution splitting scheme supports the three grouping modes described in FIG. 7: Group1, Group4, and Group16.

To support all three grouping modes at the same time, in some embodiments, the convolution kernel may be determined as multicast data, and the multicast data after being split and converted in its dimension storage order may be stored in the first storage circuit for transmission to the plurality of scheduled slave processing circuits through the broadcast bus during the computation. Correspondingly, the input feature map may be determined as distribution data, and the distribution data after being split and converted in its dimension storage order may be stored in the second storage circuit for distribution to the corresponding slave processing circuits. These pieces of distribution data may be distributed to the corresponding slave processing circuits before the computation. The input feature map may, for example, be split among a plurality of SLs of a single SLB, as illustrated in FIG. 8. For example, the storage content in the second storage circuit may be referred to FIG. 9a (Group1) and FIG. 9c (Group4), and the storage content in the Group 16 mode is not shown.

Accordingly, the first caching circuit may cache a plurality of input feature data lines, which are from the second storage circuit and distributed to the slave processing circuit; the second caching circuit may cache a plurality of weight data lines of the convolution kernel corresponding to the output channel value, which are from the first storage circuit and multicast to the slave processing circuit. Depending on the splitting and/or reuse method, these data lines may be distributed to corresponding computing circuits CUs or broadcast to all computing circuits CUs within the slave processing circuit during the computation. Each computing circuit CU may then perform an element-wise multiply-accumulate operation on an input feature data line selected from the first caching circuit and a weight data line selected from the second caching circuit respectively in each computation.

When a plurality of computing circuits CUs in a single slave processing circuit SL process a single Co value together, it is necessary to split output points among the plurality of CUs. In the Forward4 scheme, the splitting method of the output points among four computing circuits CUs may refer to FIG. 10b. Specifically, each computing circuit computes a plurality of spaced output points of the output feature map in the X and/or Y dimensions during each computation.

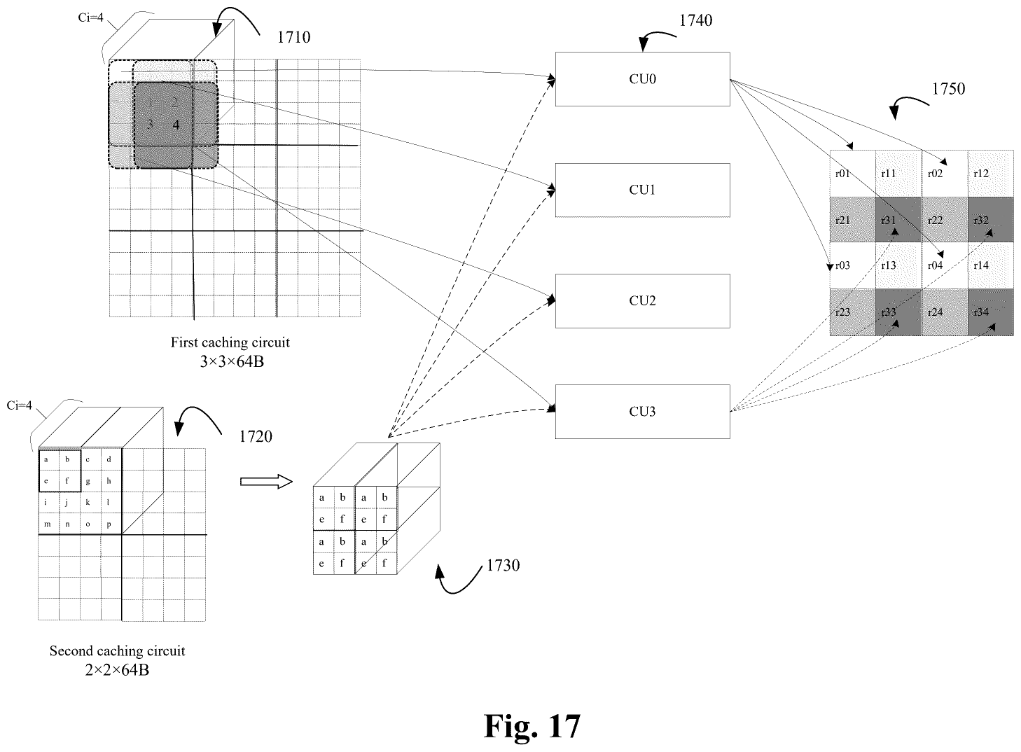

FIG. 17 shows a schematic diagram of a single computation in the Forward4 scheme according to an embodiment of the present disclosure. In this example, a first caching circuit 1710 has a size of 3×3×64 B, which means that the first caching circuit 1710 may cache up to 9 lines of data, and a second caching circuit 1720 has a size of 2×2×64 B, which means that the second caching circuit 1720 may cache up to 4 lines of data. To be consistent with the splitting units, the storage within the caching circuit in the figure is also shown in units of the splitting units.

A computation process of a first selection by sliding window is shown in the figure. A computation process of a first selection by sliding window is shown in the figure. In a manner corresponding to the splitting of the output points, N_{CU} input feature lines are selected from the first caching circuit by sliding by taking a splitting unit as a sliding window, and then sent to N_{CU} computing circuits for computation. 1/Nop weight lines are selected from the second caching circuit in a sliding method corresponding to that in the first caching circuit, where Nop is the maximum number of computable convolution output points per computing circuit at a single time, the selected 1/Nop weight lines are copied Nop−1 times to be extended into an extended weight line and broadcast to N_{CU} computing circuits in the slave processing circuit.

Specifically, in the computing apparatus shown in FIG. 5, N_{CU}=4, and Nop=4. The output points are split in a case where each computing circuit computes 2×2 output points spaced by 1 in both X and Y dimensions at each computation.

As shown in the figure, one input feature data line is selected from the first caching circuit 1710 at the starting position and the position moved by 1 in each of the X and/or Y directions, and a total of 4 input feature data lines are selected and correspondingly sent to 4 computing circuits 1740 in the slave processing circuit SL. ¼ weight data line is selected from the second caching circuit 1720 at the starting position, which is 2×2 data, and the selected ¼ weight data line is copied three times to be extended into one extended weight data line 1730 and broadcast to four computing circuits 1740 in the SL.

In each computation, each computing circuit performs an element-wise multiply-accumulate operation on an input feature line from the first caching circuit and an extended weight line from the second caching circuit in units of 1/Nop data lines, thus obtaining Nop partial sums.

As shown in the figure, four computing circuits 1740 perform element-wise multiply-accumulate operations on the distributed input feature data lines and the broadcast extended weight data lines to obtain a computation result 1750. In 1750, results of different background colors are obtained by different computing circuits 1740. As may be seen, in each computation, a CU computes a partial sum of four output points, and 4 CUs obtain a total of 4×4 partial sums. It may be seen that output points computed by each CU are not adjacent in the XoYo dimension of the output feature map.

Then, the selection by sliding window is synchronized in the first caching circuit and the second caching circuit to perform a next computation. Nk times of selection by sliding window may be performed, where Nk=ceil(Kx/2)*ceil(Ky/2), where Kx is a smaller value of a size of the convolution kernel in the X dimension or a maximum convolution kernel size supported by the slave processing circuit in a single computation in the current convolution splitting mode, and Ky is a smaller value of a size of the convolution kernel in the Y dimension or the maximum convolution kernel size supported by the slave processing circuit in a single computation in the current convolution splitting mode. Accordingly, the computing circuit accumulates Nk*Nop partial sums obtained during Nk times of sliding computation according to corresponding convolution output points, thus obtaining Nop computation results.

In some embodiments, in the Forward4 mode, the maximum convolution kernel size supported by the slave processing circuit in a single computation is 8×8.

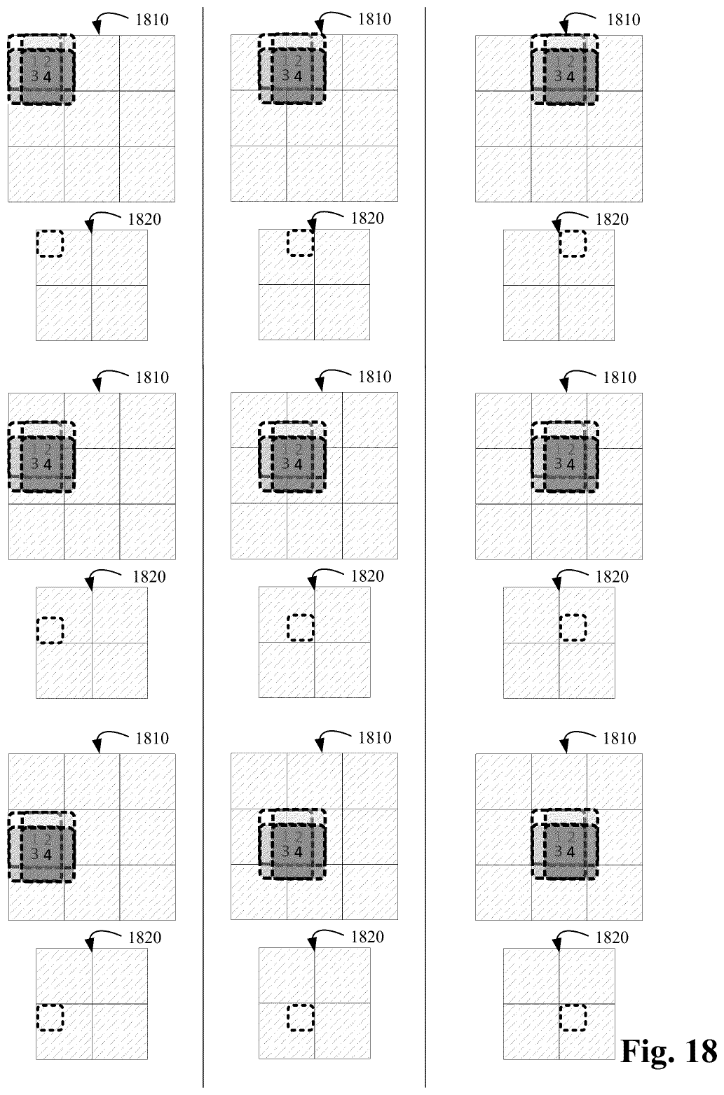

FIG. 18 shows a schematic diagram of a sliding convolution process in the Forward4 scheme according to an embodiment of the present disclosure. In this example, taking a 9×9 input feature map and a 5×5 convolution kernel as an example, if a convolution stride is 1, a size of an output feature map is 5×5. The input feature map is required to be aligned to 12×12 and is split into 9 blocks of 4×4×4 (C×H×W) size and stored in a first caching circuit, shown as 1810 in the figure, in which a C dimension is omitted. The 5×5 convolution kernel is required to be aligned to 8×8, the alignment part is padded with 0, and the convolution kernel is stored in a second caching circuit, shown as 1820 in the figure, in which a C dimension is also omitted. During each computation, a 2×2 block in the convolution kernel is selected and copied 4 times, which exactly corresponds to a 4×4 block in the input feature map. The copy operation may be realized by hardware.

The selection ranges of the input feature map and the convolution kernel in the first caching circuit and the second caching circuit during each sliding are shown in FIG. 18. There are 9 graphs in total, representing sliding 9 times in total. In the figure, a block 1810 represents an input feature map in a first caching circuit, and four dashed boxes represent areas selected to be sent to four CUs, a block 1820 represents a convolution kernel in a second caching circuit, and a dashed box represents a selected ¼ line, which is copied 3 copies and expanded into one line to be broadcast to four CUs. The number of slides is Nk=ceil(Kx/2)*ceil(Ky/2)=9.

In each computation, each CU performs an element-wise multiply-accumulate operation on an input feature data line from the first caching circuit and an extended weight data line from the second caching circuit by taking a ¼ data line as a unit to obtain four partial sums; and in a current round of computation, Nk partial sums corresponding to a same convolution output point obtained during Nk times of computation are accumulated to obtain and output four computation results.

Specifically, for each graph in FIG. 18, the number of CUs is Ncu=4, and each CU computes Nop=4 output points or partial sums at a time, where the partial sum is an element-wise multiply-accumulate result of a ¼ data line; in other words, each output point is standard 4×2×2 (Ci×Y×X) convolution. After sliding Nk=ceil(Kx/2)*ceil(Ky/2)=9 times, the accumulation is completed in the Y×X direction, and finally a complete 4×4 (Y×X) output is obtained in one SL (as shown in FIG. 10b). Under this mode, a single computation only supports a case where a convolution kernel is not larger than 8×8. For a larger convolution kernel, the convolution kernel is required to be split according to 8×8 in the Kx and Ky directions. The splitting operation may be carried out according to the same principle above.

It is understandable that when Ci>4, it is necessary to traverse in the Ci direction, switching inputs and weights simultaneously until a complete output is computed. When Xo/Yo computed by each CU is greater than 4, it is necessary to slide along the Xo/Yo direction to read different input neurons and weights. Those skilled in the art may similarly derive the computation process according to the above description, which is not described here.

As may be seen from the previous sliding convolution process, an order of an output result in a sliding mode is not a normal arrangement order of output data of traditional convolution. Therefore, during the output process, each slave processing circuit SL may convert a computation result of its computing circuit CU into a specified format, such as Nco×Uy×Ux. In some embodiments, each slave processing circuit may output a partial computation result(s) of a partial computing circuit(s) within it each time, where the partial computation results are continuous in the X and/or Y dimensions of the output feature map. The blocking circuit may further store a computation result returned from each slave processing circuit in a fourth dimension storage order. Depending on situations, the blocking circuit may also store the computation result in a desired dimension storage order.

When the grouping mode and/or the splitting method of the input feature map within a single SLB (which is the splitting method according to the HoWo of the output feature map) is different, the output data format is slightly different.

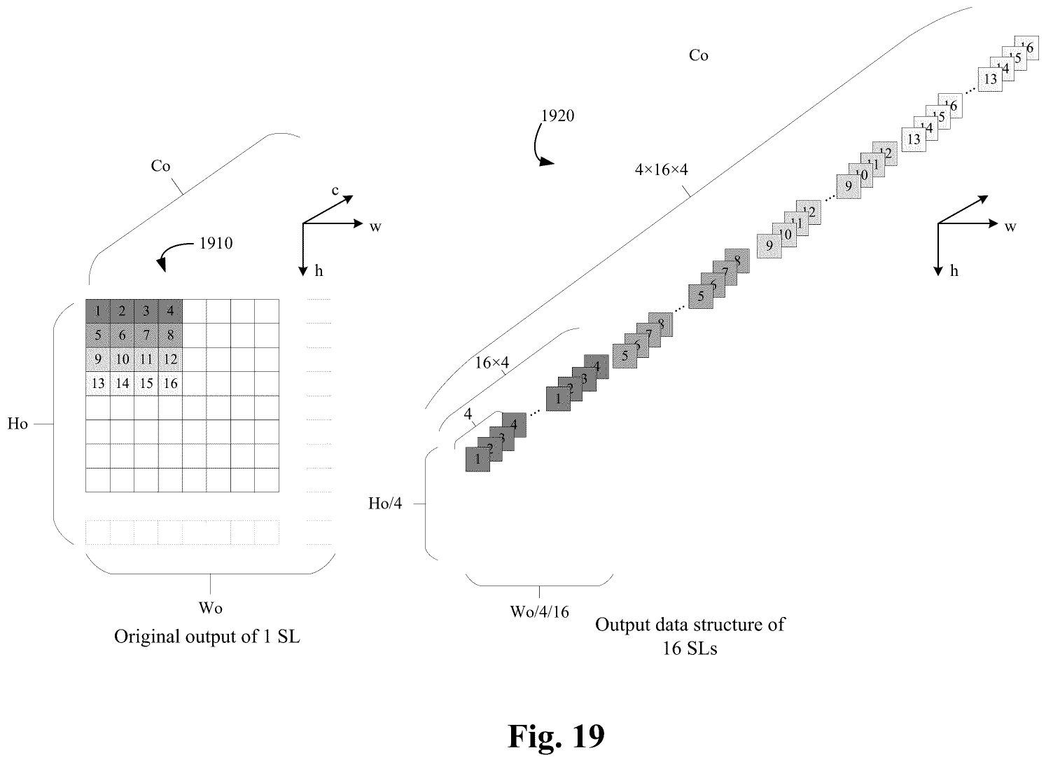

FIG. 19 shows a schematic output data format diagram in the Forward4 scheme according to an embodiment of the present disclosure. In this embodiment, the grouping mode is Group1, and the splitting method of the input feature map in a single SLB (including 16 SLs) is Ho×Wo=1×16.

In the figure, 1910 shows an original output of 1 SL. As may be seen from the figure, each SL outputs a 1×1×4 (Co×Y×X) area each time; in other words, each SL outputs partial computation results of the computing circuits within it each time, such as two computation results in each of the two CUs (refer to FIG. 10b). The partial computation results are continuous in the X and/or Y dimensions of the output feature map. For example, the partial computation results may be in the same line (as shown in FIG. 19) or the same column. The 1×4×4 (Co×Y×X) area is returned for four consecutive times, obtaining four computation results of each of the four CUs. Different SLs output to different areas of the output feature map of the same Co. After all 4×4 areas of Co have been output, the continued outputting will switch different output points.

In the figure, 1920 shows an output data structure of 16 SLs. As shown in the figure, final output data is changed into Yo*Xo*Co*4*16*4 format after being written into a storage circuit (such as the first storage circuit), where Yo and Xo are the numbers of blocks of the output feature map split into each SL, and 16 represents the splitting on the 16 SLs. Depending on needs, in some implementations, a data arrangement operation may be performed again to convert data to other desired data formats.

As mentioned earlier, when the grouping mode and/or the splitting method of the input feature map among a plurality of SLs within a single SLB is different, there are also subtle differences in the output data format. It is assumed that an original output size is:

$$1 * ho * wo * co .$$

Then, in the Group1 mode, when the input feature map is split according to 4*4 in the Ho*Wo, a shape of output data is:

$$ho / ( 4 * 4 ) * wo / ( 4 * 4 ) * co / group * ( 4 * 16 * 4 ) .$$

In the above formula, (4*16*4) is a basic output block of forward4, whose directions correspond to h*c*w respectively, where 16 represents the splitting of ho and wo of the same co on 16 SLs; and ho, wo are divided by 4 twice, where a first 4 represents performing 4×4 splitting when storing data in SL, and a second 4 represents the folding of data blocks in the direction of h and w. In Group1 mode, the above group=1.

In the Group1 mode, when the input feature map is split according to 1*16 in the Ho*Wo, a shape of output data is:

$$ho / ( 4 ) * wo / ( 4 * 16 ) * co / group * ( 4 * 16 * 4 ) .$$

In the above formula, (4*16*4) is a basic output block of forward4, whose directions correspond to h*c*w respectively, where 16 represents the splitting of ho and wo of the same co on 16 Sls; and in the Group1 mode, the above group=1. This shape is also the shape of the diagram in FIG. 19.

Thus, in the case of Group1, the Yo*Xo dimension of one output feature map is bisected by 16 SLs. When output, the data in the inline dimension SL corresponds one-to-one to the way in which output neurons are bisected by 16 SLs in the Yo*Xo direction. This scenario is suitable for input neurons with large values in the Y*X direction and small Co values.

In the Group4 mode, the shape of the output data is:

$$ho / ( 2 * 4 ) * wo / ( 2 * 4 ) * co / group * ( 4 * 16 * 4 ) .$$

In the above formula, (4*16*4) has the same meaning as above, except that 16 represents the output splitting of wo of four cos on four SLs. In Group4 mode, the above group=4.

In the Group16 mode, the shape of the output data is:

$$ho / 4 * wo / 4 * co / group * ( 4 * 16 * 4 ) .$$

In the above, (4*16*4) has the same meaning as above, except that 16 represents the output splitting of 16 cos on 16 SLs. In Group16 mode, the above group=16.

Since there are different splitting categories of Group in the H*W direction, 16 in 4*16*4 mentioned in the above is different in the specific splitting. Since a 4 B*4*4 block is used as a computation unit in the Forward4, there are inevitable alignment limitations in the computation. According to different Group modes, different H*W splitting modes of the same Group mode will have different alignment limitations in the computation finally. In the computation of alignment, the alignment limitation of ho*wo may be determined first according to the splitting mode of the output feature map, and hi*wi is then derived backwards from ho*wo. Because input neurons need to be arranged into the form of splitting unit blocks, alignment is required to be performed again. The above alignment limitations may be summarized in Table 2:

TABLE 2
Alignment limitations

| Alignment | | | |
|---|---|---|---|
| limitations | Group1 | Group4 | Group16 |
| Output (ho, wo) | 4 × 4 splitting: 16 * 16 | 1 × 4 splitting: 4 * 16 | No splitting in ho, |
| | 1 × 16 splitting: 4 * 64 | 2 × 2 splitting: 8 * 8 | wo directions: 4 * 4 |
| Input (hi*wi*ci) | Int8: 4 * 4 * 4 | Int8: 4 * 4 * 4 | Int8: 4 * 4 * 4 |
| | half: 4 * 4 * 2 | half: 4 * 4 * 2 | half: 4 * 4 * 2 |
| | float: 4 * 4 * 1 | half: 4 * 4 * 1 | half: 4 * 4 * 1 |
| Convolution kernel | Computation | Computation | Computation |
| (kh, kw) | alignment 2 * 2 | alignment 2 * 2 | alignment 2 * 2 |
| | Splitting unit | Splitting unit | Splitting unit |
| | alignment 4 * 4 | alignment 4 * 4 | alignment 4 * 4 |
| Input channel (ci) | 4B | 4B | 4B |
| Output channel (co) | 1 | 4 | 16 |

To sum up, when output, hardware may automatically output neurons according to a 4*16*4 (Y*SL*X) dimension within the line and a Y*X*C dimension between the lines. The same goes for larger convolution kernels.

In some embodiments, in view of the storage space of the registers inside the computing circuit, for example, a single slave processing circuit containing four computing circuits computing up to 16 4×4 output feature areas, the input feature maps/neurons may be reused, thereby reducing the reading frequency of the second storage circuit. In other words, the reading frequencies of the first storage circuit and the second storage circuit may be different. If the result computed by the computing circuit is a partial sum, the result is stored in the internal register.

In these embodiments, the slave processing circuit may be further configured to: determine the number of times rn that the input feature map is reused in the slave processing circuit according to the storage space limitations in the computing circuit; and control the loading frequency of weight data in the second caching circuit, so that input feature map data loaded each time in the first caching circuit is reused rn times, and performs a convolution operation with corresponding weight data loaded rn times in the second caching circuit. In some examples, rn may take a value not greater than 16.

### Embodiment 3: Forward1

In a Forward1 scheme, a shape of a splitting unit is the same as that in Forward4, which is also 4 B×4×4; the difference is that the Forward1 scheme applies to depthwise convolution operations, i.e. 2D convolution operations. The principle of the 2D convolution operations may be described above in conjunction with FIG. 4b. The following description may be applied to a convolution splitting scheme similar to the Forward1.

Since input channels are not accumulated in the depthwise convolution, dimensions of the convolution kernel and the input feature map be simplified into three dimensions: C (channel), H (height), and W (width). The shape of the splitting unit indicated by these convolution splitting schemes also satisfies: Uc×Uy×Ux=M, where Uc is a size of the splitting unit on an initial lowest storage dimension (such as C dimension) of an input feature map and a convolution kernel, Ux is a size of the splitting unit on an initial X storage dimension of the input feature map and the convolution kernel, Uy is a size of the splitting unit on an initial Y storage dimension of the input feature map and the convolution kernel, and M is a maximum computation amount of hardware at a time. In these convolution splitting schemes, Ux=Uy≥Uc>1, Uc=M/4n, n=1, 2, . . . ½ log₂ M−1.

The example of data splitting and storage in the Forward1 scheme may refer to the description of Forward4 in Embodiment 2, for example, referring to FIG. 16, and the same part will not be repeated. For the Forward1 scheme, it is only necessary to replace Ci and Co dimensions with C dimension, which is to simplify the input feature map and the convolution kernel into three-dimensional data.

Specifically, when the data is a neuron, the data is required to be arranged from [Hi Wi C] as:
[Hi/4*Wi/4*C/4*(4×4×4)], which is a shape of a six-dimensional tensor, omitting N dimension.

When the data is a weight, the data is required to be arranged from [Kh Kw C] as:
[Kh/4*Kw/4*C/4*(4×4×4)], which is also a shape of a six-dimensional tensor, omitting N dimension.

When the Forward1 convolution splitting scheme is performed using the computing apparatus shown in FIG. 5, according to the Forward1 convolution splitting scheme, the input feature map and the convolution kernel may be split into a plurality of corresponding splitting units by a blocking circuit integrated within the master processing circuit or a blocking circuit completely or partially independent of the master processing circuit. The blocking circuit may also convert the dimension storage orders of the input feature map and the convolution kernel, so that data in each splitting unit is continuously stored in one data line. The split and converted input feature map and/or convolution kernel may be supplied to the master processing circuit or the slave processing circuit. The master processing circuit may then distribute the obtained data to a plurality of slave processing circuits to perform convolution operations. According to the convolution splitting scheme, computation results returned from the plurality of slave processing circuits are spliced to obtain the output feature map of the convolution operation of the input feature map and the convolution kernel. The plurality of slave processing circuits may perform convolution operations based on the obtained data and return computation results to the master processing circuit.

In a depthwise convolution operation scenario, such as Forward1, because computation results in C dimension are not required to be accumulated, operations on different Cs are allocated to different computing circuits, where the operations may be performed relatively independently. It should be noted that in the Forward1 splitting scheme, the C dimension will be aligned according to 4 B. Therefore, when processed in units of the splitting units, the C dimension will be aligned to 4 B (which is Uc) before being split. In other words, the processing on different computing circuits is split in units of Uc in the C dimension.

In depthwise convolution scenarios, the number of channels C is usually small, while the convolution kernel and the input feature map are generally large. In these embodiments, typically in a single round of computation, the multiples of Nc in the channel C of the input feature map and the convolution kernel to Uc do not exceed the number of slave processing circuits scheduled, so the computation of a single channel in units of Uc may be completed by one or more slave processing circuits. More generally, even when the C dimension is large, the convolution operation may be implemented by splitting it into a plurality of rounds of computation, where the multiple of the C dimension size Nc to Uc for each round of computation is less than or equal to the number of slave processing circuits scheduled. Thus, in an example, the number of rounds of computation required to complete the convolution operation and the number Nc of Cs processed in each round or a corresponding grouping mode may be first determined based on the size of the channel C dimension of the convolution kernel and the number Ns of schedulable slave processing circuits, where Nc is aligned to Uc.

Similar to Forward4, the Forward1 scheme may also support the three grouping modes described in FIG. 7: Group1, Group4, and Group16. The difference between the grouping modes of Forward1 and Forward4 is that the splitting of C dimension in Forward1 is carried out in units of Uc; for example, every 4 consecutive Cs (corresponding to a Uc) are allocated to a group (or a slave processing circuit group SLB). Thus, in some embodiments, according to the C dimension size Nc of the convolution kernel and the number Ns of schedulable slave processing circuits in a single round of computation, each Rs slave processing circuits corresponding to the convolution kernel and the input feature map of the same Uc may be determined, and Rs=[Ns/(Nc/Uc)], which represents the number of times that the weight is reused among the slave processing circuits.

To support all three grouping modes at the same time, in some embodiments, the convolution kernel may be determined as multicast data, and the multicast data after being split and converted in its dimension storage order may be stored in the first storage circuit for transmission to the plurality of scheduled slave processing circuits through the broadcast bus during the computation. Correspondingly, the input feature map may be determined as distribution data, and the distribution data after being split and converted in its dimension storage order may be stored in the second storage circuit for distribution to the corresponding slave processing circuits. These pieces of distribution data may be distributed to the corresponding slave processing circuits before the computation.

The input feature map may, for example, be split among a plurality of SLs of a single SLB, as illustrated in FIG. 8. Specifically, the input feature map corresponding to Uc may be split among each Rs slave processing circuits by: splitting the output feature map evenly into Rs output feature blocks with the same shape in the X and Y dimensions according to the size of the output feature map; splitting the input feature map into Rs input feature blocks in the X and Y dimensions according to an input feature map area required for computing each output feature block; and splitting the Rs input feature blocks according to the splitting units respectively and storing the split Rs input feature blocks in the storage areas allocated for Rs slave processing circuits in the second storage circuit after converting the dimension storage order.

The storage content in the second storage circuit may be referred to FIG. 9a (Group1) and FIG. 9c (Group4), and the storage content in the Group16 mode is not shown.

Accordingly, the first caching circuit may cache a plurality of input feature data lines, which are from the second storage circuit and distributed to the slave processing circuit; the second caching circuit may cache a plurality of weight data lines of the convolution kernel corresponding to the output channel value, which are from the first storage circuit and multicast to the slave processing circuit. Depending on the split and/or reuse method, these data lines may be distributed to corresponding computing circuits CUs or broadcast to all computing circuits CUs within the slave processing circuit during the computation. Each computing circuit CU may then perform an element-wise multiply-accumulate operation on an input feature data line selected from the first caching circuit and a weight data line selected from the second caching circuit respectively in each computation.

When a plurality of computing circuits CUs in a single slave processing circuit SL process a single Uc together, it is necessary to split output points among the plurality of CUs. Similar to the Forward4, in the Forward1, the splitting is also performed according to the way in which each computing circuit allocates spaced output points. However, in the Forward1, the convolution kernel is split on a smaller scale, and the convolution kernel is split in units of 4×4, while in the Forward4, the convolution kernel is split in units of 8×8, so the splitting of the output points is slightly different. Specifically, in an embodiment, each computing circuit computes one spaced output point of the output feature map in X and/or Y dimensions during each computation; and in different computations, each computing circuit computes different output points of the output feature map in the X and/or Y dimensions.

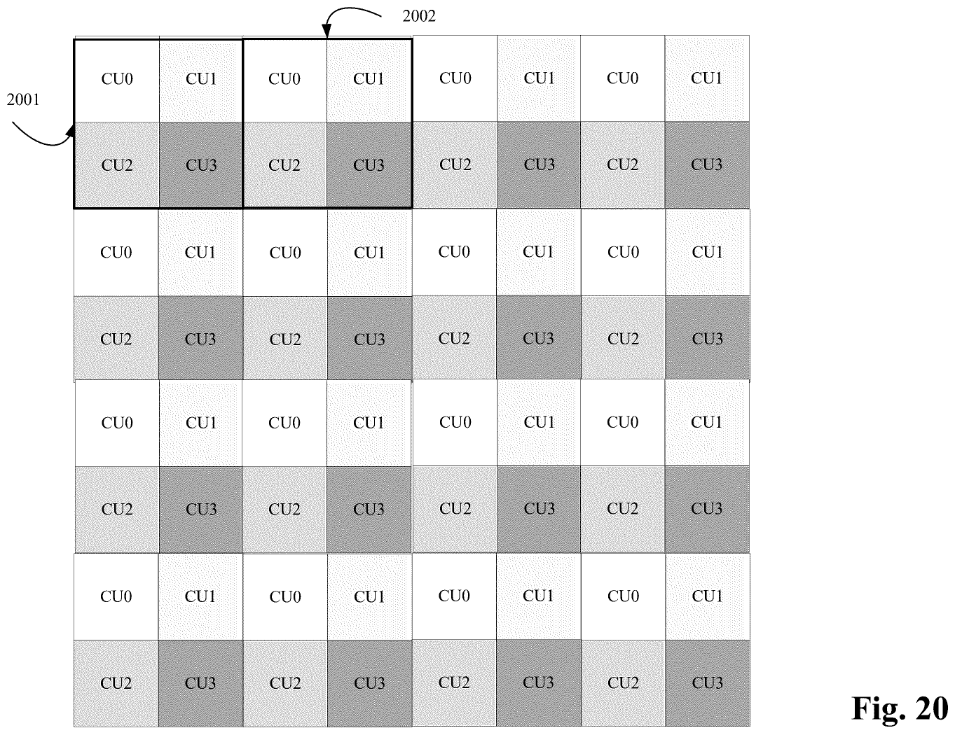

FIG. 20 shows a schematic diagram of output point splitting of a computing circuit in the Forward 1 scheme according to an embodiment of the present disclosure.

Since the convolution kernel is split in units of 4×4, only one line of weight in the second caching circuit is required to be used in each computation, and a maximum of 9 lines of input feature data may be stored in the first caching circuit, so a maximum of 8×8 outputs may be computed. The figure shows the splitting of 4 computing circuits at 8×8 output points, where different backgrounds are used to show output points allocated to 4 different computing circuits CU0˜CU3. Since there is only one line of weight in each computation, current output points may be obtained per computation, without the need for sliding and accumulation.

For example, in the first slide, four CUs compute four output points in a first sub-block 2001 respectively; in the second slide to the right, four CUs compute four output points in a second sub-block 2002, and so on. The 8×8 output points require sliding 16 times accordingly.

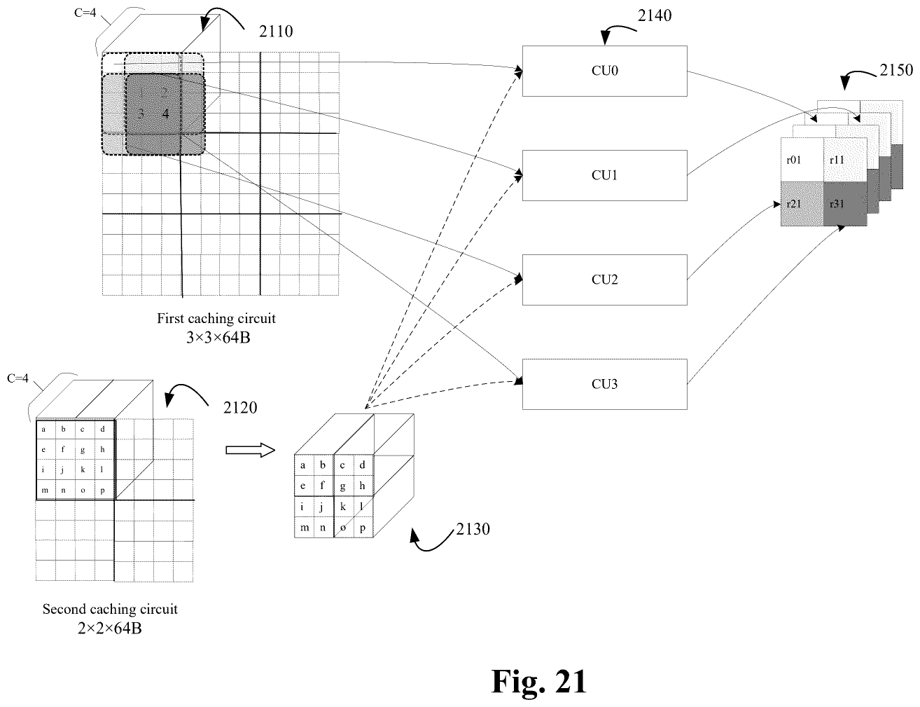

FIG. 21 shows a schematic diagram of a single computation in the Forward1 scheme according to an embodiment of the present disclosure. In this example, a first caching circuit 2110 has a size of 3×3×64 B, which means that the first caching circuit 2110 may cache up to 9 lines of data, and a second caching circuit 2120 has a size of 2×2×64 B, which means that the second caching circuit 2120 may cache up to 4 lines of data. To be consistent with the splitting units, the storage within the caching circuit in the figure is also shown in units of the splitting units.

A computation process of a first selection by sliding window is shown in the figure. According to a method corresponding to the splitting method of the output points, N_{CU} input feature lines are selected from the first caching circuit by taking a splitting unit as a sliding window, and sent to N_{CU} computing circuits in the slave processing circuit for computation. One weight data line is read from the second caching circuit and broadcast to the N_{CU} computing circuits in the slave processing circuit.

Specifically, in the computing apparatus shown in FIG. 5, N_{CU}=4, and Nop=4.

As shown in the figure, one input feature data line is selected from the first caching circuit 2110 at the starting position and the position moved by 1 in the X and/or Y direction respectively, and a total of 4 input feature data lines are selected and correspondingly sent to 4 computing circuits 2140 in the slave processing circuit SL. One weight data line is selected from the second caching circuit 2120 at the starting position, which means that data 2130 with a size of 4×4 is selected, and broadcast to four computing circuits 2140 in the SL.

In each computation, for an input feature line from the first caching circuit and a weight line from the second caching circuit, taking 1/Uc data line as a unit, an element-wise multiply-accumulate operation is performed on feature data and weight data corresponding to the same channel value to obtain Uc output points.

As shown in the figure, four computing circuits 2140 perform element-wise multiply-accumulate operations on the distributed input feature data lines and the broadcast weight data lines according to 1/Uc (Uc=4) line to obtain a computation result 2150. In 2150, results of different background colors are obtained by different computing circuits 2140. As may be seen, in each computation, a CU computes one output point on each XoYo plane on Uc, and 4 CUs obtain Uc×2×2 output points in total. It may be seen that the output points computed by the four Cus are adjacent in the XoYo dimension of the output feature map.

Then, the selection by sliding window is performed in the first caching circuit, no slide is performed in the second caching circuit, and this line of weight is still used for a next computation. Nk times of selection by sliding window are performed in the first caching circuit, where Nk=Kx*Ky, where Kx is a smaller value of a size of the convolution kernel in the X dimension or a maximum convolution kernel size supported by the slave processing circuit in a single computation in the current convolution splitting mode, and Ky is a smaller value of a size of the convolution kernel in the Y dimension or the maximum convolution kernel size supported by the slave processing circuit in a single computation in the current convolution splitting mode. Accordingly, the computing circuit splices Nk*Uc output points obtained during Nk times of sliding computation according to the splitting method of the output points, thus obtaining the Nk*N_{CU} computation results on the Uc channels.

In some embodiments, in the Forward1 mode, the maximum convolution kernel size supported by the slave processing circuit in a single computation is 4×4.

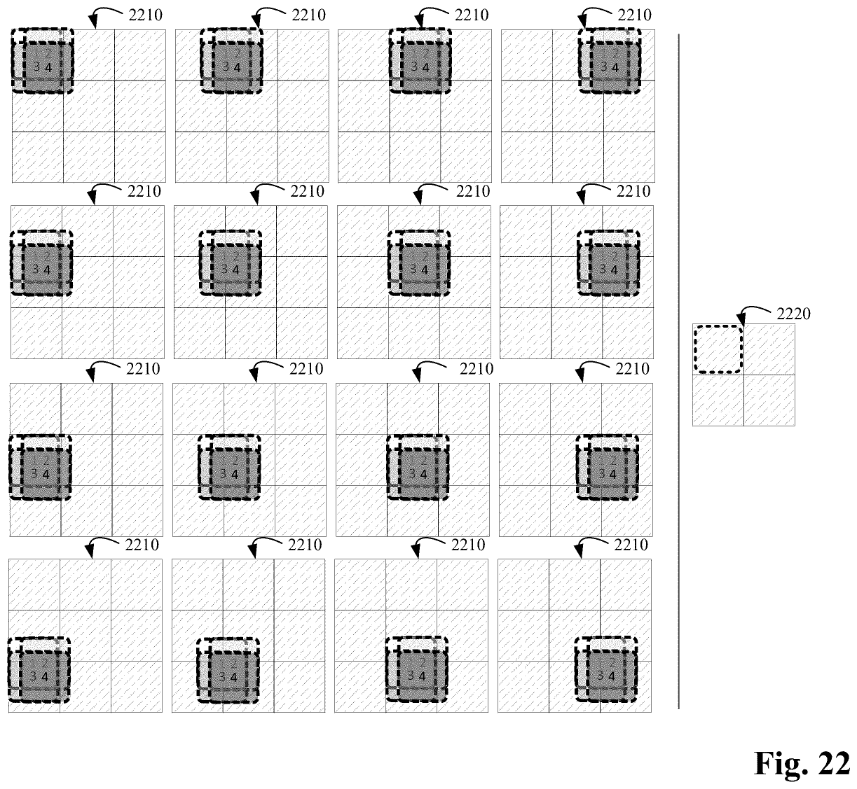

FIG. 22 shows a schematic diagram of a sliding convolution process in the Forward1 scheme according to an embodiment of the present disclosure. In this example, taking an 11×11 input feature map and a 4×4 convolution kernel as an example, if a convolution stride is 1, a size of an output feature map is 8×8. The input feature map needs to be aligned to 12×12, split into 9 blocks of 4×4×4 (C×H×W) size, stored in the first caching circuit, and shown as 2210 in the figure, where the C dimension is omitted. The convolution kernel is split according to 4×4, stored in the second caching circuit, and shown as 2220 in the figure, where the C dimension is also omitted. During each computation, a convolution kernel with a 4×4 size is selected, which just corresponds to a block with a 4×4 size of the input feature map and is broadcast to 4 computing circuits.

Selection ranges of the input feature map and the convolution kernel in the first caching circuit and the second caching circuit at each slide are shown in FIG. 22, with a total of 16 graphs, representing a total of 16 slides. The block 2210 in the figure represents the input feature map in the first caching circuit, and 4 dashed boxes represent the areas selected to be sent to 4 CUs. The block 2220 represents the convolution kernel in the second caching circuit, and a dashed box represents 1 weight line selected, which is broadcast to 4 CUs and does not require reselection during the sliding. The number of slides Nk=Kx*Ky, where Kx is a smaller value of a size of the convolution kernel in the X dimension and a maximum convolution kernel size supported by the slave processing circuit in a single computation, and Ky is a smaller value of a size of the convolution kernel in the Y dimension and a maximum convolution kernel size supported by the slave processing circuit in a single computation. The sliding stride is 2. Similarly, the maximum convolution kernel size supported by the slave processing circuit in a single computation is determined by at least the space sizes of the first caching circuit and the second caching circuit. It may be understood that when the convolution kernel is greater than the maximum convolution kernel size, it needs to be split according to the maximum convolution kernel size in the Kx and Ky directions.

During each computation, each CU performs an element-wise multiply-accumulate operation on an input feature data line from the first caching circuit and a weight data line from the second caching circuit according to 1/Uc line, and obtains one output point on each XoYo plane on Uc, so that N_{CU} computing circuits obtain N_{CU} output points on Uc XoYo planes each time. It may be understood that after sliding through Nk cycles of computations, Nk*N_{CU} output points on the Uc XoYo planes may be obtained. By splicing the Nk*N_{CU} output points, a maximum of 8×8 (Ho*Wo) output points on Uc planes in the C dimension, that is, Uc×8×8, are obtained.

Specifically, for each graph in FIG. 22, the number Ncu of CUs is 4, each CU computes 1 output point on Uc planes in the C dimension at a time, and this partial sum is an element-wise multiply-accumulate result of 1/Uc (¼) data lines, which means that each output point is a 4×4 (Y×X) 2D convolution. After sliding Nk=Kx*Ky=16 times, the computation of a maximum output point is completed, and an output of 8×8 (Y×X) is obtained in 1 SL (as shown in FIG. 20). In this mode, a single computation only supports the case of a 4×4 convolution kernel. For larger convolution kernels, it needs to be split according to 4×4 in the Kx and Ky directions. The splitting operation may be performed according to the same principle as above.

It may be understood that when the Xo/Yo computed by each CU is greater than 8, it is necessary to slide along the Xo/Yo direction to read different input neurons and weights. Those skilled in the art may similarly deduce the computation process based on the above description, which will not be described here.

As may be seen from the previous sliding convolution process, an output result in the sliding mode is not in a normal order of traditional convolution output data. Therefore, during the output process, each slave processing circuit SL may convert a computation result of its internal computing circuit CU into a specified format, such as the format of Nc×Uy×Ux. In some embodiments, each slave processing circuit may output a partial computation result(s) of a partial computing circuit(s) within it each time, where these partial computation results are continuous in the X and/or Y dimensions of the output feature map. The blocking circuit may further store a computation result returned from each slave processing circuit in a fourth-dimension storage order. Depending on situations, the blocking circuit may also store the computation results in a desired dimension storage order.

When a grouping mode and/or a splitting method of the input feature map within a single SLB (that is, the splitting method according to the HoWo of the output feature map) are different, the output data format is slightly different.

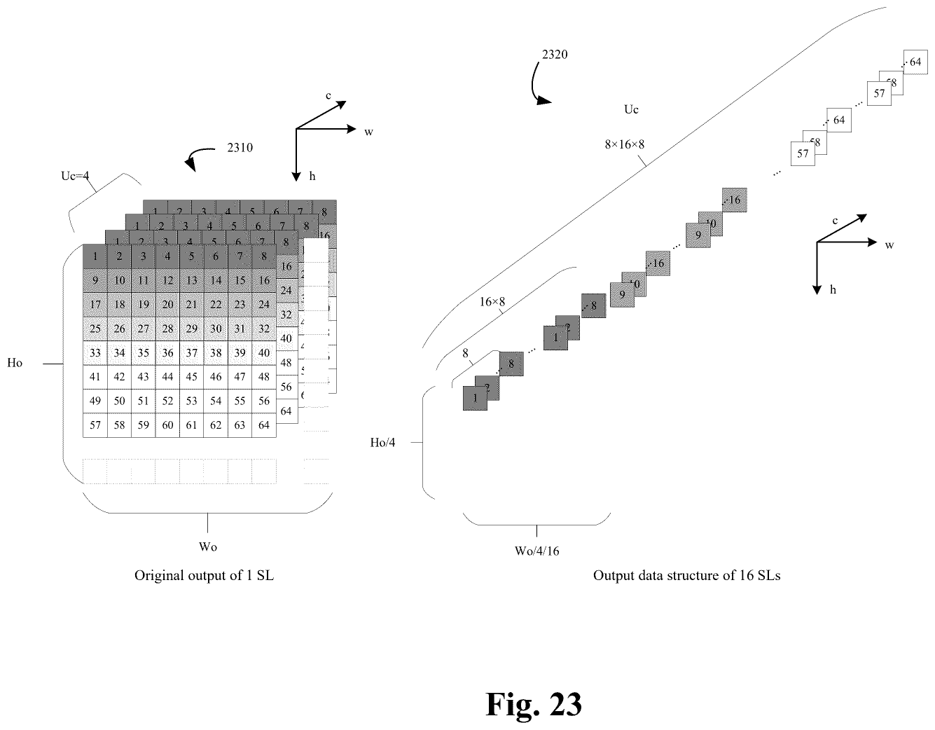

FIG. 23 shows a schematic output data format diagram in the Forward1 scheme according to an embodiment of the present disclosure. In this embodiment, the grouping mode is Group 1, and the input feature map in a single SLB (including 16 SLs) is split according to Ho×Wo=1×16.

The 2310 in the figure shows an original output of 1 SL. As may be seen from the figure, each SL outputs an area of Uc×1×8 (C×Y×X) each time, and in other words, the SL outputs partial computation result(s) of a computing circuit in the SL each time, for example, 4 computation results in each of the 2 CUs (see FIG. 20). These partial computation results are continuous in the X and/or Y dimensions of the output feature map, for example, in the same line (as shown in FIG. 20) or the same column. The area of Uc×8×8 (C×Y×X) is returned 8 times continuously, that is, the 16 computation results of each of the 4 CUs. Different SLs output different areas of the output feature map of the same Uc. After outputting all 8×8 areas of Uc, continuing to output will switch different output points.

The 2320 in the figure shows the output data structure of 16 SLs. As shown in the figure, final output data becomes the format of Yo*Xo*ceil[C/Uc]*Uc*8*16*8 after being written into a storage circuit (such as the first storage circuit), where Yo and Xo are the number of blocks of the output feature map that each SL is split into, and 16 is the splitting on 16 SLs. As required, in some implementations, a data arrangement operation may be performed again to convert the data into other desired data formats.

As mentioned earlier, there are subtle differences in the output data format when the grouping mode and/or the splitting method of the input feature map among a plurality of SLs within a single SLB are different. It is assumed that an original output size is:

$$1 * ho * wo * c ,$$

an output data shape of Group1 when Ho*Wo is split according to 4*4 is:

$$ho / ( 4 * 4 ) * wo / ( 4 * 4 ) * c / group / Uc * Uc * ( 8 * 16 * 8 ) .$$

In the above formula, (8*16*8) is a basic output block of forward1, and the directions correspond to h*c*w respectively, where 16 represents the splitting of ho and wo of the same Uc on 16 SLs; ho and wo are divided by 4 twice, where the first 4 represents 4×4 splitting when storing data in SL, and the second 4 represents folding of data blocks in the h and w directions. In a Group 1 mode, the above group=1.

an output data shape of Group1 when Ho*Wo is split according to 1*16 is:

$$ho / ( 4 ) * wo / ( 4 * 16 ) * c / group / Uc * Uc * ( 8 * 16 * 8 ) .$$

In the above formula, (8*16*8) is a basic output block of forward1, and the directions correspond to h*c*w respectively, where 16 represents the splitting of ho and wo of the same Uc on 16 SLs; in a Group1 mode, the above group=1. This shape is also the shape of the schematic diagram in FIG. 23.

It may be seen that in the case of Group1, 16 SLs equally split the Yo*Xo dimension of an output feature map. The data in the inline dimension SL during output corresponds one-to-one to the method that the 16 SLs equally split the output neurons in the Yo*Xo direction. This scenario is suitable for input neurons with large values in the Y*X direction and small c values.

An output data shape of Group 4 is:

$$ho / ( 2 * 4 ) * wo / ( 2 * 4 ) * c / group / Uc * Uc * ( 8 * 16 * 8 ) .$$

In the above formula, (8*16*8) has the same meaning as above, except that 16 represents wo output splitting of 4 Ucs on 4 SLs. In a Group4 mode, the above group=4.

An output data shape of Group 16 is:

$$ho / 4 * wo / 4 * co / group / Uc * Uc * ( 8 * 16 * 8 ) .$$

In the above formula, (8*16*8) has the same meaning as above, except that 16 represents output splitting of 16 Ucs on 16 SLs. In a Group 16 mode, the above group=16.

Since Group has different splitting categories in the H*W direction, the specific splittings of 16 in the above 8*16*8 are still different. Since Forward 1 is based on a 4 B*4*4 block as a computing unit, there are inevitably alignment limitations during computation. Depending on the different Group modes and different H*W splitting methods of the same Group mode, the alignment limitations during computation are different finally. In the computation of alignment, the alignment limitations of ho*wo may be firstly determined according to the splitting method of the output feature map, and then hi*wi is reversely inferred from ho*wo. Since the input neurons need to be arranged in the form of splitting unit blocks, they need to be aligned again. The above alignment limitations may be summarized in Table 3:

TABLE 3
Forward1 alignment limitations

| Alignment | | | |
|---|---|---|---|
| limitations | Group1 | Group4 | Group16 |
| Output (ho, wo) | 4 × 4 splitting: 16 * 16 | 1 × 4 splitting: 4 * 16 | No splitting in ho, |
| | 1 × 16 splitting: 4 * 64 | 2 × 2 splitting: 8 * 8 | wo directions: 4 * 4 |
| Input (hi*wi*ci) | int8: 4 * 4 * 4 | int8: 4 * 4 * 4 | int8: 4 * 4 * 4 |
| | half: 4 * 4 * 2 | half: 4 * 4 * 2 | half: 4 * 4 * 2 |
| | float: 4 * 4 * 1 | half: 4 * 4 * 1 | half: 4 * 4 * 1 |
| Convolution kernel | Computation | Computation | Computation |
| (kh, kw) | alignment 4 * 4 | alignment 4 * 4 | alignment 4 * 4 |
| | Splitting unit | Splitting unit | Splitting unit |
| | alignment 4 * 4 | alignment 4 * 4 | alignment 4 * 4 |
| Channel (c) | 4B | 4*4B | 16*4B |

To sum up, when outputting, the hardware may automatically output neurons in the inline 8*16*8 (Y*SL*X) dimension and the Y*X*C dimension between lines. The same goes for larger convolution kernels.

In some embodiments, considering storage space of an internal register of the computing circuit, for example, a single slave processing circuit including four computing circuits computing up to 16 output feature areas of 4×4 size, an input feature map/neuron may be reused, thereby reducing a reading frequency of the second storage circuit. In other words, the reading frequency of the first storage circuit may be different from the reading frequency of the second storage circuit. If the result computed by the computing circuit is a partial sum, it is stored in the internal register.

In these embodiments, the slave processing circuit may be further used to: determine the number of times rn that the input features within the slave processing circuit are reused based on the storage space limitation within the computing circuit; and control a loading frequency of the weight data in the second caching circuit, so that the input feature data loaded each time in the first caching circuit is reused rn times, and is convolved with the corresponding weight data loaded rn times in the second caching circuit. In some examples, rn may take a value not greater than 16.

### Embodiment 4: Update1

In Update1, the shape of the splitting unit is the same as that in Forward1, which is also 4 B×4×4; and the difference is that Update1 is applied to a depthwise convolution operation in reverse training of the neural network model, specifically for a weight update process in the reverse training of the depthwise convolution operation, while Forward1 is applied to a forward depthwise convolution operation, both of which are 2D convolution operations. The principle of the reverse depthwise convolution operation may be referred to the previous description in conjunction with FIG. 4b. In the reverse depthwise convolution operation scenario, the size of top_diff and the size of bottom_data are usually large, so different optimization operation schemes are required.

In the following description, although top_diff and bottom_data will be used to refer to data to be computed, the previous description of the convolution kernel may be applied similarly to top_diff, and the description of the input feature map may be applied similarly to bottom_data, which means that both may be used interchangeably. The following description may be applied to a convolution splitting scheme similar to Update1.

Since no accumulation is performed in the input channels in depthwise convolution, the dimensions of top_diff and bottom_data may be simplified into three dimensions: C (channel), H (height), and W (width). The shape of splitting units indicated by these convolution splitting schemes also satisfies: Uc×Uy×Ux=M, where Uc is the size of the splitting unit in an initial lowest storage dimension (e.g., C dimension) of bottom_data and top_diff, Ux and Uy are the sizes of the splitting unit in initial X and Y storage dimensions of bottom_data and top_diff, respectively, and M is a maximum computation amount of hardware at a time. In these convolution splitting schemes, Ux=Uy≥Uc>1, Uc=M/4ⁿ, n=1, 2, . . . ½ log₂ M−1.

Since product results in the C channel dimension are not accumulated in the depthwise convolution operation, when an original arithmetic unit performs conventional 3D convolution, for example, 64 numbers multiplied by 64 numbers in the C dimension, 1 number is obtained after the accumulation, but now it will get 64 numbers. In other words, since the non-accumulation in the C dimension wastes the computing power of the arithmetic unit, it brings performance losses to the arithmetic unit. In order to make full use of the computing power of the arithmetic unit, the data in dimensions where accumulation is performed (such as the H and W dimensions) is transferred to the C dimension through the above splitting method, thereby improving the utilization rate of the arithmetic unit. For example, when using a 4 B×4×4 splitting unit, it is assumed that the data type is int 8, an accumulation result of 64 numbers multiplied by 64 numbers is 4 numbers instead of the original 64 numbers.

For an example of splitting and storing data in the Update1 scheme, reference may be made to the description of Forward4 in Example 2, for example, reference may be made to FIG. 16, and the same parts will not be repeated. For the Update1 scheme, it is only needed to replace the Ci and Co dimensions with the C dimension, which means that the input feature map (bottom_data) and the convolution kernel (top_diff) are simplified into three-dimensional data.

Specifically, for bottom_data, the data needs to be arranged from [Hi Wi C] to:
[Hi/4*Wi/4*C/4*(4×4×4)], which is the shape of this six-dimensional tensor, omitting the N dimension.

For top_diff, the data needs to be arranged from [Ho Wo C] to:
[Ho/4*Wo/4*C/4*(4×4×4)], which is the shape of this six-dimensional tensor, omitting the N dimension.

When the computing device shown in FIG. 5 is used to execute the Update1 convolution splitting scheme, bottom_data and top_diff may be split into a plurality of splitting units according to the Update1 convolution splitting scheme by a blocking circuit integrated in the master processing circuit or a blocking circuit that is completely or partially independent of the master processing circuit. The blocking circuit may also convert the dimension storage order of bottom_data and top_diff, so that the data in each splitting unit is stored continuously as a data line. The split and converted bottom_data and/or top_diff may be provided to a master processing circuit or a slave processing circuit. Then, the master processing circuit may distribute the data it obtains to a plurality of slave processing circuits for performing convolution operations; and according to the convolution splitting scheme, computation results returned by the scheduled plurality of slave processing circuits are spliced to obtain the output ΔW (or referred to as weight_diff) of the depthwise convolution operation of bottom_data and top_diff. A plurality of slave processing circuits may perform convolution operations based on the data they obtain and return the computation results to the master processing circuit.

In order to make full use of the schedulable slave processing circuits, corresponding computing tasks may be allocated among the slave processing circuits to improve parallel processing efficiency. Considering that in depthwise convolution operation scenarios such as Update1, computation results in the C dimension do not need to be accumulated, so the computations in different Cs are allocated to different computing circuits and may be performed relatively independently. It should be noted that in the Update1 splitting scheme, the C dimension will be aligned to 4 B. Therefore, when processing in units of splitting units, the C dimension will be aligned to 4 B (that is, Uc) before splitting. In other words, the processing on different computing circuits is split in units of Uc in the C dimension.

In the reverse depthwise convolution scenario, the C dimension is usually large, such as greater than 64, and bottom_data and top_diff are usually also large. In these embodiments, usually the size Nc of the channel C dimension of bottom_data and top_diff in a single round of computation may be a multiple of 64, so the computation of a single channel computed in units of Uc may be distributed to a single slave processing circuit to complete. Therefore, in some embodiments, the convolution splitting scheme also indicates a grouping splitting method for performing depthwise convolution operations, where the grouping splitting method may be used for bottom_data and top_diff data, and the data may be sequentially split into Ns schedulable slave processing circuits according to the channel C dimension and in units of Uc, and each slave processing circuit processes different bottom_data and top_diff data of consecutive Uc C values. In other words, a single slave processing circuit may be a group that processes computations of different Cs (in units of Uc), which corresponds to the Group 16 grouping mode mentioned above.

In this embodiment of grouping according to the C dimension, the top_diff may be split according to the convolution splitting scheme and converted in dimension before being stored in the first storage circuit. Since each slave processing circuit processes a different Uc, top_diff corresponding to different Uc C values may be unicast/transmitted separately to the scheduled Ns slave processing circuits via the broadcast bus during the computation.

In these embodiments, bottom_data may be determined as distribution data, and the distribution data after being split and converted in dimension storage order may be stored in storage areas corresponding to Ns slave processing circuits in the second storage circuit in a manner of being split sequentially according to the channel C dimension and in units of Uc, so as to be distributed to the corresponding slave processing circuits.

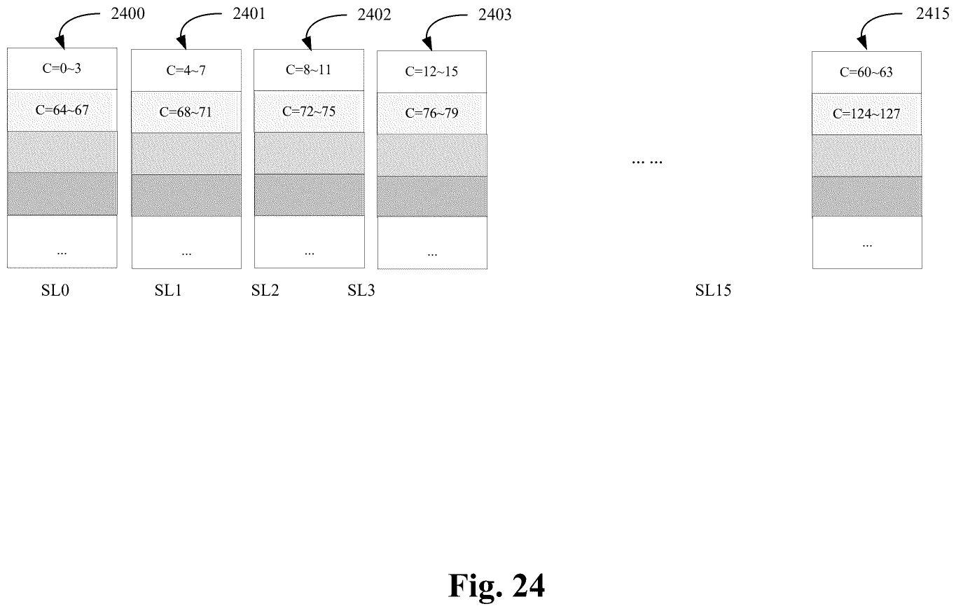

FIG. 24 shows a schematic diagram of storage of bottom_data in the second storage circuit according to some embodiments of the present disclosure.

As shown in the figure, the second storage circuit may allocate a storage area to each slave processing circuit, so that the bottom_data required for the computation of each slave processing circuit only needs to be read from its corresponding storage area. The figure exemplarily shows that 16 storage areas 2400-2415 are allocated to 16 slave processing circuits, and each storage area stores a bottom_data data block to be processed by a slave processing circuit.

As mentioned above, splitting is performed in units of Uc in the C dimension. In the example in the figure, assuming Uc=4 B and the data type is int8, one Uc includes 4 C values. When the size of the C dimension is greater than Uc times the number of schedulable slave processing circuits, a plurality of rounds of computations are required to perform the computation.

Taking the example in the figure as an example, assuming that a total of 16 slave processing circuits are schedulable, and further assuming that the C dimension size of the bottom_data is 128, which is more than Uc times the number of schedulable slave processing circuits (16*4=64), all computations may be completed in two rounds. The bottom_data may be split into 32 bottom_data data blocks according to the C dimension and in units of Uc. The first 16 data blocks are computed in the first round of computation, and the last 16 data blocks are computed in the second round of computation.

As shown in the figure, in the data of the first round of computation, the bottom_data data blocks including C=0, 1, 2, 3 are allocated to the first slave processing circuit; the bottom_data data blocks including C=4, 5, 6, 7 are allocated to the second slave processing circuit; and so on. In the data of the second round of computation, the bottom_data data block is similarly split and stored accordingly, which will not be repeated here.

Accordingly, the first caching circuit may cache a plurality of bottom_data data limes from the second storage circuit and distributed to the slave processing circuit; and the second caching circuit may cache a plurality of top_diff data lines from the first storage circuit and unicast to the slave processing circuit corresponding to Uc. Depending on a specific splitting and/or reuse method, these data lines may be distributed to the corresponding computing circuit CU or broadcast to all CUs within the slave processing circuit during the computation. Then, each computing circuit CU is configured to perform an element-wise multiply-accumulate operation on bottom_data data lines selected from the first caching circuit and top_diff data lines selected from the second caching circuit in each computation.

When a plurality of computing circuits CU in a single slave processing circuit SL jointly process a Uc, output points need to be split among the plurality of CUs. Similar to Forward4, it is also split in Update1 according to the method that each computing circuit allocates a spaced output point (for example, FIG. 10b). In Update1, the convolution kernel top_diff is split in units of 4×4, and the bottom_data only uses 2×2 64 Bs in the first caching circuit each time. Therefore, after a plurality of selection by sliding window computations on the first caching circuit, a maximum of 4×4 output points may be computed.

Specifically, in one embodiment, in each computation, each computing circuit computes an adjacent output point of the output ΔW on the XY plane of Uc channel C values in the X and/or Y dimensions; and in different computations, each computing circuit computes different output points on the output ΔW in the X and/or Y dimensions. Number of slides Nk=ceil(Kx/2)*ceil(Ky/2), where Kx is a smaller value of a size of the output ΔW in the X dimension or a maximum output size supported by the slave processing circuit in a single computation in the current convolution splitting mode, and Ky is a smaller value of a size of the output ΔW in the Y dimension or the maximum output size supported by the slave processing circuit in a single computation in the current convolution splitting mode. For example, for the case of Kx=Ky=4, Nk=2*2=4 times, it means sliding 4 times, 2×2 output points are computed each time, and a total of 4×4 output points are computed.

The single computation process in the scheme Update1 may be similar to that of Forward1, and reference may be made to the description in conjunction with FIG. 21, which will not be repeated here.

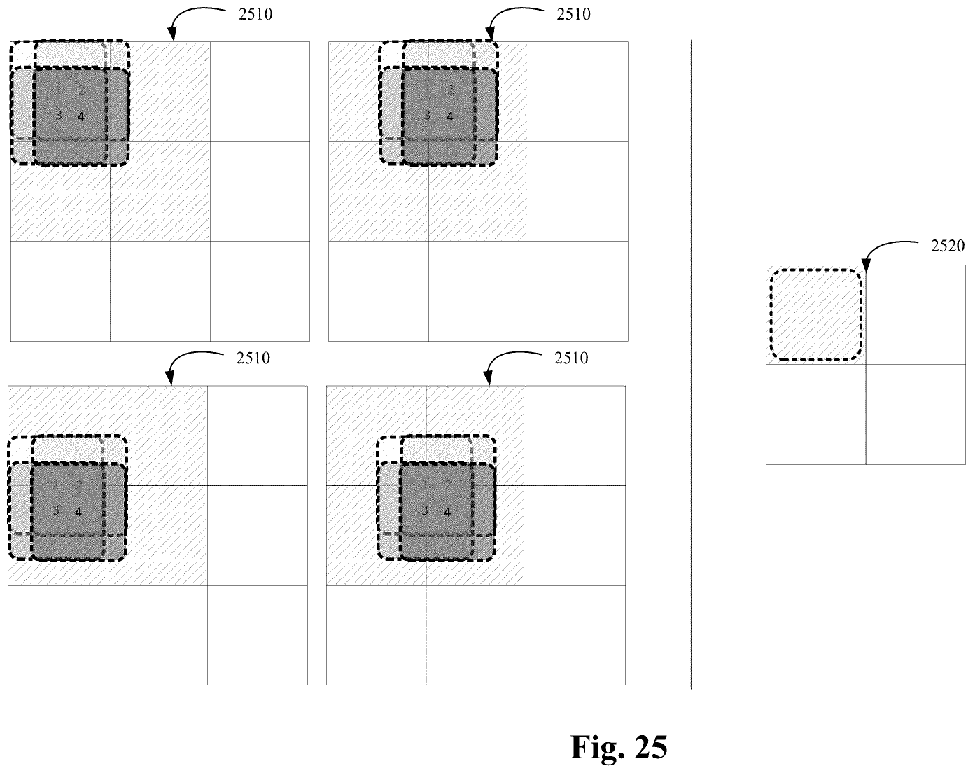

FIG. 25 shows a schematic diagram of a sliding convolution process in the Update1 scheme according to an embodiment of the present disclosure. In this example, the first caching circuit caches 2*2=4 bottom_data data lines, shown as 2510 in the figure, in which the C dimension is omitted; the second caching circuit caches 1 top_diff data line, shown as 2520 in the figure, in which the C dimension is also omitted. Each data line is a 4×4×4 (C×H×W) sized block. ΔW sizes in X and Y dimensions are Kx=Ky=4. During each computation, the second caching circuit selects top_diff with a 4×4 size, which just corresponds to a block with a 4×4 size of bottom_data and is broadcast to 4 computing circuits.

Specifically, in a method corresponding to the splitting method of the output points, using the splitting unit as a sliding window, N_{CU} bottom_data data lines are slidably selected from the first caching circuit and sent to N_{CU} computing circuits respectively in the slave processing circuit for computation. Further, 1 top_diff data line is read from the second caching circuit and broadcast to N_{CU} computing circuits in the slave processing circuit. Nk times of selection by sliding windows are performed on the first caching circuit, and Nk=ceil(Kx/2)*ceil(Ky/2), where Kx is a smaller value of a size of the weight gradient data ΔW in the X dimension or a maximum output size supported by the slave processing circuit in a single computation in the current convolution splitting mode, and Ky is a smaller value of a size of the weight gradient data ΔW in the Y dimension or the maximum output size supported by the slave processing circuit in a single computation in the current convolution splitting mode.

Selection ranges of the bottom_data and the top_diff in the first caching circuit and the second caching circuit at each slide are shown in FIG. 25, with a total of 4 graphs, representing a total of 4 slides. The block 2510 in the figure represents the bottom_data in the first caching circuit, and 4 dashed boxes represent the areas selected to be sent to 4 CUs. The block 2520 represents the top_diff in the second caching circuit, and a dashed box represents 1 top_diff weight line selected, which is broadcast to 4 CUs and does not require reselection during the sliding. The number of slides Nk is 4, and the sliding stride is 2. In the Update1 convolution operation mode, a maximum size of ΔW supported by the slave processing circuit in a single computation is 4×4. It may be understood that when the ΔW is greater than the maximum supported size, it needs to be split according to the maximum supported size in the X and Y directions.

During each computation, for a bottom_data data line from the first caching circuit and a top_diff data line from the second caching circuit, each CU performs an element-wise multiply-accumulate operation on the bottom_data data line and the top_diff data line corresponding to the same channel value in units of 1/Uc data line, and obtains Uc output points, that is, 1 output point of ΔW on each KxKy plane on Uc, so that N_{CU} computing circuits obtain N_{CU} output points on Uc KxKy planes each time. It may be understood that after sliding through Nk cycles of computations, each computing circuit computes and obtains Nk output points spaced apart in the X and/or Y dimensions on Uc KxKy planes. Nk slides of N_{CU} computing circuits may obtain Nk*N_{CU} output points in total on Uc KxKy planes. These output points are spliced to form a maximum of 4×4 (Kx*Ky) output points on Uc planes in the C dimension, that is, Uc×4×4.

Specifically, for each graph in FIG. 25, the number Ncu of CUs is 4, each CU computes 1 output point on Uc planes in the C dimension at a time, and this partial sum is an element-wise multiply-accumulate result of 1/Uc (¼) data lines, which means that each output point is a 4×4 (Y×X) 2D convolution. After sliding Nk=4 times, the computation of a maximum output point is completed, and an output of 4×4 (Y×X) is obtained in 1 SL (as shown in FIG. 10b).

It may be understood that when the Kx/Ky computed by each CU is greater than 4, it is necessary to slide along the Kx/Ky direction to read different bottom_data and top_diff. Those skilled in the art may similarly deduce the computation process based on the above description, which will not be described here.

As may be seen from the previous sliding convolution process, an output result in the sliding mode is not in a normal order of traditional convolution output data. Therefore, during the output process, each slave processing circuit SL may convert a computation result of its internal computing circuit CU into a specified format. In some embodiments, each slave processing circuit may output 1 output point at the same position on Uc XY planes computed by one of its internal computing circuits at a time. Ns slave processing circuits simultaneously output 1 output point at the same position on Ns*Uc XY planes each time. Through this output method, the Ns*Uc output points are continuous in the C dimension. The blocking circuit may further store computation results returned from the slave processing circuits in a fourth dimension storage order, for example, splicing and storing in a Ky*Kx*(Ns*Uc) dimension order. Depending on situations, the blocking circuit may also store the computation results in a desired dimension storage order.

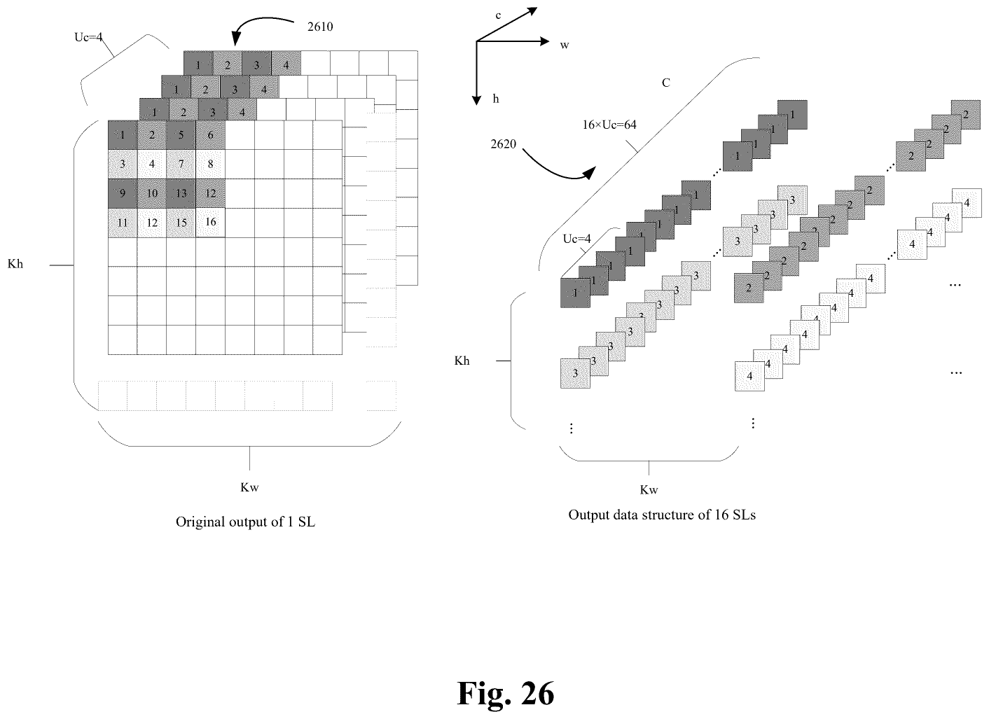

FIG. 26 shows a schematic output data format diagram of in the Update1 scheme according to an embodiment of the present disclosure. In this embodiment, the grouping is split according to the C dimension, which means that each slave processing circuit SL processes computations of different Ucs.

The 2610 in the figure shows an original output of 1 SL. As may be seen from the figure, each SL outputs an area of Uc×1×1 (C×Y×X) each time, and in other words, the SL outputs Uc computation results of a computing circuit in the SL each time, for example, 4 computation results of CU0. These 4 computation results are continuous in the C dimension of the output data. Since different SLs process computations on different Ucs, each of 16 SLs may simultaneously output 1 output point at the same position on the XY plane on different Ucs, and the output points may be spliced into 16*Uc output points in the C dimension, which are continuous in the C dimension.

The 2620 in the figure shows the output data structure of 16 SLs. As shown in the figure, outputs of 16 SLs are spliced into a line of data continuous in the C dimension each time. For example, for the first time, 16 SLs all output points at the position of Ky=0, Kx=0 (marked “1”); for the second time, 16 SLs all output points at the position of Ky=0, Kx=1 (marked “2”), and so on. Final output data becomes the format of Kh*Kw*(16*Uc) after being written into a storage circuit (such as the first storage circuit), where 16 is the splitting on 16 SLs. As required, in some implementations, a data arrangement operation may be performed again to convert the data into other desired data formats.

In some embodiments, considering storage space of an internal register of the computing circuit, for example, a single slave processing circuit including four computing circuits computing up to 16 4×4 output point areas, the bottom_data may be reused, thereby reducing a reading frequency of the second storage circuit. In other words, the reading frequency of the first storage circuit may be different from the reading frequency of the second storage circuit. If the result computed by the computing circuit is a partial sum, it is stored in the internal register.

In these embodiments, the slave processing circuit may be further used to: determine the number of times rn that the bottom_data within the slave processing circuit is reused based on the storage space limitation within the computing circuit; and control a loading frequency of the top_diff in the second caching circuit, so that the bottom_data loaded each time in the first caching circuit is reused rn times and is convolved with the corresponding top_diff data loaded rn times in the second caching circuit. In some examples, rn may take a value not greater than 16.

### Embodiment 5: Update4

In Update4, the shape of the splitting unit is the same as that in Update1, which is also 4 B×4×4; and the difference is that Update4 is applied to a cross product convolution operation in reverse training of the neural network model, specifically for a weight update process in the reverse training of the depthwise convolution operation, while Update1 is applied to a reverse depthwise convolution operation. The principle of the reverse cross product convolution operation may be referred to the previous description in conjunction with FIG. 4c. Due to the characteristics of the reverse cross product convolution operation, a different optimization operation scheme is required.

In the following description, although top_diff and bottom_data will be used to refer to data to be computed, the previous description of the convolution kernel may be applied similarly to top_diff, and the description of the input feature map may be applied similarly to bottom_data, which means that both may be used interchangeably. The following description may be applied to a convolution splitting scheme similar to Update4.

The shape of splitting units indicated by these convolution splitting schemes also satisfies: Uc×Uy×Ux=M, where Uc is the size of the splitting unit in an initial lowest storage dimension (e.g., for bottom_data, the initial lowest storage dimension is a Ci dimension, and for top_diff, the initial lowest storage dimension is a Co dimension) of the bottom_data and the top_diff, Ux and Uy are the sizes of the splitting unit in initial X and Y storage dimensions of the bottom_data and the top_diff, respectively, and M is a maximum computation amount of hardware at a time. In these convolution splitting schemes, Ux=Uy≥Uc>1, Uc=M/4ⁿ, n=1, 2, . . . ½ log₂ M−1. For an example of splitting and storing data in the Update4 scheme, reference may be made to the description of Forward4 in Example 2, for example, reference may be made to FIG. 16, and the same parts will not be repeated.

Specifically, for bottom_data, the data needs to be arranged from [Hi Wi C] to:
[Hi/4*Wi/4*Ci/4*(4×4×4)], which is the shape of this six-dimensional tensor, omitting the N dimension.

For top_diff, the data needs to be arranged from [Ho Wo C] to:
[Ho/4*Wo/4*Co/4*(4×4×4)], which is the shape of this six-dimensional tensor, omitting the N dimension.

When the computing device shown in FIG. 5 is used to execute the Update4 convolution splitting scheme, bottom_data and top_diff may be split into a plurality of corresponding splitting units according to the Update4 convolution splitting scheme by a blocking circuit integrated in the master processing circuit or a blocking circuit that is completely or partially independent of the master processing circuit. The blocking circuit may also convert the dimension storage order of bottom_data and top_diff, so that the data in each splitting unit is stored continuously as a data line. The split and converted bottom_data and/or top_diff may be provided to a master processing circuit or a slave processing circuit. Then, the master processing circuit may distribute the data it obtains to a plurality of slave processing circuits for performing convolution operations; and according to the convolution splitting scheme, computation results returned by the plurality of slave processing circuits scheduled are spliced to obtain the output ΔW (or referred to as weight_diff) of the depthwise convolution operation of bottom_data and top_diff. A plurality of slave processing circuits may perform convolution operations based on the data they obtain and return the computation results to the master processing circuit.

From the cross convolution operation principle applied by Update4 described in the previous text in conjunction with FIG. 4c, it may be seen that the output ΔW (weight gradient) includes four dimensions [Co Kh Kw Ci], where the computation results on the Co dimension are relatively independent. Therefore, the computations in different Cos are allocated to different computing circuits and may be performed relatively independently. It should be noted that in the Update4 splitting scheme, the C dimension will be aligned to 4 B. Therefore, when processing in units of splitting units, the C dimension will be aligned to 4 B (that is, Uc) before splitting. In other words, the processing on different computing circuits is split in units of Uc in the Co dimension.

Therefore, in some embodiments, the number of rounds of computations required to complete the cross product convolution operation, the number Nco of output channels Co processed in each round of computation, and the corresponding grouping mode may be first determined based on an output channel Co dimension size and the number Ns of schedulable slave processing circuits, where Nco is aligned to Uc.

In some embodiments, different grouping modes may be used to perform convolution operations according to different value ranges of Co. In one implementation, when Co is small, for example, between 1 and 4, the Group1 mode may be adopted, and in other words, all slave processing circuits SLs belong to one group and jointly process computations of the same Co (i.e., one Uc). In another implementation, when Co is large, for example, between 4 and 16, the Group4 mode may be adopted, and in other words, all SLs are split into 4 groups, and each group process computations of one Co (i.e., one Uc). In another implementation, when Co is very large, for example, exceeding 16, the Group 16 mode may be adopted, and in other words, each SL belongs to one group and processes computations of different Cos (i.e., different Ucs). Although the above embodiments describe grouping modes suitable for different Co ranges, it is possible to select according to other rules. For example, when Co=16, the Group1 mode may also be used to complete the required processing through a plurality of rounds of computations. It may be seen that splitting methods between different groups (for example, Group1, Group4, and Group16) are determined according to Co. The above grouping mode may be summarized as GroupN, which means that the Ns slave processing circuits scheduled in the current round of computation are split into N groups, each slave processing circuit group processes the same consecutive Uc Co values, and different slave processing circuit groups process different consecutive Uc Co values, where N=4n, n=0, 1, 2 . . . .

Furthermore, within each group, computing tasks may also be allocated to a corresponding number of slave processing circuits, for example, according to the Ci dimension. For the GroupN mode, assuming that each group has Rs slave processing circuits, where Rs=Ns/N, it is necessary to allocate computing tasks to the Rs slave processing circuits in each slave processing circuit group SLB, and the allocation method within each group is the same.

When the splitting method within the group is based on the Ci dimension, the bottom_data data may be split sequentially to Rs slave processing circuits in the same group in units of Uc according to the input channel Ci direction. No additional processing of the top_diff data is required. At this time, the top_diff data may be determined as multicast data, and the multicast data after being split and converted in dimension storage order may be stored in the first storage circuit, so that during the computation, the top_diff data corresponding to different Uc Co values may be transmitted to the scheduled N slave processing circuit groups through the broadcast bus, and each slave processing circuit group shares the same neuron gradient data of Uc Co values. Furthermore, the bottom_data data may be determined as distribution data, and the distribution data after being split and converted in its dimension storage order may be copied N times, each of which is split into Rs data blocks according to the grouping splitting method in the Ci direction, and stored in corresponding storage areas in the second storage circuit respectively, so as to be distributed to corresponding slave processing circuits.

The following is a detailed description of the splitting of different grouping modes.

In the Group1 mode, that is, when all slave processing circuits SLs jointly process the same Co, top_diff may be directly split by splitting units and stored in the first storage circuit; then in addition to splitting by splitting units, bottom_data is also split into Ns data blocks according to the Ci dimension and in units of Uc and stored in the second storage circuit to be distributed to Ns slave processing circuits.

In such an embodiment that splitting is performed according to the Ci dimension, since each slave processing circuit processes different Cis, the top_diff of the same Co (in units of Uc) may be broadcasted to corresponding slave processing circuits. Further, the master processing circuit may determine the bottom_data as distribution data, and the distribution data after being split and converted in its dimension storage order may be stored in the second storage circuit for distribution to the corresponding slave processing circuits.

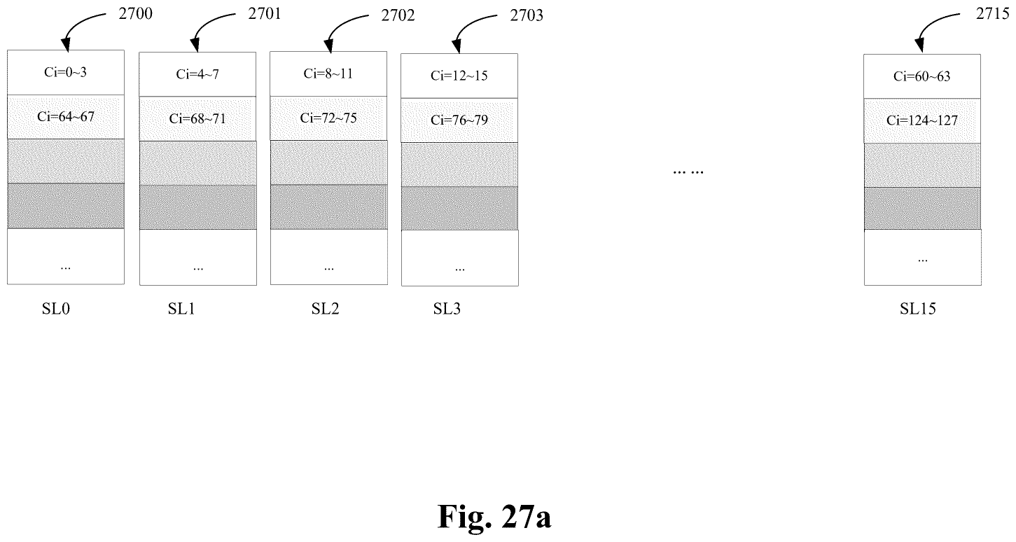

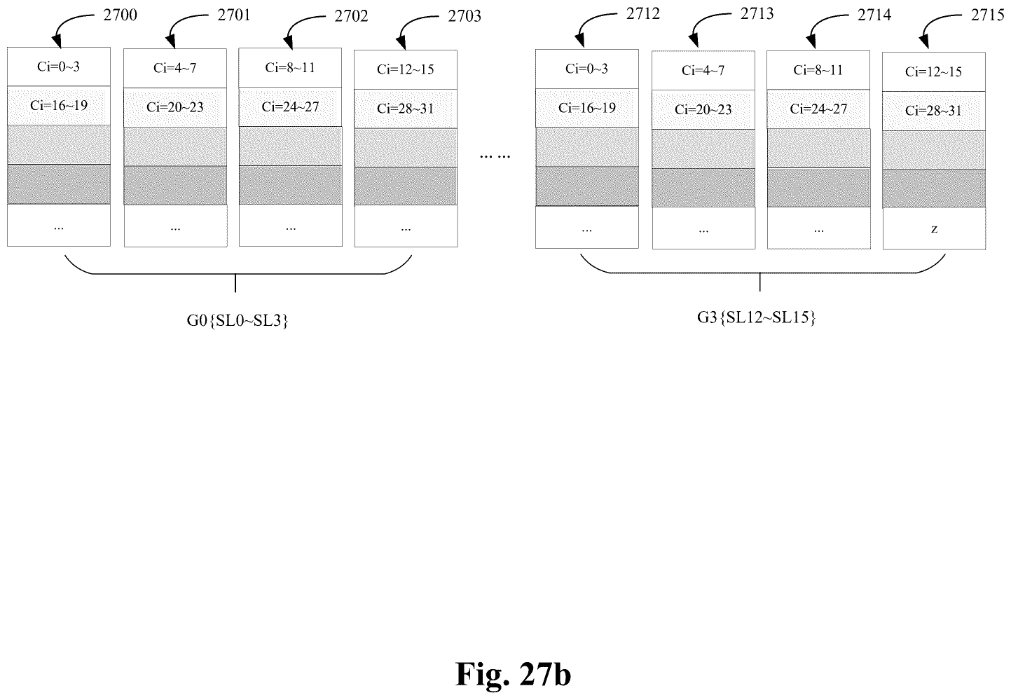

FIG. 27a shows exemplary storage contents in a second storage circuit in the Group1 mode in the Update4 scheme according to some embodiment of the present disclosure.

As shown in the figure, the bottom_data is stored in the second storage circuit, which includes 16 storage areas 2700˜2715, which are respectively allocated to 16 slave processing circuits SL0˜SL15. Each storage area stores bottom_data data blocks corresponding to different C (ie, Ci) dimensions. Specifically, the bottom_data data blocks are sequentially allocated to 16 storage areas at intervals of 1 Uc according to the C dimension. For example, Ci=0˜3 is allocated to SL0, Ci=4˜7 is allocated to SL1, and so on, until Ci=60˜63 is allocated to SL15; and then the allocation starts from SL0 again.

In the Group 4 mode, every Rs=Ns/4 slave processing circuits form a slave processing circuit group SLB, which jointly process the same Co. When the groups are split according to the Ci dimension, top_diff may also be directly split by the splitting units and then stored in the first storage circuit. Since each SLB handles different Cos, top_diff of different Cos may be unicast to the corresponding SLB, and the SLs in the SLB share the same Co. In other words, the top_diff of the same Co will be multicast to a plurality of SLs within an SLB.

In these embodiments, each SLB processes the same bottom_data data, and among the Rs SLs within the SLB, the bottom_data data is split into Rs=Ns/4 parts according to the Ci dimension and stored in corresponding storage areas in the second storage circuit so as to be distributed to corresponding slave processing circuits.

FIG. 27b shows exemplary storage contents in a second storage circuit when splitting according to the C dimension in the Group4 mode in the Update4 scheme according to some embodiment of the present disclosure.

As shown in the figure, the second storage circuit also includes 16 storage areas 2700˜2715, which are respectively allocated to 16 slave processing circuits SL0˜SL15. In the Group4 mode, these 16 storage areas are also split into 4 groups according to the corresponding SLBs. Each group stores the same and complete bottom_data, which means that 4 copies of bottom_data are stored in the storage areas corresponding to the 4 SLBs.

Specifically, each SLB processes the same bottom_data and the top_diff of different Cos; and the four SLs in each SLB respectively process bottom_data data blocks split simultaneously. The bottom_data data blocks are split according to the Ci dimension, and specifically, allocated to corresponding storage areas of 4 SLs in 1 SLB in sequence at intervals of 1 Uc according to the Ci dimension. Therefore, the storage contents of the storage areas used for the 4 SLBs in the figure are the same; for example, the contents of 2700˜2703 are the same as those of 2712˜2715. Furthermore, in each SLB, storage areas for different SLs store different split bottom_data data blocks; for example, 2700 stores bottom_data data block BD0 of Ci=0˜3, 2701 stores bottom_data data block BD1 of Ci=4˜7, and so on. The same storage allocation is also performed in the storage area of other SLBs, which will not be described in detail.

In the Group16 mode, that is, each slave processing circuit processes a different Co, similar to the Update1 scheme mentioned above, the 16 SLs may be split according to the Ci dimension. For this part, reference may be made to the description of the Update1 scheme above and will not be repeated here.

Accordingly, the first caching circuit may cache a plurality of bottom_data data limes from the second storage circuit and distributed to the slave processing circuit; and the second caching circuit may cache a plurality of top_diff data lines from the first storage circuit, and unicast, multicast or broadcast to corresponding Cos (in units of Uc) of the slave processing circuit. Depending on the splitting and/or reuse method, these data lines may be distributed to corresponding computing circuits CUs or broadcast to all computing circuits CUs within the slave processing circuit during the computation. Then, each computing circuit CU is configured to perform an element-wise multiply-accumulate operation on bottom_data data lines selected from the first caching circuit and top_diff data lines selected from the second caching circuit in each computation.

When a plurality of computing circuits CUs in a single slave processing circuit SL process a single Co in units of Uc together, it is necessary to split output points among the plurality of CUs. Due to the characteristics of the cross product convolution operation used by the Update4 scheme, the output points between CUs may be split according to an output channel Co dimension. For example, in the Update4, the top_diff is split in units of 4×4, and the bottom_data data only uses 2×2 64 Bs in the first caching circuit each time. Therefore, after a plurality of selection by sliding window computations on the first caching circuit, a maximum of 4×4×4×4 (Co×Ky×Kx×Ci) output points may be computed.

Specifically, in one embodiment, during each computation, each computing circuit computes an output point of the output ΔW at the same position in the X and Y dimensions on different Cos, on a Ci in units of Uc (that is, on consecutive Uc Ci values). In different computations, each computing circuit computes different output points of the output ΔW in the X and Y dimensions. Number of slides Nk=Kx*Ky, where Kx is a smaller value of a size of the output ΔW in the X dimension or a maximum output size supported by the slave processing circuit in a single computation in the current convolution splitting mode, and Ky is a smaller value of a size of the output ΔW in the Y dimension or the maximum output size supported by the slave processing circuit in a single computation in the current convolution splitting mode. For example, for the case of Kx=Ky=4, Nk=4*4=16 times, it means sliding 16 times, 4×1×1×4 (Co×Ky×Kx×Ci) output points are computed each time, and a total of 4×4×4×4 (Co×Ky×Kx×Ci) output points are computed in the 16 slides.

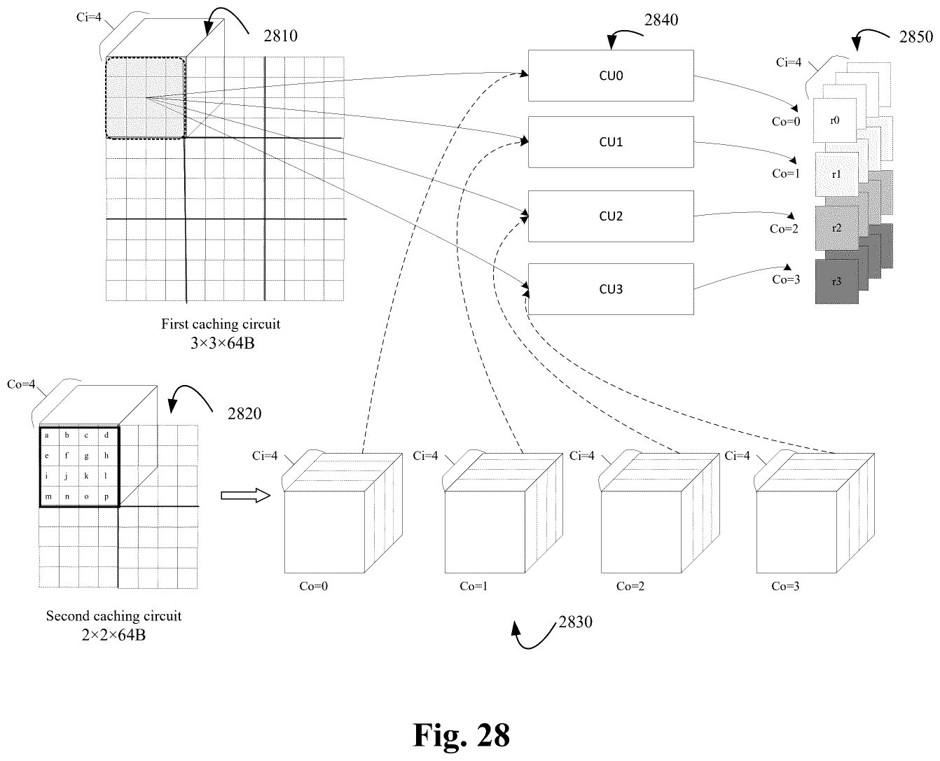

FIG. 28 shows a schematic diagram of a single computation process in the Update4 scheme according to an embodiment of the present disclosure. In this example, a first caching circuit 2810 has a size of 3×3×64 B, which means that the first caching circuit 2810 may cache up to 9 lines of data, and a second caching circuit 2820 has a size of 2×2×64 B, which means that the second caching circuit 2820 may cache up to 4 lines of data. To be consistent with the splitting units, the storage within the caching circuit in the figure is also shown in units of the splitting units.

A computation process of a first selection by sliding window is shown in the figure. According to a method corresponding to the splitting method of the output points, 1 bottom_data data line is slidably selected from the first caching circuit by taking a splitting unit as a sliding window, and broadcast to N_{CU} computing circuits in the slave processing circuit for computation; 1 top_diff data line is read from the second caching circuit, Co (one Uc) is split into Uc Cos, and Uc copies of an XY data plane of each Co are made and sent to Uc computing circuits in the slave processing circuit respectively. In the example in the figure, N_{CU}=4, and the data type is Int8, thus Uc=4.

As shown in the figure, a bottom_data data line is selected from the first caching circuit 2810 at the starting position and broadcast to 4 computing circuits 2840 in the slave processing circuit SL. One top_diff data line is selected from the second caching circuit 2820 at the starting position, which is data 2830 with the size of 4×4×4, and the selected top_diff data line is split into 4 data planes of 1×4×4 in the Co dimension, and each data plane is replicated 4 times to be extended into a data line of 4×4×4 (Ho×Wo×Ci) and broadcast to 4 computing circuits 2840 in the SL respectively.

During each computation, each computing circuit 2840 performs an element-wise multiply-accumulate operation on the bottom_data data and top_diff data corresponding to the same input channel Ci value in units of 1/Uc=¼ data lines for one bottom_data data line from the first caching circuit and one extended top_diff data line from the second caching circuit, and obtains Uc output points of the allocated Co value in the Ci dimension.

As shown in the figure, four computing circuits 2840 perform element-wise multiply-accumulate operations on the broadcast bottom_data data lines and the distributed top_diff extended data lines according to ¼ line to obtain a computation result 2850. In 2850, results of different background colors are obtained by different computing circuits 2840. As may be seen, in each computation, a CU computes one output point on each KxKy plane on Uc (Ci dimension) of an allocated Co, and 4 CUs obtain 1×1×Uc output points of 4 Cos in total. It may be seen that the output points computed by the 4 CUs correspond to the same position in the KxKy dimension of different Cos.

Then, the selection by sliding window is performed in the first caching circuit, no slide is performed in the second caching circuit, and this line of top_diff data is still used for a next computation. Nk times of selection by sliding window are performed in the first caching circuit, where Nk=Kx*Ky, where Kx is a smaller value of a size of the ΔW in the X dimension or a maximum output size supported by the slave processing circuit in a single computation in the current convolution splitting mode, and Ky is a smaller value of a size of the ΔW in the Y dimension or the maximum output size supported by the slave processing circuit in a single computation in the current convolution splitting mode. Accordingly, each computing circuit computes Nk*Uc output points during Nk times of sliding computation, which are Nk output points continuous in the X and/or Y dimensions on an XY plane on a single Co and Uc Cis. The four computing circuits may obtain a total of Nk computation results on the XY plane on 4 Cos and Uc Cis.

In some embodiments, in the Update4 mode, the maximum output size supported by the slave processing circuit in a single computation is 4×4.

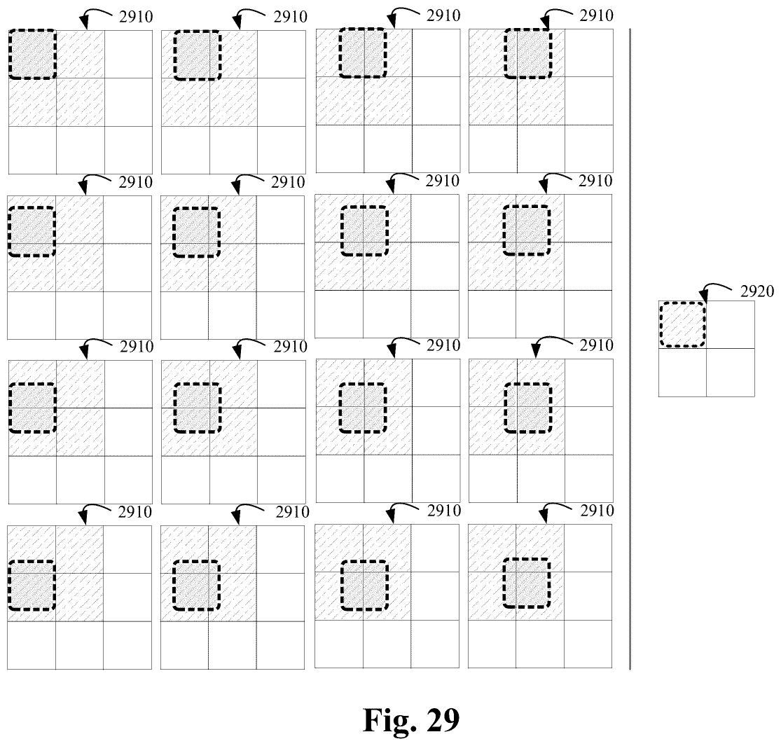

FIG. 29 shows a schematic diagram of a sliding convolution process in the Update4 scheme according to an embodiment of the present disclosure. In this example, the first caching circuit caches 2*2=4 bottom_data data lines, shown as 2910 in the figure, in which the C dimension is omitted; the second caching circuit caches 1 top_diff data line, shown as 2920 in the figure, in which the C dimension is also omitted. Each data line is a 4×4×4 (C×H×W) sized block. The sizes of ΔW in the X and Y dimensions are Kx=Ky=4. During each computation, a 4×4 sized top_diff is selected from the second caching circuit, split and copied according to C to be extended into 4 data lines, and distributed to 4 computing circuits.

Selection ranges of the bottom_data and the top_diff in the first caching circuit and the second caching circuit at each slide are shown in FIG. 29, with a total of 16 graphs, representing a total of 16 slides. The block 2910 in the figure represents the bottom_data in the first caching circuit, and dashed boxes represent the areas broadcast to 4 CUs. The block 2920 represents the top_diff in the second caching circuit, and the dashed box represents 1 top_diff data line selected, which is copied, extended, and distributed to 4 CUs and does not require reselection during the sliding. The number of slides Nk is 16, and the sliding stride is 1. In the Update4 convolution operation mode, a maximum size of ΔW supported by the slave processing circuit in a single computation is 4×4. It may be understood that when the ΔW is greater than the maximum supported size, it needs to be split according to the maximum supported size in the X and Y directions.

During each computation, each CU performs an element-wise multiply-accumulate operation on an bottom_data data line from the first caching circuit and a top_diff extended data line from the second caching circuit according to 1/Uc line, and obtains 1 output point of ΔW on each KxKy plane on one Co and Uc Cis, so that N_{CU} computing circuits obtain 1 output point on N_{CU} Cos and Uc KxKy planes each time. It may be understood that after sliding through Nk cycles of computations, Kx*Ky output points on N_{CU} Cos and Uc KxKy planes may be obtained. By splicing the Kx*Ky output points, a maximum of 4×4 (Kx*Ky) output points on N_{CU} Cos and Uc planes may be obtained, that is, Ky×Kx×N_{CU}×Uc (Ky×Kx×Co×Ci).

Specifically, for each graph in FIG. 29, the number Ncu of CUs is 4, each CU computes 1 output point on Uc planes on one Co in the Ci dimension at a time, and this output point is an element-wise multiply-accumulate result of 1/Uc (¼) data lines, which means that each output point is 4×4 (Y×X) 2D convolution. After sliding Nk=16 times, the computation of a maximum output point is completed, and an output of 4×4×4×4 (Y×X×Co×Ci) is obtained in 1 SL.

It may be understood that when the Kx/Ky computed by each CU is greater than 4, it is necessary to slide along the Kx/Ky direction to read different bottom_data and top_diff. Those skilled in the art may similarly derive the computation process according to the above description, which is not described here.

The above describes the computation process within a single slave processing circuit SL. When the data type is Int16 or Float16, Uc=2. At this time, only 2 Cos are allocated to each slave processing circuit, and all the computing circuits CUs may not be used. In this case, the data may be read one more time to read in the top_diff data lines of the next two Cos, so that one Co may still be computed by each CU. When the data type is Float32, Uc=1, that is, the data is split according to Co=1 piece of data in the C dimension. In this case, in some embodiments, only one Co is computed each time. Each CU may only compute one Co per beat, and the computation is performed continuously for four beats, so that all four Cos are computed. For example, CU0 may compute data with Co=0 in the first beat, CU1 may compute data with Co=1 in the second beat, and so on. In some other embodiments, the data may be read three more times to read in the top_diff data lines of the next three Cos, so that one Co may still be computed by each CU. In other words, when Uc<N_{CU}, N_{CU}/Uc top_diff data lines may be read from the second caching circuit and split into N_{CU} Co values according to the Co dimension. The XY data plane corresponding to each Co value is copied Uc times and sent to N_{CU} computing circuits in the slave processing circuit respectively.

As may be seen from the previous sliding convolution process, an order of an output result in a sliding mode is not a normal arrangement order of output data of traditional convolution. Therefore, during the output process, each slave processing circuit SL may convert a computation result of its internal computing circuit CU into a specified format. In some embodiments, each slave processing circuit may output 1 computation result of a computing circuit therein each time, and these computation results are an output point of the output data at the same position on the XY plane on one Co and Uc Cis. In other words, these Uc output points are continuous in the Ci dimension. Rs slave processing circuits in the same SLB output 1 output point at the same position on the XY plane of Rs*Uc Cis of the same Co at the same time each time. Through this output method, the Rs*Uc output points are continuous in the Ci dimension. The blocking circuit may further store the computation results returned from each slave processing circuit in a fourth dimension storage order, for example, splicing and storing the computation results in a Ky*Kx*Co/N*N*(Rs*Uc) dimension order, where N represents GroupN, which is the number of groups. Depending on situations, the blocking circuit may also store the computation results in a desired dimension storage order.

When the grouping mode (for example, Group1, Group4, and Group16) is different, the output data format is slightly different.

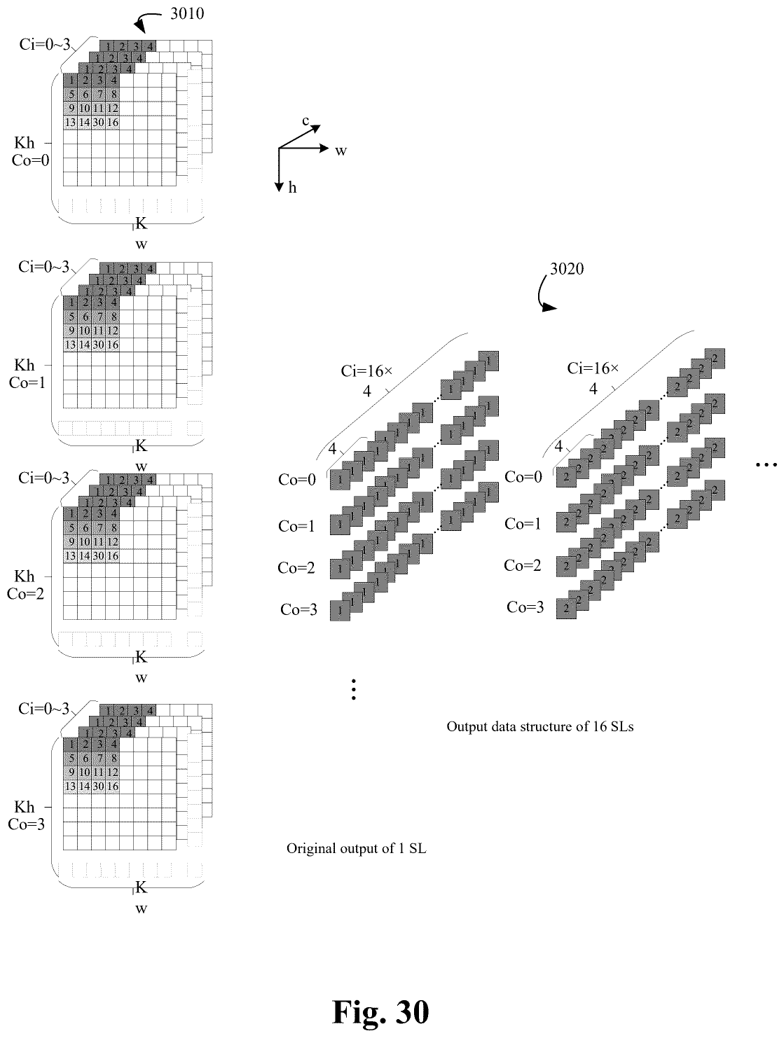

FIG. 30 shows a schematic output data format diagram in the Update4 scheme according to an embodiment of the present disclosure. In this embodiment, the Group1 mode is adopted, and the groups are split according to the Ci dimension, which means that each slave processing circuit SL processes the output data of the same Co (in units of Uc) and different Cis (in units of Uc).

In the figure, 3010 shows an original output of 1 SL. As may be seen from the figure, each SL outputs an area of 1×Uc×1×1 (Co×Ci×Y×X) each time, which means that it outputs the computation result of a computing circuit therein each time. For example, CU0 computes an output point of Kx=Ky=0 in the 4 XY planes on Co=0 and Ci=0˜3. These four output points are continuous in the Ci dimension of the output data and correspond to the same position in the X and Y dimensions. Since 16 SLs process computations of the same Co and different Cis (all in units of Uc), these 16 SLs may simultaneously output one output point at the same position on the XY plane of the same Co and different Cis, which may be spliced into 16*Uc output points in the Ci dimension, which are continuous in the Ci dimension.

In the figure, 3020 shows an output data structure of 16 SLs. As shown in the figure, outputs of 16 SLs are spliced into a line of continuous data in the Ci dimension each time. For example, after the first sliding computation cycle, the 16 SLs may first output computation results of CU0 therein, which is an output point at the position Co=0, Ky=0, Kx=0 (marked “1”); then the 16 SLs output computation results of CU1 therein, which is an output point at the position Co=1, Ky=0, Kx=0 (marked “1”), until the computation result of CU3 is output. After the second sliding computation cycle, the 16 SLs may sequentially output the output points corresponding to the Ky=0, Kx=1 position (marked “2”), and so on. Finally, output data becomes the format of Kh*Kw*Co*(16*Uc) after being written into a storage circuit (such as the first storage circuit), where 16 is the splitting on 16 SLs. Depending on the need, in some implementations, a data arrangement operation may be performed again to convert data to other desired data formats.

As mentioned above, when splitting methods of the grouping mode are different, the output data format is slightly different, which may be expressed as Ky*Kx*Co/N*N*(Rs*Uc), where N is the number of groups in GroupN.

Since Update4 is based on a 4 B*4*4 block as a computing unit, there are inevitably alignment limitations during computation. Depending on the different grouping modes (such as Group1, Group4, and Group16, etc.), the final alignment limitations during computation are also different. Those skilled in the art may deduce the alignment limitations for each piece of data according to different data types and different grouping modes, which will not be described in detail here.

In some embodiments, considering storage space of an internal register of the computing circuit, for example, a single slave processing circuit including four computing circuits computing up to 16 4×4 output point areas, the bottom_data may be reused, thereby reducing a reading frequency of the second storage circuit. In other words, the reading frequencies of the first storage circuit and the second storage circuit may be different. If the result computed by the computing circuit is a partial sum, it is stored in the internal register.

In these embodiments, the slave processing circuit may be further used to: determine the number of times rn that the bottom_data within the slave processing circuit is reused based on the storage space limitation within the computing circuit; and control a loading frequency of the top_diff data in the second caching circuit, so that the bottom_data data loaded each time in the first caching circuit is reused rn times and is convolved with the corresponding top_diff data loaded rn times in the second caching circuit. In some examples, rn may take a value not greater than 16.

The above exemplary description and explanation of the convolution optimization scheme provided by the embodiments of the present disclosure are made in combination with the specific convolution splitting schemes including Forward16, Forward4, Forward1, Update1 and Update4 Based on the teachings of this disclosure, those skilled in the art may conceive of other convolution splitting schemes according to the specific hardware circuit configuration (such as the number of slave processing circuits, the number of computing circuits within the slave processing circuit, the single processing capability of the hardware, etc.), which all fall within the scope of this disclosure and are not listed one by one here.

The disclosed embodiment also provides a method for performing convolution operations using the aforementioned computing device. It may be understood by those skilled in the art that steps described in the method for performing the convolution operation correspond to the various circuits of the computing device described above in conjunction with the accompanying drawings, and therefore the features described above are also applicable to the method steps and will not be repeated here.

The present disclosure also provides a chip, including the computing apparatus of any embodiment described above with reference to the drawings. Further, the present disclosure also provides a board card, including the above chip.

According to different application scenarios, an electronic device or apparatus of the present disclosure may include a server, a cloud server, a server cluster, a data processing apparatus, a robot, a computer, a printer, a smayner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic smayner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the scheme of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the scheme of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain scheme or some schemes of the present disclosure. Additionally, according to different schemes, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented in other ways that are not disclosed in the present disclosure. For example, for units in the aforementioned electronic device or apparatus embodiment, the present disclosure splits the units on the basis of considering logical functions, but there may be other splitting methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the direct or indirect coupling relates to a communication connection using an interface, where the communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the scheme described in the embodiments of the present disclosure. Additionally, in some scenarios, the plurality of units in the embodiments of the present disclosure may be integrated into one unit, or each of the units may be physically separated.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a CPU, a GPU, an FPGA, a DSP, and an ASIC, and the like. Furthermore, the aforementioned storage unit or storage device may be any appropriate storage medium (including magnetic storage medium or magneto-optical storage medium, etc.), which may be, for example, a resistive random access memory (RRAM), a dynamic random access memory (DRAM), a static random access memory (SRAM), an enhanced dynamic random access memory (EDRAM), a high bandwidth memory (HBM), a hybrid memory cube (HMC), an ROM and an RAM, etc.

The foregoing may be better understood according to the following articles:

Article A1. A computing device configured to perform a convolution operation, where the computing device includes:
a master processing circuit configured to obtain an input feature map and/or a convolution kernel, where the input feature map and the convolution kernel are split into a plurality of splitting units according to a convolution splitting scheme, and dimension storage orders of the input feature map and the convolution kernel are converted, where the convolution splitting scheme is determined based on a size of a lowest storage dimension of the input feature map before splitting, the convolution splitting scheme indicates a shape of a splitting unit, the amount of data contained in one splitting unit is less than or equal to a maximum computation amount of hardware at a time, and data in one splitting unit is continuously stored in one data line; and
a plurality of slave processing circuits configured to perform convolution operations on corresponding splitting units of the input feature map and the convolution kernel.

Article A2. The computing device of Article A1, where the convolution splitting scheme is determined as follows:
aligning a lowest storage dimension Ci of the input feature map before splitting to a multiple of the nearest M/4ⁿ, where M is the maximum computation amount of hardware at a time, n=0, 1, . . . ½ log₂ M−1, and a size Uci of the splitting unit in the lowest storage dimension is determined as M/4ⁿ;
taking a maximum value of M/4ⁿ or the M/4ⁿ with a smallest alignment padding amount as the Uci if there are a plurality of multiples of the nearest M/4ⁿ; and
determining a size Ux in an X storage dimension and a size Uy in a Y storage dimension of the splitting unit, such that Uci×Ux×Uy=M, where Ux=Uy.

Article A3. The computing device of Article A1, including a blocking circuit configured to perform splitting and storage for the input feature map and the convolution kernel respectively as follows:
reading one or more splitting units according to a first read order in units of the splitting units from to-be-computed data stored in a first dimension storage order, and storing the read splitting units on corresponding storage circuits, where data in each splitting unit is stored according to a second dimension storage order, and data between the splitting units is stored according to a third dimension storage order.

Article A4. The computing device of Article A3, where
the first dimension storage order is HWC from high to low;
the second dimension storage order is CHW from high to low;
the first read order is HWC from high to low; and
the third dimension storage order is the same as the first dimension storage order, where
H is a height dimension, W is a width dimension, and C is a channel dimension.

Article A5. The computing device of any one of Articles A1 to A4, where the master processing circuit is further configured to:
determine the number of rounds of computations required to complete the convolution operation and the number of Cos processed in each round of computation or a corresponding grouping mode based on the size of an output channel Co dimension of the convolution kernel and the number Ns of schedulable slave processing circuits.

Article A6. The computing device of Article A5, where the grouping mode is GroupN, indicating that all slave processing circuits scheduled in a current round of computation are split into N slave processing circuit groups, each slave processing circuit group processes a same Co value, and different slave processing circuit groups process different Co values, where N=4ⁿ, and n=0, 1, 2 . . . .

Article A7. The computing device of Article A6, where each slave processing circuit group includes Rs slave processing circuits, and the master processing circuit is further configured to split the input feature map among the Rs slave processing circuits as follows:
evenly splitting a corresponding output feature map into Rs output feature blocks of a same shape along H and W dimensions based on a size of the output feature map; and
splitting the input feature map into Rs input feature blocks along the H and W dimensions to be allocated to the Rs slave processing circuits according to an input feature map area required to compute each output feature block.

Article A8. The computing device of Article A7, where the split input feature blocks are aligned in the H and W dimensions according to Y and X dimensions of the splitting unit.

Article A9. The computing device of any one of Articles A7 to A8, including a first storage circuit and a second storage circuit, where
one of the input feature map and the convolution kernel is determined as multicast data, and split multicast data is stored in the first storage circuit; and
the other one of the input feature map and the convolution kernel is determined as distribution data, and split distribution data is stored in the second storage circuit.

Article A10. The computing device of Article A9, where the second storage circuit includes a storage area allocated to each slave processing circuit,
the input feature map split for each slave processing circuit is stored in a corresponding storage area in the second storage circuit; or
the convolution kernel allocated to each slave processing circuit is stored in a corresponding storage area in the second storage circuit.

Article A11. The computing device of any one of Articles A9 to A10, where each slave processing circuit includes a first caching circuit, a second caching circuit, and a plurality of computing circuits, where
the first caching circuit is configured to cache a plurality of input feature lines corresponding to the slave processing circuit and from one of the first storage circuit and the second storage circuit;
the second caching circuit is configured to cache a plurality of weight lines corresponding to the slave processing circuit and from the other one of the first storage circuit and the second storage circuit; and
each computing circuit performs an element-wise multiply-accumulate operation on an input feature line selected from the first caching circuit and a weight line selected from the second caching circuit respectively in each computation.

Article A12. The computing device of Article A11, where each slave processing circuit is further configured to:
select N_{CU} input feature lines by sliding from the first caching circuit by taking the splitting unit as a sliding window according to a splitting method of output points among the plurality of computing circuits, and send the N_{CU} input feature lines to N_{CU} computing circuits in the slave processing circuit respectively for computation;
select corresponding weight data from the second caching circuit, and broadcast the weight data to N_{CU} computing circuits for computation; and
perform Nk times of selection by sliding window, where Nk is determined according to a smaller value of a size of the convolution kernel in X and Y dimensions and a maximum convolution kernel size supported by the slave processing circuit in a single computation in a convolution splitting mode.

Article A13. The computing device of Article A12, where when the convolution operation is a three-dimensional convolution operation, the slave processing circuit is further configured to select corresponding weight data as follows:

selecting 1/Nop weight lines from the second caching circuit in a sliding method corresponding to the first caching circuit, copying the selected 1/Nop weight lines Nop−1 times to be extended into an extended weight line, and broadcasting the extended weight line to the N_{CU} computing circuits in the slave processing circuit, where Nop is a maximum number of computable convolution output points per computing circuit at a single time.

Article A14. The computing device of Article A13, where each computing circuit is further configured to:
perform an element-wise multiply-accumulate operation on one input feature line from the first caching circuit and one extended weight data line from the second caching circuit in units of 1/Nop data lines in each computation to obtain Nop partial sums; and
accumulate Nk*Nop partial sums obtained during Nk times of sliding computation according to corresponding convolution output points to obtain Nop computation results.

Article A15. The computing device of any one of Articles A12 to A14, where each slave processing circuit is further configured to:
output points computed by a plurality of computing units within the slave processing circuit in a specific order according to the splitting method of the output points among the plurality of computing circuits, so that consecutively outputted output points are continuous in X and/or Y dimensions.

Article A16. The computing device of any one of Articles A12 to A15, where the splitting method of the output points among the plurality of computing units includes one of the following:
computing, by each computing circuit, a plurality of continuous output points in the X and/or Y dimensions during each computation; or
computing, by each computing circuit, a plurality of spaced output points in the X and/or Y dimensions.

Article A17. The computing device of Article A3, where the blocking circuit is further configured to:
store computation results returned from the slave processing circuits in a fourth dimension storage order; and
convert the computation results in a desired dimension storage order.

Article A18. The computing device of Article A3 or A17, where
the blocking circuit is integrated in the master processing circuit; or
the blocking circuit is independent of the master processing circuit.

Article A19. The computing device of Article A3, A17 or A18, where
the blocking circuit performs the splitting on both the input feature map and the convolution kernel; or
the blocking circuit performs the splitting only on data determined as multicast data in the input feature map and the convolution kernel.

Article A20. A chip, including the computing device of any one of Articles A1 to A19.

Article A21. A board card, including the chip of Article A20.

Article A22. A method for implementing a convolution operation using the computing device of any one of Articles A1 to A19.

Article B1. A processing circuit configured to perform a convolution operation, including a first caching circuit, a second caching circuit, and a plurality of computing circuits, where
the first caching circuit is configured to cache a plurality of to-be-computed input feature lines;
the second caching circuit is configured to cache a plurality of to-be-computed weight lines; and
each computing circuit performs an element-wise multiply-accumulate operation on an input feature line selected from the first caching circuit and a weight line selected from the second caching circuit respectively in each computation, where the weight line is an extended weight line that is obtained by copying and extending part of the weight line selected from the second caching circuit.

Article B2. The processing circuit of Article B1, where the processing circuit is, during each selection by sliding window, further configured to:
select N_{CU} input feature lines by sliding from the first caching circuit according to a splitting method of output points among the plurality of computing circuits, and send the N_{CU} input feature lines to N_{CU} computing circuits in the processing circuit respectively for computation; and
select 1/Nop weight lines from the second caching circuit in a sliding method corresponding to the first caching circuit, copy the selected 1/Nop weight lines Nop−1 times to be extended into an extended weight line, and broadcast the extended weight line to the N_{CU} computing circuits, where Nop is a maximum number of computable convolution output points per computing circuit at a single time.

Article B3. The processing circuit of Article B2, where the processing circuit is further configured to:
perform Nk times of selection by sliding window, where Nk is determined according to a smaller value of a size of a convolution kernel in X and Y dimensions and a maximum convolution kernel size supported by the processing circuit in a single computation in a current convolution operation mode.

Article B4. The processing circuit of Article B3, where each computing circuit is further configured to:
perform an element-wise multiply-accumulate operation on one input feature line from the first caching circuit and one extended weight data line from the second caching circuit in units of 1/Nop data lines in each computation to obtain Nop partial sums; and
accumulate Nk*Nop partial sums obtained during Nk times of sliding computation according to corresponding convolution output points to obtain Nop computation results.

Article B5. The processing circuit of Article B4, where the processing circuit is further configured to:
output points computed by a plurality of computing units within the processing circuit in a specific order according to the splitting method of the output points among the plurality of computing circuits, so that consecutively outputted output points are continuous in the X and/or Y dimensions.

Article B6. The processing circuit of any one of Articles B2 to B5, where the splitting method of the output points among the plurality of computing units includes one of the following:
computing, by each computing circuit, a plurality of continuous output points in the X and/or Y dimensions during each computation; or
computing, by each computing circuit, a plurality of spaced output points in the X and/or Y dimensions during each computation.

Article B7. The processing circuit of any one of Articles B2 to B6, where N_{CU}=4, and Nop=4.

Article B8. The processing circuit of any one of Articles B1 to B7, where each of the input feature line and the weight line consists of a splitting unit, and the splitting unit includes data in a lowest storage dimension and at least one other storage dimension.

Article B9. The processing circuit of Article B8, where a shape of the splitting unit is Uci×Ux×Uy=M, where Uci is a size of the splitting unit on an initial lowest storage dimension of input feature data and weight data, Ux is a size of the splitting unit on an initial X storage dimension of the input feature data and the weight data, Uy is a size of the splitting unit on an initial Y storage dimension of the input feature data and the weight data, and M is a maximum computation amount of hardware at a time, where Uci=M/4ⁿ, n=1, 2, . . . ½ log₂ M−1.

Article B10. A computing device configured to perform a convolution operation, where the computing device includes a master processing circuit and a plurality of slave processing circuits, and each slave processing circuit is configured as the processing circuit of any one of Articles B1 to B9.

Article B11. A chip, including the computing device of Article B10.

Article B12. A board card, including the chip of Article B11.

Article B13. A method for implementing a convolution operation using the processing circuit of any one of Articles B1 to B9.

Article C1. A computing device configured to perform a convolution operation, where the computing device includes:
a blocking circuit configured to split an input feature map and a convolution kernel into a plurality of corresponding splitting units according to a convolution splitting scheme, where one of the splitting units includes data in a lowest storage dimension and at least one other storage dimension, and the amount of data contained in one splitting unit is less than or equal to a maximum computation amount of hardware at a time; and convert dimension storage orders of the input feature map and the convolution kernel, so that data in one splitting unit is continuously stored in one data line, where the split and converted input feature map and/or convolution kernel are supplied to a master processing circuit or a slave processing circuit;
the master processing circuit configured to distribute the data obtained to a plurality of slave processing circuits to perform convolution operations, and splice computation results returned from the plurality of slave processing circuits according to the convolution splitting scheme to obtain an output feature map of the convolution operation of the input feature map and the convolution kernel; and
the plurality of slave processing circuits configured to perform convolution operations based on the data obtained and return computation results to the master processing circuit.

Article C2. The computing device of Article C1, where the convolution splitting scheme also indicates the number of rounds of computations required to perform the convolution operation, where the number of output channels Co processed in each round of computation corresponds to the number Ns of schedulable slave processing circuits in the round of computation.

Article C3. The computing device of Article C2, including a first storage circuit and a second storage circuit, where
the input feature map is determined as multicast data, and the multicast data after being split and converted in its dimension storage order is stored in the first storage circuit for transmission to the plurality of scheduled slave processing circuits through a broadcast bus during the computation; and
the convolution kernel is determined as distribution data, and the distribution data after being split and converted in its dimension storage order is stored in the second storage circuit for distribution to corresponding slave processing circuits before the computation.

Article C4. The computing device of Article C3, where convolution kernels with different Co values allocated to respective slave processing circuits in each round of computation are stored in corresponding storage areas allocated to the corresponding slave processing circuits in the second storage circuit respectively.

Article C5. The computing device of any one of Articles C3 to C4, where each slave processing circuit includes a first caching circuit, a second caching circuit, and a plurality of computing circuits, where
the first caching circuit is configured to cache a plurality of input feature data lines transmit from the first storage circuit by broadcast;
the second caching circuit is configured to cache a plurality of weight data lines from the second storage circuit that are distributed to a convolution kernel of the slave processing circuit; and
each computing circuit performs an element-wise multiply-accumulate operation on an input feature data line selected from the first caching circuit and a weight data line selected from the second caching circuit respectively in each computation.

Article C6. The computing device of Article C5, where the slave processing circuit is further configured to split output points among N_{CU} computing circuits schedulable by the slave processing circuit as follows:
computing, by each computing circuit, a plurality of continuous output points of the output feature map in the X and/or Y dimensions during each computation.

Article C7. The computing device of Article C6, where the convolution operation is a three-dimensional convolution operation, and each slave processing circuit is further configured to:
select N_{CU} input feature lines by sliding from the first caching circuit by taking the splitting unit as a sliding window according to a method corresponding to a splitting method of the output points, and send the N_{CU} input feature lines to N_{CU} computing circuits respectively for computation;
select 1/Nop weight lines from the second caching circuit in a sliding method corresponding to the first caching circuit, where Nop is a maximum number of computable convolution output points per computing circuit at a single time, copy the selected 1/Nop weight lines Nop−1 times to be extended into an extended weight line, and broadcast the extended weight line to the N_{CU} computing circuits in the slave processing circuit;
perform Nk times of selection by sliding window, where Nk=Kx*Ky, Kx is a smaller value of a size of the convolution kernel in the X dimension or a maximum convolution kernel size supported by the slave processing circuit in a single computation in a convolution splitting mode, and Ky is a smaller value of a size of the convolution kernel in the Y dimension or the maximum convolution kernel size supported by the slave processing circuit in a single computation in the convolution splitting mode.

Article C8. The computing device of Article C7, where each computing circuit is further configured to:
perform an element-wise multiply-accumulate operation on one input feature line from the first caching circuit and one extended weight data line from the second caching circuit in units of 1/Nop data lines in each computation to obtain Nop partial sums; and
accumulate Nk*Nop partial sums obtained during Nk times of sliding computation according to corresponding convolution output points to obtain Nop computation results.

Article C9. The computing device of Article C8, where each slave processing circuit is further configured to:
output Nop computation results of one computing circuit in the slave processing circuit at a time in an order in which output points are split continuously.

Article C10. The computing device of any one of Articles C5 to C9, where the slave processing circuit is further configured to:
determine the number of times rs that a weight is reused in the slave processing circuit according to storage space limitations in the computing circuit;
control a loading frequency of input feature data in the first caching circuit, so that weight data loaded each time in the second caching circuit is reused rs times, and performs a convolution operation with corresponding input feature data loaded rs times in the first caching circuit.

Article C11. The computing device of any one of Articles C1 to C10, where a shape of the splitting unit indicated by the convolution splitting scheme is Uci×Ux×Uy=M, where Uci is a size of the splitting unit on an initial lowest storage dimension of the input feature map and the convolution kernel, Ux is a size of the splitting unit on an initial X storage dimension of the input feature map and the convolution kernel, Uy is a size of the splitting unit on an initial Y storage dimension of the input feature map and the convolution kernel, and M is a maximum computation amount of hardware at a time, where Uci>Ux=Uy>1, Uci=M/4ⁿ, n=1, 2, . . . ½ log₂ M−1.

Article C12. The computing device of Article C11, where M=64 B, Uci=16 B, and Ux=Uy=2.

Article C13. The computing device of Article C6, where each computing circuit computes an output feature block consisting of 2×2 output points at each computation.

Article C14. The computing device of Article C7, where N_{CU}=4, and Nop=4.

Article C15. The computing device of Article C7, where the slave processing circuit supports a maximum convolution kernel size of 3×3 for a single computation in the convolution splitting mode.

Article C16. A chip, including the computing device of any one of Articles C1 to C15.

Article C17. A board card, including the chip of Article C16.

Article C18. A method for implementing a convolution operation using the computing device of any one of Articles C1 to C15.

Article D1. A computing device configured to perform a convolution operation, where the computing device includes:
a master processing circuit configured to obtain an input feature map and/or a convolution kernel, where the input feature map and the convolution kernel are split into a plurality of splitting units according to a convolution splitting scheme, and dimension storage orders of the input feature map and the convolution kernel are converted, where one of the splitting units includes data in a lowest storage dimension and at least one other storage dimension, and the amount of data contained in one splitting unit is less than or equal to a maximum computation amount of hardware at a time, a size of an output channel Co dimension of the convolution kernel in a single round of computation is less than or equal to the number of slave processing circuits, and data in one splitting unit is continuously stored in one data line; and
a plurality of slave processing circuits configured to perform convolution operations on corresponding data lines of the input feature map and the convolution kernel.

Article D2. The computing device of Article D1, where the convolution splitting scheme also indicates the number of rounds of computations required to perform the convolution operation, the number of Cos processed in each round of computation, and a corresponding grouping mode.

Article D3. The computing device of Article D2, where the grouping mode is GroupN, indicating that Ns slave processing circuits performing computation in a current round of computation are split into N slave processing circuit groups, each slave processing circuit group processes a same Co value, and different slave processing circuit groups process different Co values, where N=4ⁿ, and n=0, 1, 2 . . . .

Article D4. The computing device of Article D3, where each slave processing circuit group includes Rs slave processing circuits, and the master processing circuit is further configured to split the input feature map among the Rs slave processing circuits as follows:
evenly splitting a corresponding output feature map into Rs output feature blocks of a same shape along H and W dimensions based on a size of the output feature map; and
splitting the input feature maps into Rs input feature blocks along the H and W dimensions to be allocated to the Rs slave processing circuits according to an input feature map area required to compute each output feature block.

Article D5. The computing device of Article D4, including a first storage circuit and a second storage circuit, where
the convolution kernel is determined as multicast data, and the multicast data after being split and converted in its dimension storage order is stored in the first storage circuit for transmission to a plurality of scheduled slave processing circuits through a broadcast bus during the computation; and
the input feature map is determined as distribution data, and the distribution data after being split and converted in its dimension storage order is stored in the second storage circuit for distribution to corresponding slave processing circuits.

Article D6. The computing device of Article D5, where the Rs slave processing circuits are split respectively according to the splitting units and stored in storage areas allocated for Rs slave processing circuits in the second storage circuit after being converted in a dimension storage order of the Rs slave processing circuits.

Article D7. The computing device of any one of Articles D5 to D6, where each slave processing circuit includes a first caching circuit, a second caching circuit, and a plurality of computing circuits, where
the second caching circuit is configured to cache a plurality of input feature data lines from the second storage circuit that are distributed to the slave processing circuit; and
the second caching circuit is configured to cache a plurality of weight data lines of the convolution kernel corresponding to an output channel value, which are from the first storage circuit and multicast to the slave processing circuit; and
each computing circuit performs an element-wise multiply-accumulate operation on an input feature data line selected from the first caching circuit and a weight data line selected from the second caching circuit respectively in each computation.

Article D8. The computing device of Article D7, where the slave processing circuit is further configured to split output points among N_{CU} computing circuits schedulable by the slave processing circuit as follows:
computing, by each computing circuit, a plurality of spaced output points of the output feature map in X and/or Y dimensions during each computation.

Article D9. The computing device of Article D8, where the convolution operation is a three-dimensional convolution operation, and each slave processing circuit is further configured to:
select N_{CU} input feature lines by sliding from the first caching circuit by taking the splitting unit as a sliding window according to a method corresponding to a splitting method of the output points, and send the N_{CU} input feature lines to N_{CU} computing circuits in the slave processing circuit respectively for computation;
select 1/Nop weight lines from the second caching circuit in a sliding method corresponding to the first caching circuit, copy the selected 1/Nop weight lines Nop−1 times to be extended into an extended weight line, and broadcast the extended weight line to the N_{CU} computing circuits in the slave processing circuit; and
perform Nk times of selection by sliding window, where Nk=ceil(Kx/2)*ceil(Ky/2), Kx is a smaller value of a size of the convolution kernel in the X dimension or a maximum convolution kernel size supported by the slave processing circuit in a single computation in a convolution splitting mode, and Ky is a smaller value of a size of the convolution kernel in the Y dimension or the maximum convolution kernel size supported by the slave processing circuit in a single computation in the convolution splitting mode.

Article D10. The computing device of Article D9, where each computing circuit is further configured to:
perform an element-wise multiply-accumulate operation on one input feature line from the first caching circuit and one extended weight data line from the second caching circuit in units of 1/Nop data lines in each computation to obtain Nop partial sums; and
accumulate Nk*Nop partial sums obtained during Nk times of sliding computation according to corresponding convolution output points to obtain Nop computation results.

Article D11. The computing device of Article D10, where each slave processing circuit is further configured to:
output a partial computation result(s) of a partial computing circuit(s) within the slave processing circuit each time, where the partial computation result(s) is continuous in the X and/or Y dimensions of the output feature map.

Article D12. The computing device of any one of Articles D7 to D11, where the slave processing circuit is further configured to:
determine the number of times rs that an input feature in the slave processing circuit is reused according to storage space limitations in the computing circuit; and
control a loading frequency of weight data in the second caching circuit, so that input feature data loaded each time in the first caching circuit is reused rs times, and performs a convolution operation with corresponding weight data loaded rs times in the second caching circuit.

Article D13. The computing device of any one of Articles D1 to D12, where a size of the splitting unit indicated by the convolution splitting scheme is Uci×Uy×Ux=M, where Uci is a size of the splitting unit on an initial lowest storage dimension of the input feature map and the convolution kernel, Ux is a size of the splitting unit on an initial X storage dimension of the input feature map and the convolution kernel, Uy is a size of the splitting unit on an initial Y storage dimension of the input feature map and the convolution kernel, and Mis a maximum computation amount of hardware at a time, where Ux=Uy≥Uci>1, Uci=M/4ⁿ, n=1, 2, . . . ½ log₂ M−1.

Article D14. The computing device of Article D13, where M=64 B, Uci=4 B, and Ux=Uy=4.

Article D15. The computing device of Article D8, where each computing circuit computes 2×2 output points spaced by 1 in both X and Y dimensions at each computation.

Article D16. The computing device of Article D9, where N_{CU}=4, and Nop=4.

Article D17. The computing device of Article D9, where the slave processing circuit supports a maximum convolution kernel size of 8×8 for a single computation in the convolution splitting mode.

Article D18. A chip, including the computing device of any one of Articles D1 to D17.

Article D19. A board card, including the chip of Article D18.

Article D20. A method for implementing a convolution operation using the computing device of any one of Articles D1 to D17.

Article E1. A computing device configured to perform a depthwise convolution operation, where the computing device includes:
a master processing circuit configured to obtain an input feature map and/or a convolution kernel, where the input feature map and the convolution kernel are split into a plurality of splitting units according to a convolution splitting scheme, and dimension storage orders of the input feature map and the convolution kernel are converted, where one of the splitting units includes data in a lowest storage dimension and at least one other storage dimension, and the amount of data contained in one splitting unit is less than or equal to a maximum computation amount of hardware at a time, and data in one splitting unit is continuously stored in one data line; and
a plurality of slave processing circuits configured to perform convolution operations on corresponding data lines of the input feature map and the convolution kernel.

Article E2. The computing device of Article E1, where a shape of the splitting unit indicated by the convolution splitting scheme is Uc×Uy×Ux=M, where Uc is a size of the splitting unit on an initial lowest storage dimension C of the input feature map and the convolution kernel, Ux is a size of the splitting unit on an initial X storage dimension of the input feature map and the convolution kernel, Uy is a size of the splitting unit on an initial Y storage dimension of the input feature map and the convolution kernel, and M is a maximum computation amount of hardware at a time, Ux=Uy≥Uc>1, Uc=M/4ⁿ, n=1, 2, . . . ½ log₂ M−1.

Article E3. The computing device of Article E2, where the convolution splitting scheme also indicates the number of rounds of computations required to perform the convolution operation, the number Nc of Cs processed in each round of computation, and a corresponding grouping mode, where Nc is aligned to Uc.

Article E4. The computing device of Article E3, where the grouping mode is GroupN, indicating that Ns slave processing circuits scheduled in a current round of computation are split into N slave processing circuit groups, each slave processing circuit group processes same consecutive Uc Co values, and different slave processing circuit groups process different consecutive Uc Co values, where N=4ⁿ, and n=0, 1, 2 . . . .

Article E5. The computing device of Article E4, where each slave processing circuit group includes Rs slave processing circuits, and the master processing circuit is further configured to split the input feature map among the Rs slave processing circuits as follows:
evenly splitting a corresponding output feature map into Rs output feature blocks of a same shape along H and W dimensions based on a size of the output feature map; and
splitting the input feature maps into Rs input feature blocks along the H and W dimensions to be allocated to the Rs slave processing circuits according to an input feature map area required to compute each output feature block.

Article E6. The computing device of Article E5, including a first storage circuit and a second storage circuit, where
the convolution kernel is determined as multicast data, and the multicast data after being split and converted in its dimension storage order is stored in the first storage circuit for transmission to a plurality of scheduled slave processing circuits through a broadcast bus during the computation; and
the input feature map is determined as distribution data, and the distribution data after being split and converted in its dimension storage order is stored in the second storage circuit for distribution to corresponding slave processing circuits.

Article E7. The computing device of Article E6, where
the Rs slave processing circuits are split respectively according to the splitting units and stored in storage areas allocated for Rs slave processing circuits in the second storage circuit after being converted in a dimension storage order of the Rs slave processing circuits.

Article E8. The computing device of any one of Articles E6 to E7, where each slave processing circuit includes a first caching circuit, a second caching circuit, and a plurality of computing circuits, where
the second caching circuit is configured to cache a plurality of input feature data lines from the second storage circuit that are distributed to the slave processing circuit; and
the second caching circuit is configured to cache a plurality of weight data lines from the first storage circuit that are multicast to the slave processing circuit; and
each computing circuit performs an element-wise multiply-accumulate operation on an input feature data line selected from the first caching circuit and a weight data line selected from the second caching circuit respectively in each computation.

Article E9. The computing device of Article E8, where the slave processing circuit is further configured to split output points among N_{CU} computing circuits schedulable by the slave processing circuit as follows:
computing, by each computing circuit, one spaced output point of the output feature map in X and/or Y dimensions during each computation; and
computing, by each computing circuit, different output points of the output feature map in the X and/or Y dimensions in different computations.

Article E10. The computing device of Article E9, where each slave processing circuit is further configured to:
select N_{CU} input feature lines by sliding from the first caching circuit by taking the splitting unit as a sliding window according to a method corresponding to a splitting method of the output points, and send the N_{CU} input feature lines to N_{CU} computing circuits in the slave processing circuit respectively for computation;
read one weight data line from the second caching circuit and broadcast the weight data line to the N_{CU} computing circuits in the slave processing circuit; and
perform Nk times of selection by sliding window in the first caching circuit, where Nk=Kx*Ky, Kx is a smaller value of a size of the convolution kernel in the X dimension or a maximum convolution kernel size supported by the slave processing circuit in a single computation in a convolution splitting mode, and Ky is a smaller value of a size of the convolution kernel in the Y dimension or the maximum convolution kernel size supported by the slave processing circuit in a single computation in the convolution splitting mode.

Article E11. The computing device of Article E10, where each computing circuit is further configured to:
for an input feature line from the first caching circuit and a weight line from the second caching circuit, taking 1/Uc data line as a unit, perform an element-wise multiply-accumulate operation on feature data and weight data corresponding to the same channel value in each computation to obtain Uc output points; and
splice Nk*Uc output points obtained during Nk times of sliding computation according to the splitting method of the output points, thus obtaining the Nk*N_{CU} computation results on Uc channels

Article E12. The computing device of Article E11, where each slave processing circuit is further configured to:
output partial computation result(s) of partial computing circuit(s) within the slave processing circuit each time, where these partial computation results are continuous in the X and/or Y dimensions of the output feature map.

Article E13. The computing device of any one of Articles E8 to E12, where the slave processing circuit is further configured to:
determine the number of times rn that an input feature in the slave processing circuit is reused according to storage space limitations in the computing circuit; and
control a loading frequency of weight data in the second caching circuit, so that input feature data loaded each time in the first caching circuit is reused rn times, and performs a convolution operation with corresponding weight data loaded rn times in the second caching circuit.

Article E14. The computing device of any one of Articles E2 to E13, where M=64 B, Uci=4 B, and Ux=Uy=4.

Article E15. The computing device of Article E10, where N_{CU}=4, and Nop=4.

Article E16. The computing device of Article E10, where the slave processing circuit supports a maximum convolution kernel size of 4×4 for a single computation in the convolution splitting mode.

Article E17. A chip, including the computing device of any one of Articles E1 to E16.

Article E18. A board card, including the chip of Article E17.

Article E19. A method for implementing a convolution operation using the computing device of any one of Articles E1 to E16.

Article F1. A computing device configured to perform a depthwise convolution operation in reverse training of a neural network model, where the computing device includes:
a master processing circuit configured to obtain input neuron data and/or neuron gradient data, where the input neuron data and the neuron gradient data are split into a plurality of splitting units according to a convolution splitting scheme, and dimension storage orders of the input neuron data and the neuron gradient data are converted, where one of the splitting units includes data in a lowest storage dimension and at least one other storage dimension, and the amount of data contained in one splitting unit is less than or equal to a maximum computation amount of hardware at a time, and data in one splitting unit is continuously stored in one data line; and
a plurality of slave processing circuits configured to perform the depthwise convolution operation on corresponding data lines of the input neuron data and the neuron gradient data.

Article F2. The computing device of Article F1, where a shape of the splitting unit indicated by the convolution splitting scheme is Uc×Uy×Ux=M, where Uc is a size of the splitting unit on an initial lowest storage dimension and a channel C of the input neuron data and the neuron gradient data, Ux is a size of the splitting unit on an initial X storage dimension of the input neuron data and the neuron gradient data, Uy is a size of the splitting unit on an initial Y storage dimension of the input neuron data and the neuron gradient data, and M is a maximum computation amount of hardware at a time, where Ux=Uy≥Uc>1, Uc=M/4ⁿ, n=1, 2, . . . ½ log₂ M−1.

Article F3. The computing device of Article F2, where the convolution splitting scheme also indicates a grouping splitting method for performing the depthwise convolution operation, where the grouping splitting method is used for the input neuron data and the neuron gradient data, the data is sequentially split into Ns schedulable slave processing circuits according to a channel C dimension and in units of Uc, and each slave processing circuit processes different input neuron data and neuron gradient data of consecutive Uc C values.

Article F4. The computing device of Article F3, including a first storage circuit and a second storage circuit, where
the neuron gradient data is determined as unicast data, and the unicast data after being split and converted in its dimension storage order is stored in the first storage circuit, so that the neuron gradient data corresponding to different Uc C values is transmitted separately to Ns scheduled slave processing circuits through a broadcast bus during the computation; and
the input neuron data is determined as distribution data, and the distribution data after being split and converted in its dimensional storage order is stored in storage areas corresponding to Ns slave processing circuits in the second storage circuit in a manner of being split sequentially according to the channel C dimension and in units of Uc, so as to be distributed to the corresponding slave processing circuits.

Article F5. The computing device of Article F4, where each slave processing circuit includes a first caching circuit, a second caching circuit, and a plurality of computing circuits, where
the second caching circuit is configured to cache a plurality of input neuron data lines from the second storage circuit that are distributed to the slave processing circuit; and
the second caching circuit is configured to cache a plurality of neuron gradient data lines from the first storage circuit that are unicast to the slave processing circuit; and
each computing circuit performs an element-wise multiply-accumulate operation on an input neuron data line selected from the first caching circuit and a neuron gradient data line selected from the second caching circuit respectively in each computation.

Article F6. The computing device of Article F5, where the slave processing circuit is further configured to split output points among N_{CU} computing circuits schedulable by the slave processing circuit as follows:
computing, by each computing circuit, an adjacent output point of weight gradient data on an XY plane of Uc channel C values in X and/or Y dimensions in each computation; and
computing, by each computing circuit, different output points of the weight gradient data in the X and/or Y dimensions in different computations.

Article F7. The computing device of Article F6, where each slave processing circuit is further configured to:
select N_{CU} input neuron data lines by sliding from the first caching circuit by taking the splitting unit as a sliding window according to a method corresponding to a splitting method of the output points, and send the N_{CU} input neuron data lines to N_{CU} computing circuits in the slave processing circuit respectively for computation;
read one neuron gradient data line from the second caching circuit and broadcast the neuron gradient data line to the N_{CU} computing circuits in the slave processing circuit; and
perform Nk times of selection by sliding window in the first caching circuit, where Nk=ceil(Kx/2)*ceil(Ky/2), Kx is a smaller value of a size of the weight gradient data in the X dimension or a maximum weight gradient size supported by the slave processing circuit in a single computation in a convolution splitting mode, and Ky is a smaller value of a size of the weight gradient data in the Y dimension or the maximum weight gradient size supported by the slave processing circuit in a single computation in the convolution splitting mode.

Article F8. The computing device of Article F7, where each computing circuit is further configured to:
for an input neuron data line from the first caching circuit and a neuron gradient data line from the second caching circuit, taking 1/Uc data line as a unit, perform an element-wise multiply-accumulate operation on input neuron data and neuron gradient data corresponding to the same channel value in each computation to obtain an output point at the same position on Uc XY planes; and
compute and obtain Nk output points spaced apart in the X and/or Y dimensions on the Uc XY planes during Nk times of sliding computation.

Article F9. The computing device of Article F8, where each slave processing circuit is further configured to:
output one output point, computed by a computing circuit in the slave processing circuit, at the same position on Uc XY planes each time.

Article F10. The computing device of Article F9, where the master processing circuit is further configured to:
splice and store computation results outputted from the slave processing circuit in a Ky*Kx*(Ns*Uc) dimension order.

Article F11. The computing device of any one of Articles F1 to F10, where M=64 B, Uc=4 B, and Ux=Uy=4.

Article F12. The computing device of any one of Articles F6 to F10, where N_{CU}=4, and Ns=16.

Article F13. The computing device of Article F7, where the slave processing circuit supports a maximum weight gradient size of 4×4 for a single computation in the convolution splitting mode.

Article F14. A chip, including the computing device of any one of Articles F1 to F13.

Article F15. A board card, including the chip of Article F14.

Article F16. A method for implementing a convolution operation using the processing device of any one of Articles F1 to F13.

Article G1. A computing device configured to perform a cross product convolution operation in reverse training of a neural network model, where the computing device includes:
a master processing circuit configured to obtain input neuron data and/or neuron gradient data, where the input neuron data and the neuron gradient data are split into a plurality of splitting units according to a convolution splitting scheme, where one of the splitting units includes data in a lowest storage dimension and at least one other storage dimension, and the amount of data contained in one splitting unit is less than or equal to a maximum computation amount of hardware at a time, and data in one splitting unit is continuously stored in one data line; and
a plurality of slave processing circuits configured to perform the cross product convolution operation on corresponding data lines of the input neuron data and the neuron gradient data.

Article G2. The computing device of Article G1, where a shape of the splitting unit indicated by the convolution splitting scheme is Uc×Uy×Ux=M, where Uc is a size of the splitting unit on an initial lowest storage dimension on an input channel Ci of the input neuron data and a size of the splitting unit on an initial lowest storage dimension on an output channel Co of the neuron gradient data, Ux is a size of the splitting unit on an initial X storage dimension of the input neuron data and the neuron gradient data, Uy is a size of the splitting unit on an initial Y storage dimension of the input neuron data and the neuron gradient data, and M is a maximum computation amount of hardware at a time, where Ux=Uy≥Uc>1, Uc=M/4ⁿ, n=1, 2, . . . ½ log₂ M−1.

Article G3. The computing device of Article G2, where the convolution splitting scheme also indicates the number of rounds of computations required to perform the depthwise convolution operation, the number Nco of output channels processed in each round of computation, and a corresponding grouping mode, where Nc is aligned to Uc.

Article G4. The computing device of Article G3, where the grouping mode is GroupN, indicating that Ns slave processing circuits scheduled in a current round of computation are split into N slave processing circuit groups, each slave processing circuit group processes same consecutive Uc Co values, and different slave processing circuit groups process different consecutive Uc Co values, where N=4ⁿ, and n=0, 1, 2 . . . .

Article G5. The computing device of Article G4, where the convolution splitting scheme also indicates that in each slave processing circuit group, the input neuron data is sequentially split into Rs schedulable slave processing circuits in a same slave processing circuit group in units of Uc according to an input channel Ci dimension, where Rs=Ns/N.

Article G6. The computing device of Article G5, including a first storage circuit and a second storage circuit, where
the neuron gradient data is determined as multicast data, and the multicast data after being split and converted in its dimensional storage order can be stored in the first storage circuit so that during the computation, the neuron gradient data corresponding to different Uc Co values can be transmitted to N slave processing circuit groups scheduled through a broadcast bus, and each slave processing circuit group shares the same neuron gradient data of Uc Co values; and
the input neuron data is determined as distribution data, and the distribution data after being split and converted in its dimensional storage order is copied N times, each of which is split into Rs data blocks in a manner of being split sequentially in a Ci direction and in units of Uc, and stored in corresponding storage areas in the second storage circuit respectively, so as to be distributed to corresponding slave processing circuits.

Article G7. The computing device of Article G6, where each slave processing circuit includes a first caching circuit, a second caching circuit and a plurality of computing circuits, where
the second caching circuit is configured to cache a plurality of input neuron data lines from the second storage circuit that are distributed to the slave processing circuit; and
the second caching circuit is configured to cache a plurality of neuron gradient data lines from the first storage circuit that are broadcast to the slave processing circuit; and
each computing circuit performs an element-wise multiply-accumulate operation on an input neuron data line selected from the first caching circuit and a neuron gradient data line selected from the second caching circuit respectively in each computation.

Article G8. The computing device of Article G7, where the slave processing circuit is further configured to split output points among N_{CU} computing circuits schedulable by the slave processing circuit as follows:
computing, by each computing circuit, an output point of weight gradient data at the same position in the X and Y dimensions on consecutive Uc Ci values on different Cos; and
computing, by each computing circuit, different output points of the weight gradient data in the X and/or Y dimensions in different computations.

Article G9. The computing device of Article G8, where each slave processing circuit is further configured to:
select one input neuron data line by sliding from the first caching circuit by taking the splitting unit as a sliding window according to a method corresponding to a splitting method of the output points, and broadcast the input neuron data line to N_{CU} computing circuits in the slave processing circuit for computation;
read one neuron gradient data line from the second caching circuit, split the neuron gradient data line into Uc Co values according to a Co dimension, make Uc copies of an XY data plane of each Co value, and send the Uc copies to Uc computing circuits in the slave processing circuit respectively; and
perform Nk times of selection by sliding window in the first caching circuit, where Nk=Kx*Ky, Kx is a smaller value of a size of the weight gradient data in the X dimension or a maximum weight gradient size supported by the slave processing circuit in a single computation in a convolution splitting mode, and Ky is a smaller value of a size of the weight gradient data in the Y dimension or the maximum weight gradient size supported by the slave processing circuit in a single computation in the convolution splitting mode.

Article G10. The computing device of Article G8, where when Uc<N_{CU}, each slave processing circuit is further configured to:
select one input neuron data line by sliding from the first caching circuit by taking the splitting unit as a sliding window according to a method corresponding to a splitting method of the output points, and broadcast the input neuron data line to N_{CU} computing circuits in the slave processing circuit for computation;
read N_{CU}/Uc neuron gradient data lines from the second caching circuit, split the N_{CU}/Uc neuron gradient data lines into N_{CU} Co values according to a Co dimension, make Uc copies of an XY data plane of each Co value, and send the Uc copies to N_{CU} computing circuits in the slave processing circuit respectively; and
perform Nk times of selection by sliding window in the first caching circuit, where Nk=Kx*Ky, Kx is a smaller value of a size of the weight gradient data in the X dimension or a maximum weight gradient size supported by the slave processing circuit in a single computation in a convolution splitting mode, and Ky is a smaller value of a size of the weight gradient data in the Y dimension or the maximum weight gradient size supported by the slave processing circuit in a single computation in the convolution splitting mode.

Article G11. The computing device of Article G9 or G10, where each computing circuit is further configured to:
for an input neuron data line from the first caching circuit and a neuron gradient data line from the second caching circuit, taking 1/Uc data line as a unit, perform an element-wise multiply-accumulate operation on input neuron data and neuron gradient data corresponding to a same input channel Ci value in each computation to obtain Uc output points of an allocated Co value in the Ci dimension; and
compute and obtain Nk*Uc output points during Nk times of sliding computation, which are Nk output points continuous in the X and/or Y dimensions on an XY plane on a single Co and Uc Cis.

Article G12. The computing device of Article G11, where each slave processing circuit is further configured to:
output one output point, computed by a computing circuit in the slave processing circuit, at the same position on an XY plane on a single Co and Uc Cis each time.

Article G13. The computing device of Article G12, where the master processing circuit is further configured to:
splice and store computation results outputted from the slave processing circuit in a Ky*Kx*Co/N*N*(Rs*Uc) dimension order, where N is the number of groups.

Article G14. The computing device of any one of Articles G1 to G13, where M=64 B, Uc=4 B, and Ux=Uy=4.

Article G15. The computing device of any one of Articles G8 to G13, where N_{CU}=4, and Ns=16.

Article G16. The computing device of any one of Articles G9 to G10, where the slave processing circuit supports a maximum weight gradient size of 4×4 for a single computation in the convolution splitting mode.

Article G17. A chip, including the computing device of any one of Articles G1 to G16.

Article G18. A board card, including the chip of Article G17.

Article G19. A method for implementing a convolution operation using the computing device of any one of Articles G1 to G16.

The examples of the present disclosure have been described in detail above. Specific examples have been used in the specification to explain the principles and implementation manners of the present disclosure. The descriptions of the above examples are only used to facilitate understanding of the methods and core ideas of the present disclosure. Persons of ordinary skill in the art may change the implementation and application scope according to the ideas of the present application. In summary, the content of this specification should not be construed as a limitation on the present disclosure.

What is claimed:

1. A computing device configured to perform a convolution operation, wherein the computing device comprises:
a master processing circuit configured to obtain an input feature map and/or a convolution kernel, wherein the input feature map and the convolution kernel are split into a plurality of splitting units according to a convolution splitting scheme, and dimension storage orders of the input feature map and the convolution kernel are converted, wherein the convolution splitting scheme is determined based on a size of a lowest storage dimension of the input feature map before splitting, the convolution splitting scheme indicates a shape of a splitting unit, the amount of data contained in one splitting unit is less than or equal to a maximum computation amount of hardware at a time, and data in one splitting unit is continuously stored in one data line; and
a plurality of slave processing circuits configured to perform convolution operations on corresponding splitting units of the input feature map and the convolution kernel.

2. The computing device of claim 1, wherein the convolution splitting scheme is determined as follows:
aligning a lowest storage dimension Ci of the input feature map before splitting to a multiple of the nearest M/4ⁿ, wherein M is the maximum computation amount of hardware at a time, n=0, 1, . . . ½ log₂ M−1, and a size Uci of the splitting unit in the lowest storage dimension is determined as M/4ⁿ;
taking a maximum value of M/4ⁿ or the M/4ⁿ with a smallest alignment padding amount as the Uci if there are a plurality of multiples of the nearest M/4ⁿ; and
determining a size Ux in an X storage dimension and a size Uy in a Y storage dimension of the splitting unit, such that Uci×Ux×Uy=M, wherein Ux=Uy.

3. The computing device of claim 1, comprising a blocking circuit configured to perform splitting and storage for the input feature map and the convolution kernel respectively as follows:
reading one or more splitting units according to a first read order in units of the splitting units from to-be-computed data stored in a first dimension storage order, and storing the read splitting units on corresponding storage circuits, wherein data in each splitting unit is stored according to a second dimension storage order, and data between the splitting units is stored according to a third dimension storage order.

4. The computing device of claim 3, wherein
the first dimension storage order is HWC from high to low;
the second dimension storage order is CHW from high to low;
the first read order is HWC from high to low; and
the third dimension storage order is the same as the first dimension storage order, wherein
H is a height dimension, W is a width dimension, and C is a channel dimension.

5. The computing device of claim 1, wherein the master processing circuit is further configured to:
determine the number of rounds of computations required to complete the convolution operation and the number of Cos processed in each round of computation or a corresponding grouping mode based on the size of an output channel Co dimension of the convolution kernel and the number Ns of schedulable slave processing circuits.

6. The computing device of claim 5, wherein the grouping mode is GroupN, indicating that all slave processing circuits scheduled in a current round of computation are split into N slave processing circuit groups, each slave processing circuit group processes a same Co value, and different slave processing circuit groups process different Co values, wherein N=4ⁿ, and n=0, 1, 2 . . . .

7. The computing device of claim 6, wherein each slave processing circuit group comprises Rs slave processing circuits, and the master processing circuit is further configured to split the input feature map among the Rs slave processing circuits as follows:
evenly splitting a corresponding output feature map into Rs output feature blocks of a same shape along H and W dimensions based on a size of the output feature map; and
splitting the input feature map into Rs input feature blocks along the H and W dimensions to be allocated to the Rs slave processing circuits according to an input feature map area required to compute each output feature block.

8. The computing device of claim 7, wherein the split input feature blocks are aligned in the H and W dimensions according to Y and X dimensions of the splitting unit.

9. The computing device of claim 8, comprising a first storage circuit and a second storage circuit, wherein
one of the input feature map and the convolution kernel is determined as multicast data, and split multicast data is stored in the first storage circuit; and
the other one of the input feature map and the convolution kernel is determined as distribution data, and split distribution data is stored in the second storage circuit.

10. The computing device of claim 9, wherein the second storage circuit comprises a storage area allocated to each slave processing circuit,
the input feature map split for each slave processing circuit is stored in a corresponding storage area in the second storage circuit; or
the convolution kernel allocated to each slave processing circuit is stored in a corresponding storage area in the second storage circuit.

11. The computing device of claim 10, wherein each slave processing circuit comprises a first caching circuit, a second caching circuit and a plurality of computing circuits, wherein
the first caching circuit is configured to cache a plurality of input feature lines corresponding to the slave processing circuit and from one of the first storage circuit and the second storage circuit;
the second caching circuit is configured to cache a plurality of weight lines corresponding to the slave processing circuit and from the other one of the first storage circuit and the second storage circuit; and
each computing circuit performs an element-wise multiply-accumulate operation on an input feature line selected from the first caching circuit and a weight line selected from the second caching circuit respectively in each computation.

12. The computing device of claim 11, wherein each slave processing circuit is further configured to:
select N_{CU} input feature lines by sliding from the first caching circuit by taking the splitting unit as a sliding window according to a splitting method of output points among the plurality of computing circuits, and send the N_{CU} input feature lines to N_{CU} computing circuits in the slave processing circuit respectively for computation;
select corresponding weight data from the second caching circuit, and broadcast the weight data to N_{CU} computing circuits for computation; and
perform Nk times of selection by sliding window, wherein Nk is determined according to a smaller value of a size of the convolution kernel in X and Y dimensions and a maximum convolution kernel size supported by the slave processing circuit in a single computation in a convolution splitting mode.

13. The computing device of claim 12, wherein when the convolution operation is a three-dimensional convolution operation, the slave processing circuit is further configured to select corresponding weight data as follows:
selecting 1/Nop weight lines from the second caching circuit in a sliding method corresponding to the first caching circuit, copying the selected 1/Nop weight lines Nop−1 times to be extended into an extended weight line, and broadcasting the extended weight line to the N_{CU} computing circuits in the slave processing circuit, wherein Nop is a maximum number of computable convolution output points per computing circuit at a single time.

14. The computing device of claim 13, wherein each computing circuit is further configured to:
perform an element-wise multiply-accumulate operation on one input feature line from the first caching circuit and one extended weight data line from the second caching circuit in units of 1/Nop data lines in each computation to obtain Nop partial sums; and
accumulate Nk*Nop partial sums obtained during Nk times of sliding computation according to corresponding convolution output points to obtain Nop computation results.

15. The computing device of claim 14, wherein each slave processing circuit is further configured to:
output points computed by a plurality of computing units within the slave processing circuit in a specific order according to the splitting method of the output points among the plurality of computing circuits, so that consecutively outputted output points are continuous in X and/or Y dimensions.

16. The computing device of claim 15, wherein the splitting method of the output points among the plurality of computing units comprises one of the following:
computing, by each computing circuit, a plurality of continuous output points in the X and/or Y dimensions during each computation; or
computing, by each computing circuit, a plurality of spaced output points in the X and/or Y dimensions.

17. The computing device of claim 3, wherein the blocking circuit is further configured to:
store computation results returned from the slave processing circuits in a fourth dimension storage order; and
convert the computation results in a desired dimension storage order.

18. The computing device of claim 17, wherein
the blocking circuit is integrated in the master processing circuit; or
the blocking circuit is independent of the master processing circuit.

19. The computing device of claim 18, wherein
the blocking circuit performs the splitting on both the input feature map and the convolution kernel; or
the blocking circuit performs the splitting only on data determined as multicast data in the input feature map and the convolution kernel.

20. A chip, comprising the computing device of claim 1.

21. (canceled)

22. (canceled)
